(19) United States
(12) Patent Application Publication
(10) Pub. No.: US 2024/0124619 A1
(43) Pub. Date: Apr. 18, 2024

(54) METHOD FOR PRODUCING FLUORINE-CONTAINING POLYMER AND FLUORINE-CONTAINING POLYMER

(71) Applicant: OCHANOMIZU UNIVERSITY, Tokyo (JP)

(72) Inventors: Tadashi Kanbara, Tokyo (JP); Tomoko Yajima, Tokyo (JP)

(73) Assignee: OCHANOMIZU UNIVERSITY, Tokyo (JP)

(21) Appl. No.: 18/233,473

(22) Filed: Aug. 14, 2023

(30) Foreign Application Priority Data
Aug. 16, 2022 (JP) 2022-129721
Mar. 7, 2023 (JP) 2023-034872

(51) Int. Cl. C08F 8/24; C08F 12/20; C08F 12/22; C08F 12/32

(52) U.S. Cl. CPC C08F 8/24; C08F 12/20; C08F 12/22; C08F 12/32

(57) ABSTRACT

A method for producing a fluorine-containing polymer of the present disclosure includes reacting a polymer comprising a unit represented by the following Formula (I) with a fluorine-containing compound represented by the following Formula (II), to obtain a fluorine-containing polymer comprising a unit represented by the following Formula (III).

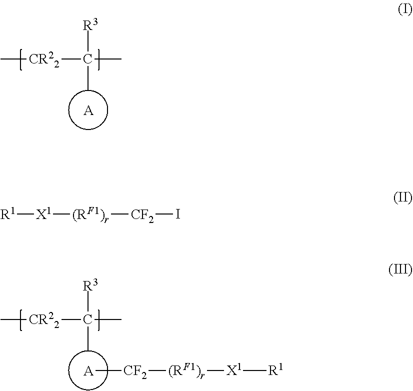

### TECHNICAL FIELD

The present disclosure relates to a method for producing a fluorine-containing polymer, and a fluorine-containing polymer.

### BACKGROUND ART

Fluorine-containing polymer materials have various characteristics derived from fluorine atoms and are utilized in many fields. Regarding such a fluorine-containing polymer material, Non-Patent Document 1 describes that 4′-nonafluorobutylstyrene is synthesized using 1-iodoperfluorobutane and a styrene monomer, and the synthesized 4′-nonafluorobutylstyrene is polymerized to obtain a polymer. Non-Patent Document 2 describes that a trifluoromethyl group is introduced into an aromatic polymer such as polystyrene using bis(trifluoroacetyl)peroxide. Non-Patent Document 3 describes that a trifluoromethyl group is introduced into poly(α-methylstyrene) or the like using (perfluoroalkyl)phenyliodonium trifluoromethanesulfonate. Non-Patent Documents 4 and 5 describe that a perfluoroalkyl group having 1 to 7 carbon atoms is introduced into polystyrene using a perfluorocarboxylic anhydride. In addition, Non-Patent Document 6 describes that 1-(5,5,6,6,7,7,8,8-octafluoro-5,6,7,8-tetrahydrofuran-2-yl)ethan-1-one is synthesized using 1,4-diiodoperfluorobutane and 3′-bromo-4′-iodoacetophenone, the acetyl group of the compound is reduced and dehydrated to form a vinyl group, and this compound is polymerized to obtain a polymer.

### Non-Patent Documents

Non-Patent Document 1: Flavio Ceretta et al., Conventional radical polymerization and iodine-transfer polymerization of 4′-nonafluorobutyl styrene: Surface and thermal characterizations of the resulting poly(fluorostyrene)s, Journal of Polymer Science Part A: Polymer Chemistry, 50, 3202-3212.
Non-Patent Document 2: Yoshio Hayakawa et al., Trifluoromethylation by bis(trifluoroacetyl) peroxide of polymers bearing benzene rings, Polymer, 42, 4081-4086.
Non-Patent Document 3: Hideo Shuyama, Perfluoroalkylation of poly(α-methylstyrene) and poly(phenyl methacrylate), Journal of Fluorine Chemistry, 29, 467-470.
Non-Patent Document 4: Sally E Lewis et al., Upcycling aromatic polymers through C—H fluoroalkylation, Chemical Science, 10, 6270-6277.
Non-Patent Document 5: Sally E Lewis et al., Organocatalytic C—H fluoroalkylation of commodity polymers, Polymer Chemistry, 11, 4914-4919.
Non-Patent Document 6: Tatsuo Hisa et al., Synthesis and characterization of a polystyrene-type polymer bearing acyclic perfluoroalkylene group, Polymer, 265 (2023) 1215588.

### SUMMARY

### Problems to be Solved by the Invention

In Non-Patent Documents 1 and 6, since a polymer is produced after a monomer having a fluorine-containing group is produced, the number of processes is large, and sufficient production efficiency is not achieved. In addition, in Non-Patent Document 1, the type of the fluorine-containing group that can be introduced into the monomer is also limited.

On the other hand, in Non-Patent Document 2 to 5, a fluorine-containing group is introduced into a polymer. In bis(trifluoroacetyl)peroxide used in Non-Patent Document 2, (perfluoroalkyl)phenyliodonium trifluoromethanesulfonate used in Non-Patent Document 3, and perfluorocarboxylic anhydrides used in Non-Patent Documents 4 and 5, there are few variations in the structure of the fluorine-containing group, and the type of the fluorine-containing group that can be introduced into the polymer is limited. Further, bis(trifluoroacetyl)peroxide and (perfluoroalkyl)phenyliodonium trifluoromethanesulfonate in Non-Patent Documents 2 and 3 are known to exhibit explosive properties. Further, in order to produce the perfluorocarboxylic anhydrides of Non-Patent Documents 4 and 5, an expensive reagent is required.

An object of the present disclosure is to provide a method for producing a novel fluorine-containing polymer into which various fluorine-containing groups are introduced, and a novel fluorine-containing polymer.

### Solutions to the Problems

The present disclosure includes the following aspects.

<1>

A method for producing a fluorine-containing polymer, the method including
reacting a polymer comprising a unit represented by the following Formula (I):

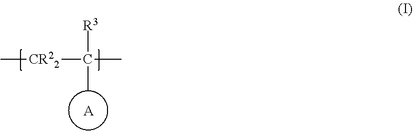

wherein A represents an aromatic ring or an aromatic heterocyclic ring,
R² each independently represents a hydrogen atom or a fluorine atom, and
R³ represents a C₁₋₄ alkyl group optionally substituted with one or more fluorine atoms, a hydrogen atom, or a fluorine atom,
with a fluorine-containing compound represented by the following Formula (II):

R¹—X¹—(R^{F1})ᵣ—CF₂—I (II)
wherein R^{F1} represents —(Rf)ₚ—R^{F}—(O)_{q}
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R¹ represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1, q is each independently 0 or 1, and r is each independently 0 or 1,
to obtain a fluorine-containing polymer comprising a unit represented by the following Formula (III):

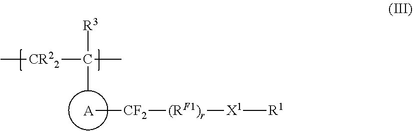

wherein A, R^{F1}, X¹, R¹, R², R³ and r have the same meaning as described above.

<2>

A method for producing a fluorine-containing polymer, the method including
reacting a polymer comprising a unit represented by the following Formula (I):

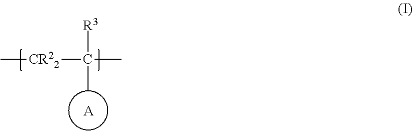

wherein A represents an aromatic ring or an aromatic heterocyclic ring,
R² each independently represents a hydrogen atom or a fluorine atom, and
R³ represents a C₁₋₄ alkyl group optionally substituted with one or more fluorine atoms, a hydrogen atom, or a fluorine atom,
with a fluorine-containing compound represented by the following Formula (VI):

I—R⁴⁰—I (VI)
wherein R⁴⁰ represents a C₃₋₆ alkylene group optionally substituted with one or more halogen atoms,
to obtain a fluorine-containing polymer comprising a unit represented by the following Formula (VII):

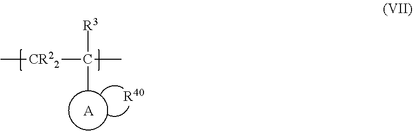

wherein A, R², R³ and R⁴⁰ have the same meaning as described above.

<3>

The method according to <1> or <2>, wherein the polymer further comprises one or more selected from a unit represented by the following Formula (IV-a):

[symbol]

CR⁵₂—CR⁶R⁷ [symbol] (IV-a)
wherein R⁵ each independently a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—, or
a unit represented by the following Formula (IV-b):

[symbol]

CR¹¹₂—CR¹²═CR¹²—CR¹¹₂ [symbol] (IV-b)
wherein R¹¹ each independently represents a C₁₋₄ alkyl group optionally substituted with one or more fluorine atoms, a hydrogen atom, or a fluorine atom, and
R¹² each independently represents a C₁₋₄ alkyl group optionally substituted with one or more fluorine atoms, a hydrogen atom, a fluorine atom, or a chlorine atom.

<4>

The method according to any one of <1> to <3>, wherein the polymer is represented by the following Formula (I-a):

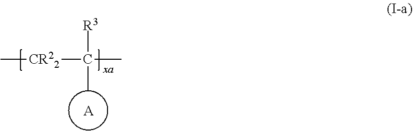

wherein A each independently represents an aromatic ring or an aromatic heterocyclic ring,
R² each independently represents a hydrogen atom or a fluorine atom, and
R³ each independently represents a C₁₋₄ alkyl group optionally substituted with one or more fluorine atoms, a hydrogen atom, or a fluorine atom, and
xa represents an integer of 1 to 10,000.

<5>

The method according to any one of <1> to <3>, wherein the polymer is represented by the following Formula (I-b):

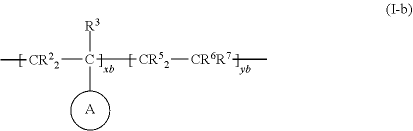

wherein A each independently represents an aromatic ring or an aromatic heterocyclic ring,
R² each independently represents a hydrogen atom or a fluorine atom, and
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
xb represents an integer of 1 to 10,000, yb represents an integer of 1 to 10,000, and
the order of occurrence of units enclosed by parentheses with xb and yb is not limited in Formula (I-b).

<6>

The method according to any one of <1> to <3>, wherein the polymer is represented by the following Formula (I-c):

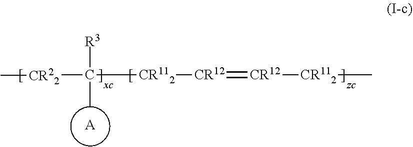

wherein A each independently represents an aromatic ring or an aromatic heterocyclic ring,
R² each independently represents a hydrogen atom or a fluorine atom, and
R³ each independently represents a C₁₋₄ alkyl group optionally substituted with one or more fluorine atoms, a hydrogen atom, or a fluorine atom,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
xc represents an integer of 1 to 10,000, zc represents an integer of 1 to 10,000, and
the order of occurrence of units enclosed by parentheses with xc and zc is not limited in Formula (I-c).

<7>

The method according to any one of <1> to <3>, wherein the polymer is represented by the following Formula (I-d):

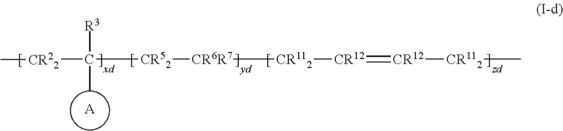

wherein A each independently represents an aromatic ring or an aromatic heterocyclic ring,
R² each independently represents a hydrogen atom or a fluorine atom, and
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
xd represents an integer of 1 to 10,000, yd represents an integer of 1 to 10,000, zd represents an integer of 1 to 10,000, and
the order of occurrence of units enclosed by parentheses with xd, yd, and zd is not limited in Formula (I-d).

<8>

The method according to any one of <1> to <3>, wherein the polymer is represented by the following Formula (I-e):

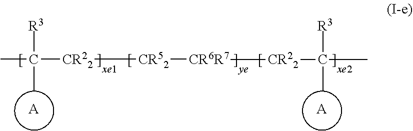

wherein A each independently represents an aromatic ring or an aromatic heterocyclic ring,
R² each independently represents a hydrogen atom or a fluorine atom, and
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
xe1 represents an integer of 1 to 10,000, xe2 represents an integer of 1 to 10,000,
ye represents an integer of 1 to 10,000, and
the order of occurrence of units enclosed by parentheses with xe1, xe2, and ye is not limited in Formula (I-e).

<9>

The method according to any one of <1> to <3>, wherein the polymer is represented by the following Formula (I-f):

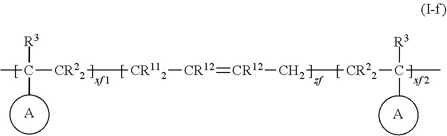

wherein A each independently represents an aromatic ring or an aromatic heterocyclic ring,
R² each independently represents a hydrogen atom or a fluorine atom, and
R³ each independently represents a C₁₋₄ alkyl group optionally substituted with one or more fluorine atoms, a hydrogen atom, or a fluorine atom,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
xf1 represents an integer of 1 to 10,000, xf2 represents an integer of 1 to 10,000, zf represents an integer of 1 to 10,000, and
the order of occurrence of units enclosed by parentheses with xf1, xf2, and zf is not limited in Formula (I-f).

<10>

A fluorine-containing polymer comprising a unit represented by the following Formula (III-a):

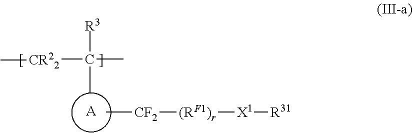

wherein A represents an aromatic ring or an aromatic heterocyclic ring,
R^{F1} represents —(Rf)ₚ—R^{F}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R² each independently represents a hydrogen atom or a fluorine atom, and
R³ each independently represents a C₁₋₄ alkyl group optionally substituted with one or more fluorine atoms, a hydrogen atom, or a fluorine atom,
R³¹ represents a C₇₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a bromine atom, or an iodine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is 0 or 1, q is 0 or 1, and r is 0 or 1.

<11>

A fluorine-containing polymer comprising a unit represented by the following Formula (VII):

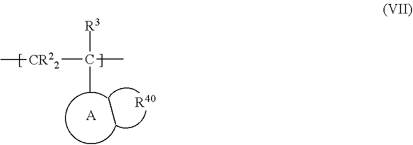

wherein A represents an aromatic ring or an aromatic heterocyclic ring,
R² each independently represents a hydrogen atom or a fluorine atom,
R³ each independently represents a C₁₋₄ alkyl group optionally substituted with one or more fluorine atoms, a hydrogen atom, or a fluorine atom, and
R⁴⁰ represents a C₃₋₆ alkylene group optionally substituted with one or more halogen atoms.

<12>

A fluorine-containing polymer comprising:
one or more selected from a unit represented by the following Formula (III):

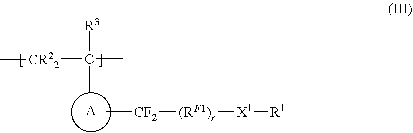

wherein A represents an aromatic ring or an aromatic heterocyclic ring,
R^{F1} represents —(Rf)ₚ—R^{F}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R¹ represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom, and
R³ each independently represents a C₁₋₄ alkyl group optionally substituted with one or more fluorine atoms, a hydrogen atom, or a fluorine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is 0 or 1, q is 0 or 1, and r is 0 or 1.
or a unit represented by the following Formula (VII):

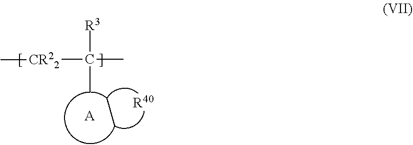

wherein A represents an aromatic ring or an aromatic heterocyclic ring,
R² each independently represents a hydrogen atom or a fluorine atom, and
R³ represents a C₁₋₄ alkyl group optionally substituted with one or more fluorine atoms, a hydrogen atom, or a fluorine atom, and
R⁴⁰ represents a C₃₋₆ alkylene group optionally substituted with one or more halogen atoms; and one or more selected from a unit represented by the following Formula (IV-a):

[symbol]

CR⁵₂—CR⁶R⁷ [symbol] (IV-a)
wherein R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
a unit represented by the following Formula (IV-b):

[symbol]

CR¹¹₂—CR¹²═CR¹²—CR¹¹₂ [symbol] (IV-b)
wherein R¹¹ each independently represents a C₁₋₄ alkyl group optionally substituted with one or more fluorine atoms, a hydrogen atom, or a fluorine atom, and
R¹² each independently represents a C₁₋₄ alkyl group optionally substituted with one or more fluorine atoms, a hydrogen atom, a fluorine atom, or a chlorine atom, and
a unit represented by the following Formula (IV-c):

[symbol]

CR¹¹₂—CR¹³₂—CR¹³₂—CR¹¹₂ [symbol] (IV-c)
wherein R¹¹ has the same meaning as described above,
R¹³ each independently represents one selected from a C₁₋₄ alkyl group optionally substituted with one or more fluorine atoms, a hydrogen atom, a fluorine atom, a chlorine atom, an iodine atom, and —CF²—(R^{F1})ᵣ—X¹—R¹,
R^{F1} represents —(Rf)ₚ—R^{F}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1, q is each independently 0 or 1, and r is each independently 0 or 1.

<13>

The fluorine-containing polymer according to <10> or <11>, wherein the fluorine-containing polymer is represented by the following Formula (V-a):

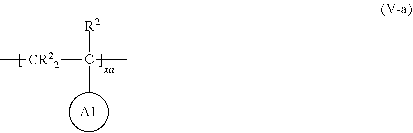

wherein A1 each independently represents one or more selected from a ring represented by the following formula:

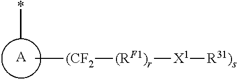

and a ring represented by the following formula:

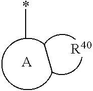

wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ represents a C₁₋₁₆ alkylene group optionally substituted with one or more halogen atoms, or a single bond,
R² each independently represents a hydrogen atom or a fluorine atom, and
R³ each independently represents a C₁₋₄ alkyl group optionally substituted with one or more fluorine atoms, a hydrogen atom, or a fluorine atom,
R³¹ each independently represents a C₇₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a bromine atom, or an iodine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1, q is each independently 0 or 1, r is each independently 0 or 1, s each independently represents an integer of 0 to 5,
xa represents an integer of 2 to 10,000, and
the number of —CF₂—(R^{F1})ᵣ—X¹—R³¹ included in Formula (V-a) is one or more.

<14>

The fluorine-containing polymer according to <12>, wherein the fluorine-containing polymer is represented by the following Formula (V-b):

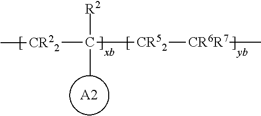

wherein A2 each independently represents one or more selected from a ring represented by the following formula:

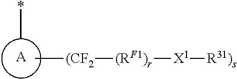

or a ring represented by the following formula:

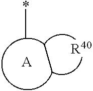

wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom, and
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1, q is each independently 0 or 1, r is each independently 0 or 1, s each independently represents an integer of 0 to 5,
xb represents an integer of 1 to 10,000, yb represents an integer of 1 to 10,000, the order of occurrence of units enclosed by parentheses with xb and yb is not limited in Formula (V-b), and
the number of —CF₂—(R^{F1})ᵣ—X¹—R¹ included in Formula (V-b) is one or more.

<15>

The fluorine-containing polymer according to <12>, wherein the fluorine-containing polymer is represented by the following Formula (V-c):

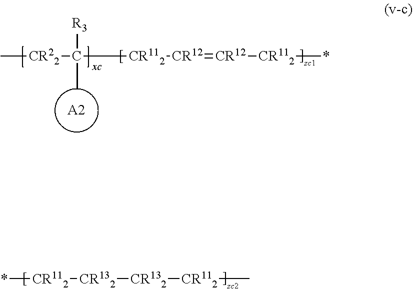

wherein A2 each independently represents one or more selected from a ring represented by the following formula:

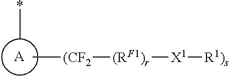

and a ring represented by the following formula:

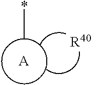

wherein A each independently represents an aromatic ring or an aromatic heterocyclic ring,
R^{F1} each independently represents —(Rf)ₚ—R^{F}—(O)_{q},
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom, and
R³ each independently represents a C₁₋₄ alkyl group optionally substituted with one or more fluorine atoms, a hydrogen atom, or a fluorine atom,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R¹³ each independently represents one selected from a C₁₋₄ alkyl group optionally substituted with one or more fluorine atoms, a hydrogen atom, a fluorine atom, a chlorine atom, an iodine atom, and —CF₂—(R^{F1})ᵣ—X¹—R¹,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1, q is each independently 0 or 1, r is each independently 0 or 1, s each independently represents an integer of 0 to 5,
xc represents an integer of 1 to 10,000, zc1 represents an integer of 1 to 10,000, zc2 represents an integer of 1 to 10,000,
the order of occurrence of units enclosed by parentheses with xc, zc1, and zc2 is not limited in Formula (V-c),
the number of —CF₂—(R^{F1})ᵣ—X¹—R¹ included in Formula (V-c) is one or more, and
asterisks * in the formulas are bonded to each other.

<16>

The fluorine-containing polymer according to <12>, wherein the fluorine-containing polymer is represented by the following Formula (V-d):

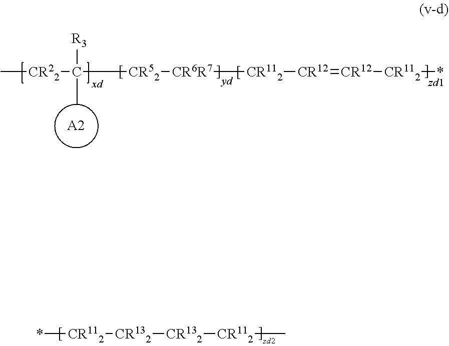

wherein A2 each independently represents one or more selected from a ring represented by the following formula:

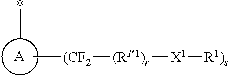

and a ring represented by the following formula:

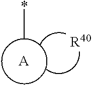

wherein each independently A represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom, and
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
R¹³ each independently represents one selected from a C₁₋₄ alkyl group optionally substituted with one or more fluorine atoms, a hydrogen atom, a fluorine atom, a chlorine atom, an iodine atom, and —CF₂—(R^{F1})ᵣ—X¹—R¹,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom, and —CH₂-on the ring is optionally substituted with one or more selected from —O—, —S— and —NH—,
p is each independently 0 or 1, q is each independently 0 or 1, r is each independently 0 or 1, s each independently represents an integer of 0 to 5,
xd represents an integer of 1 to 10,000, yd represents an integer of 1 to 10,000, zd1 represents an integer of 1 to 10,000, zd2 represents an integer of 1 to 10,000,
the order of occurrence of units enclosed by parentheses with xd, yd, and zd is not limited in Formula (V-d),
the number of —CF₂—(R^{F1})ᵣ—X¹—R¹ included in Formula (V-d) is one or more, and
asterisks * in the formulas are bonded to each other.

<17>

The fluorine-containing polymer according to <12>, wherein the fluorine-containing polymer is represented by the following Formula (V-e):

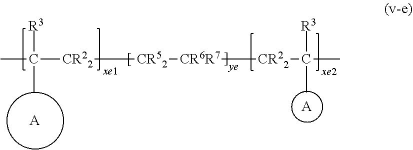

wherein A2 each independently represents one or more selected from a ring represented by the following formula:

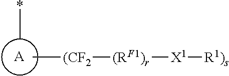

and a ring represented by the following formula:

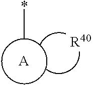

wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom, and
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1, q is each independently 0 or 1, r is each independently 0 or 1, s each independently represents an integer of 0 to 5,
xe1 represents an integer of 1 to 10,000, xe2 represents an integer of 1 to 10,000, ye represents an integer of 1 to 10,000, and
the order of occurrence of units enclosed by parentheses with xe1, xe2, and ye is not limited in Formula (V-e), and
the number of —CF₂—(R^{F1})ᵣ—X¹—R¹ included in Formula (V-e) is one or more.

<18>

The fluorine-containing polymer according to <12>, wherein the fluorine-containing polymer is represented by the following the Formula (V-f):

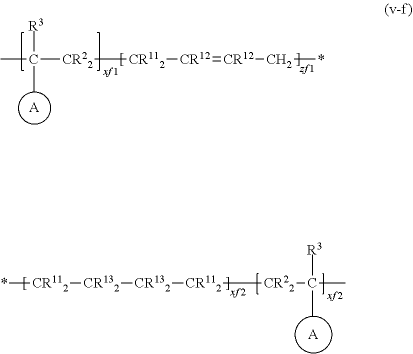

wherein A2 each independently represents one or more selected from a ring represented by the following formula:

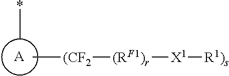

and a ring represented by the following formula:

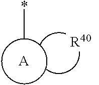

wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom, and
R³ each independently represents a C₁₋₄ alkyl group optionally substituted with one or more fluorine atoms, a hydrogen atom, or a fluorine atom,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
R¹³ each independently represents one selected from a C₁₋₄ alkyl group optionally substituted with one or more fluorine atoms, a hydrogen atom, a fluorine atom, a chlorine atom, an iodine atom, and —CF₂—(R^{F1})ᵣ—X¹—R¹,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1, q is each independently 0 or 1, r is each independently 0 or 1, s each independently represents an integer of 0 to 5,
xf1 represents an integer of 1 to 10,000, xf2 represents an integer of 1 to 10,000, zf1 represents an integer of 1 to 10,000, zf2 represents an integer of 1 to 10,000,
the order of occurrence of units enclosed by parentheses with xf1, xf2, zf1, and zf2 is not limited in Formula (V-f),
the number of —CF₂—(R^{F1})ᵣ—X¹—R¹ included in Formula (V-f) is one or more, and
asterisks * in the formulas are bonded to each other.

<19>

An article including: a base material; and a layer that is formed on a surface of the base material and formed with a surface treatment agent, wherein
the base material comprises a polymer comprising a unit represented by the following Formula (I):

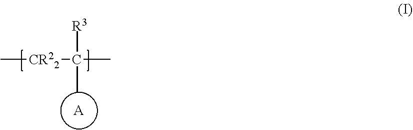

wherein A represents an aromatic ring or an aromatic heterocyclic ring,
R² represents a hydrogen atom or a fluorine atom, and
R³ represents a C₁₋₄ alkyl group optionally substituted with one or more fluorine atoms, a hydrogen atom, or a fluorine atom, and
the surface treatment agent comprises a fluorine-containing compound represented by Formula (II):

R¹—X¹—(R^{F1})ᵣ—CF₂—I (II)
wherein R^{F1} represents —(Rf)ₚ—R^{F}(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R¹ represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom, R^{f4} each independently represents a hydrogen atom or a fluorine atom,
p is 0 or 1, q is 0 or 1, and r is 0 or 1.

<20>

A method for producing an article, the method including reacting a base material and a surface treatment agent to form a layer on a surface of the base material, wherein
the base material comprises a polymer comprising a unit represented by the following Formula (I):

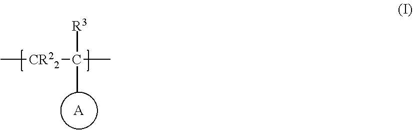

wherein A represents an aromatic ring or an aromatic heterocyclic ring,
R² represents a hydrogen atom or a fluorine atom, and
R³ represents a C₁₋₄ alkyl group optionally substituted with one or more fluorine atoms, a hydrogen atom, or a fluorine atom, and
the surface treatment agent comprises a fluorine-containing compound represented by Formula (II):

R¹—X¹—(R^{F1})ᵣ—CF₂—I (II)
wherein R^{F1} represents —(Rf)ₚ—R^{F}(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R¹ represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f2}₂, a fluorine atom, a chlorine atom, a bromine atom, or an iodine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is 0 or 1, q is 0 or 1, and r is 0 or 1.

### Effects of the Invention

According to the present disclosure, it is possible to provide a method for producing a novel fluorine-containing polymer into which various fluorine-containing groups are introduced, and a novel fluorine-containing polymer.

### DETAILED DESCRIPTION

(Method for Producing Fluorine-Containing Polymer)

A method for producing a fluorine-containing polymer of the present disclosure includes reacting a polymer containing a unit represented by the following Formula (I):

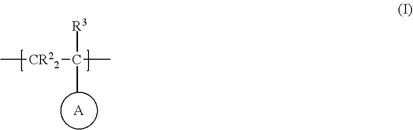

wherein A represents an aromatic ring or an aromatic heterocyclic ring,
R² represents a hydrogen atom or a fluorine atom, and
R³ represents a C₁₋₄ alkyl group optionally substituted with one or more fluorine atoms, a hydrogen atom, or a fluorine atom, with a fluorine-containing compound represented by the following Formula (II):

R¹—X¹—(R^{F1})ᵣ—CF₂—I (II)
wherein R^{F1} represents —(Rf)ₚ—R^{F}(O)_{q},
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R¹ represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is 0 or 1, q is 0 or 1, and r is 0 or 1, and
to obtain a fluorine-containing polymer containing a unit represented by the following Formula (III):

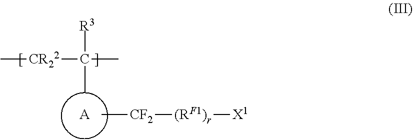

wherein A, R^{F1}, X¹, R¹, R², R³ and r have the same meaning as described above.

Further, the method for producing a fluorine-containing polymer of the present disclosure includes reacting a polymer containing a unit represented by the Formula (I):

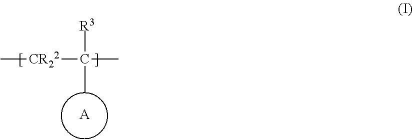

wherein A represents an aromatic ring or an aromatic heterocyclic ring,
R² represents a hydrogen atom or a fluorine atom, and
R³ represents a C₁₋₄ alkyl group optionally substituted with one or more fluorine atoms, a hydrogen atom, or a fluorine atom, with a fluorine-containing compound represented by the following Formula (VI):

I—R⁴⁰—I (VI)
wherein R⁴⁰ represents a C₃₋₆ alkylene group optionally substituted with one or more halogen atoms,
to obtain a fluorine-containing polymer containing a unit represented by the following Formula (VII):

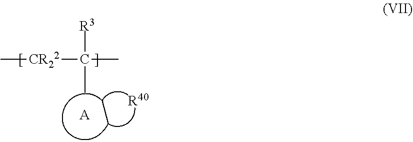

wherein A, R², R³ and R⁴⁰ have the same meaning as described above.

According to the present production method, a novel method for producing a fluorine-containing polymer into which various fluorine-containing groups are introduced can be provided. In the production method of the present disclosure, a polymer containing a styrene unit is produced in advance and a fluorine-containing group is introduced, and an iodide is used for introduction of the fluorine-containing group. It is therefore expected to be possible to provide a fluorine-containing polymer having both characteristics such as processability derived from the polymer and characteristics such as high chemical and thermal robustness, high water and oil repellency, and low refractive index derived from the fluorine-containing group. In addition, with the present production method, it is possible to easily produce a desired fluorine-containing polymer in a short process, as compared with the production method in which a styrene monomer having a fluorine-containing group is synthesized and then the synthesized monomer is polymerized, as described in Non-Patent Document 1. In addition, the present production method can be applied to any polymer that contains a styrene unit in principle, and enables use of a wide variety of widely distributed polymers containing a styrene unit as raw materials for the production of novel fluorine-containing polymers corresponding to the polymers. In addition, unlike Non-Patent Documents 2 to 5, in the present production method, a reagent to be used is inexpensive, safe, and easy to handle, and only an iodide is an essential reagent to be added. Therefore, the present production method can also be applied to the surface of a molded article formed of a polymer containing a styrene unit.

Further, by using a specific iodine compound as the iodine compound having a fluorine-containing group, it is also possible to convert an aromatic ring into a perfluoroalkyl ring, and it is expected that specific properties can be imparted to the polymer.

The polymer is only required to contain the unit represented by Formula (I), and when the polymer contains two or more units represented by Formula (I), the two or more units represented by Formula (I) may be the same or different from each other. Similarly, the fluorine-containing polymer is only required to contain the unit represented by Formula (III), and when the fluorine-containing polymer contains two or more units represented by Formula (III), the two or more units represented by Formula (III) may be the same or different from each other.

A represents an aromatic ring or an aromatic heterocyclic ring.

The aromatic ring may be a group including a C₆₋₂₀ aromatic hydrocarbon group optionally having one or more substituents, and includes one or more C₆₋₂₀ aromatic hydrocarbon groups. The number of C₆₋₂₀ aromatic hydrocarbon groups included in the aromatic ring may be preferably one or more and five or less, and more preferably one or more and three or less. In the aromatic ring, two or more C₆₋₂₀ aromatic hydrocarbon groups may be bonded via a single bond or an organic group. Examples of such an organic group include linear or branched C₁₋₄ alkylene groups.

The “C₆₋₂₀ aromatic hydrocarbon group” in the group including a C₆₋₂₀ aromatic hydrocarbon group optionally having one or more substituents may be a monocyclic ring or a polycyclic ring, and in the case of a polycyclic ring, two or more rings may form a fused ring. The “C₆₋₂₀ aromatic hydrocarbon group” in the group including a C₆₋₂₀ aromatic hydrocarbon group optionally having one or more substituents may be preferably a C₆₋₁₅ aromatic hydrocarbon group, more preferably a C₆₋₁₀ aromatic hydrocarbon group, and still more preferably a phenyl group or a naphthyl group.

Examples of the “group including an aromatic hydrocarbon group” in the group including a C₆₋₂₀ aromatic hydrocarbon group optionally having one or more substituents include a phenyl group, a naphthyl group, a fluorenyl group, and a biphenyl group.

The aromatic heterocyclic ring may be a group including a C₃₋₂₀ aromatic heterocyclic group optionally having one or more substituents, and includes one or more C₃₋₂₀ aromatic heterocyclic groups. The number of C₃₋₂₀ aromatic heterocyclic groups included in the aromatic heterocyclic ring may be preferably one or more and five or less, and more preferably one or more and three or less. In such an aromatic heterocyclic ring, two or more C₃₋₂₀ aromatic heterocyclic groups may be bonded via a single bond or an organic group. Examples of such an organic group include linear or branched C₁₋₄ alkylene groups.

The “C₃₋₂₀ aromatic heterocyclic group” in the group including a C₃₋₂₀ aromatic heterocyclic group optionally having one or more substituents may be a monocyclic ring or a polycyclic ring, and in the case of a polycyclic ring, two or more rings may form a fused ring. The “C₃₋₂₀ aromatic heterocyclic group” in the group including a C₃₋₂₀ aromatic heterocyclic group optionally having one or more substituents is preferably a C₃₋₁₅ aromatic heterocyclic group, and more preferably a pyridyl group or a carbazolyl group.

Examples of the substituent in the group including a C₆₋₂₀ aromatic hydrocarbon group optionally having one or more substituents and the group including a C₃₋₂₀ aromatic heterocyclic group optionally having one or more substituents include halogen atoms such as a fluorine atom, a chlorine atom, a bromine atom, and an iodine atom; a hydroxyl group; C₁₋₁₆ alkyl groups optionally substituted with one or more fluorine atoms; C₁₋₁₆ alkoxy groups; R²³—O—CO— wherein R²³ represents a C₁₋₁₆ alkyl group; NH₂—; R²³—NH—; R²³₂N—; R²³—NH—CO—; Ph₂N—; and Ph₂P—.

The “C₁₋₁₆ alkyl group” in the C₁₋₁₆ alkyl group optionally substituted with one or more fluorine atoms may be linear or branched, and is preferably a linear or branched C₁₋₁₀ alkyl group, and more preferably a linear or branched C₁₋₈ alkyl group. In one aspect, the C₁₋₁₆ alkyl group is a linear or branched C₁₋₄ alkyl group, and specifically may be —CH₃, —CH₂CH₃, —CH₂CH₂CH₃, —CH(CH₃)₂, —CH₂CH₂CH₂CH₃, —CH₂CH(CH₃)₂, or —CH(CH₃)₃.

In one aspect, the C₁₋₁₆ alkyl group optionally substituted with one or more fluorine atoms is a C₁₋₁₆ alkyl group not substituted with a fluorine atom. In another aspect, the C₁₋₁₆ alkyl group optionally substituted with one or more fluorine atoms is preferably a C₁₋₁₆ fluoroalkyl group substituted with one or more fluorine atoms, more preferably a C₁₋₁₆ perfluoroalkyl group, and still more preferably a C₁₋₆ perfluoroalkyl group.

The C₁₋₁₆ perfluoroalkyl group may be linear or branched, and is preferably a linear or branched C₁₋₁₀ perfluoroalkyl group, more preferably a linear or branched C₁₋₆ perfluoroalkyl group, and specifically may be —CF₃, —CF₂CF₃, —CF₂CF₂CF₃, —CF(CF₃)₂, —CF₂CF₂CF₂CF₃, —CF₂CF(CF₃)₂, or —CF(CF₃)₃.

The C₁₋₁₆ alkoxy group may be linear or branched, and is preferably a linear or branched C₁₋₁₀ alkoxy group, and more preferably a linear or branched C₁₋₈ alkoxy group. In one aspect, the C₁₋₁₆ alkoxy group is a linear or branched C₁₋₄ alkoxy group, and specifically may be —O—CH₃, —O—CH₂CH₃, —O—CH₂CH₂CH₃, —O—CH(CH₃)₂, —O—CH₂CH₂CH₂CH₃, —O—CH₂CH(CH₃)₂, —O—C(CH₃)₃.

The C₁₋₁₆ alkyl group represented by R²³ may be a linear or branched, and is preferably a C₁₋₁₀ alkyl group, and more preferably a linear or branched C₁₋₈ alkyl group. In one aspect, the C₁₋₁₆ alkyl group is a linear or branched C₁₋₄ alkyl group, and specifically may be —CH₃, —CH₂CH₃, —CH₂CH₂CH₃, —CH(CH₃)₂, —CH₂CH₂CH₂CH₃, —CH₂CH(CH₃)₂, or —CH(CH₃)₃.

In the present disclosure, a structure in which —CF₂—(R^{F1})ᵣ—X¹—R¹ is bonded to the ring A means that a hydrogen atom contained in the ring A is substituted with —CF₂—(R^{F1})ᵣ—X¹—R¹, and a structure in which —CF₂—(R^{F1})ᵣ—X¹—R³¹ is bonded to the ring A also means that a hydrogen atom contained in the ring A is substituted with —CF₂—(R^{F1})ᵣ—X¹—R³¹.

The substitution position of —CF₂—(R^{F1})ᵣ—X¹—R¹ in the ring A may be any of the p-position, m-position, and o-position as viewed from the main chain (carbon atom to which the ring A is bonded to the main chain), and may be preferably the p-position. When the substituent in the ring A is a hydroxyl group or a C₁₋₁₆ alkoxy group located at the p-position as viewed from the main chain, the substitution position of —CF₂—(R^{F1})ᵣ—X¹—R¹ in the ring A may be the m-position as viewed from the main chain.

Examples of the aromatic ring or aromatic heterocyclic ring represented by A include the following groups.

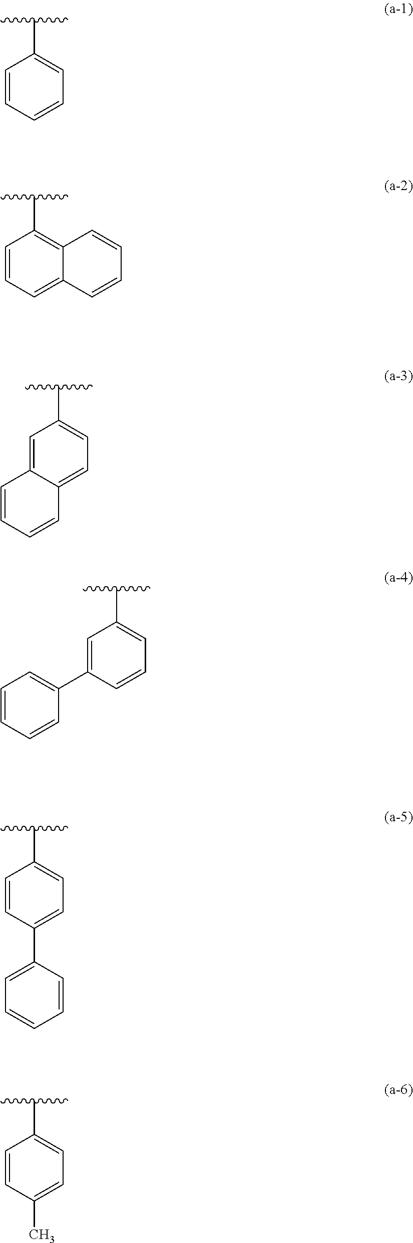

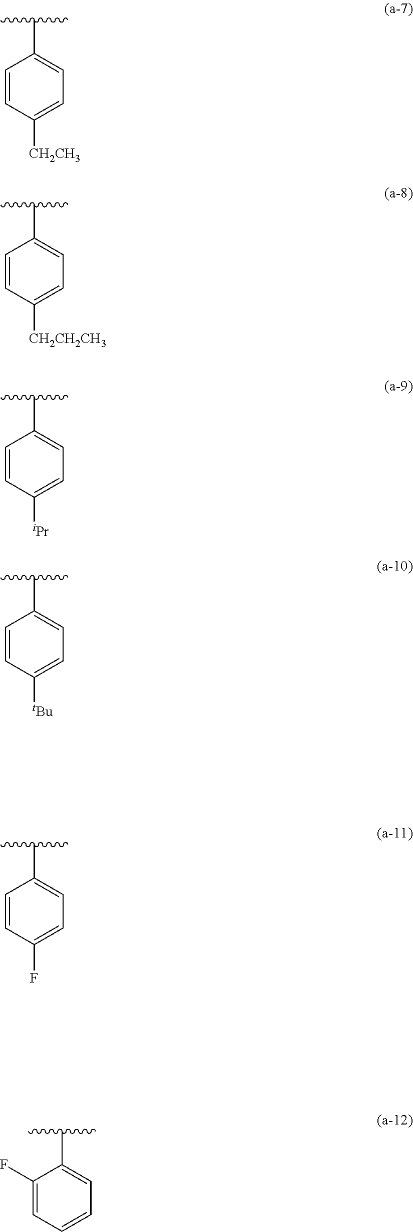

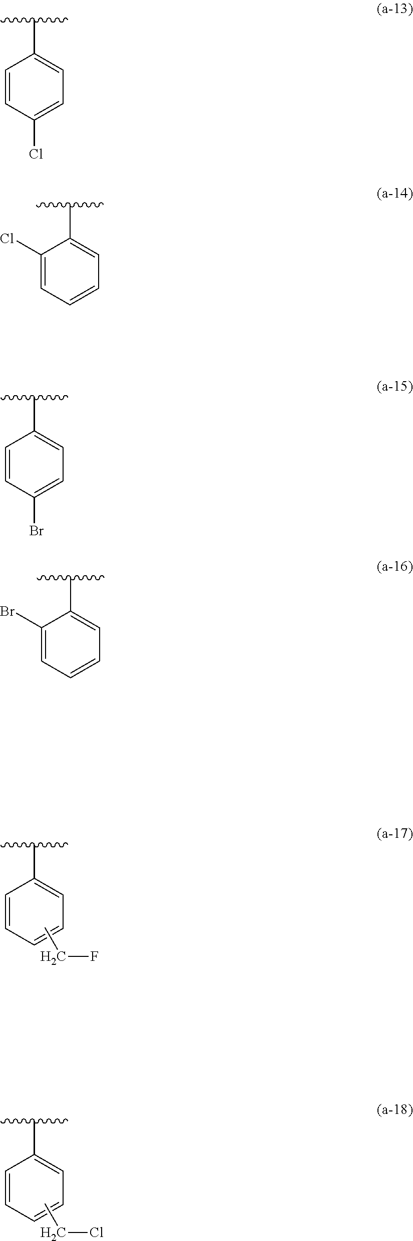

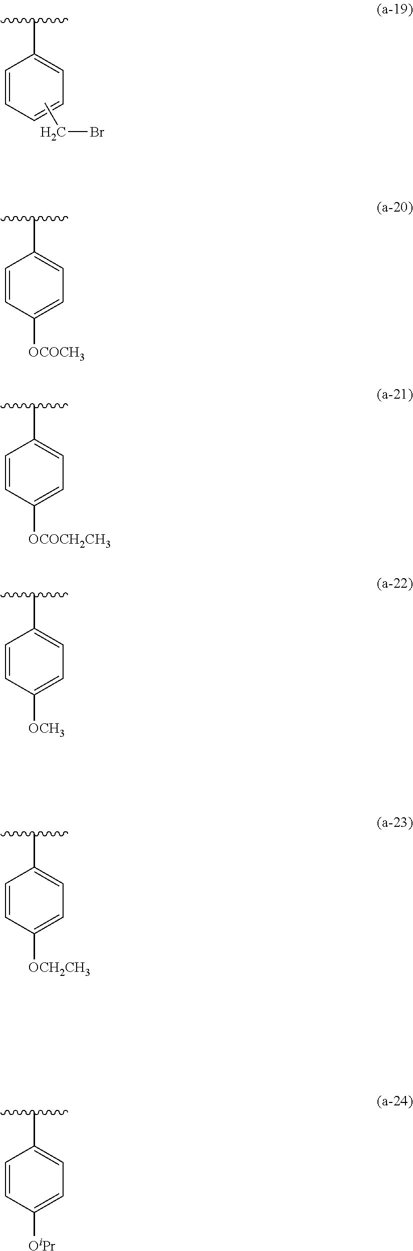

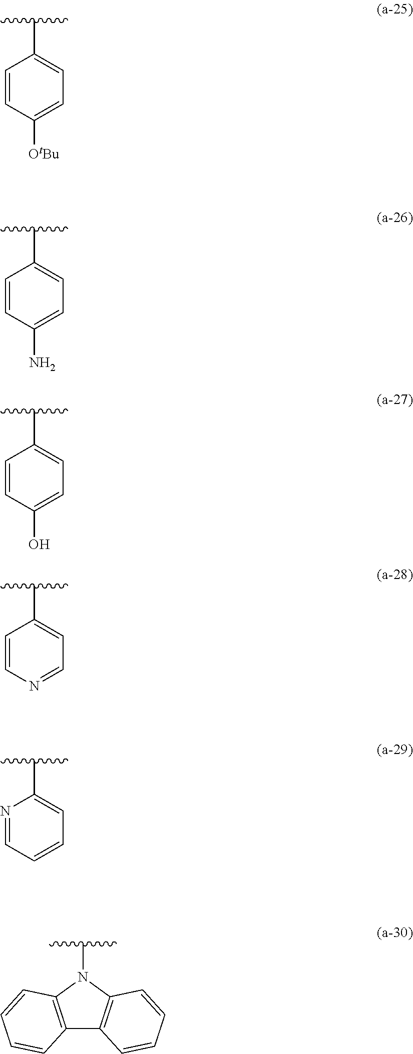

In one aspect, the aromatic ring or aromatic heterocyclic ring represented by A is preferably a ring represented by Formula (a-1), (a-2), (a-3), (a-5), (a-6), (a-10), (a-11), (a-12), (a-13), (a-18), (a-20), (a-22), (a-25), (a-26), (a-27), (a-28), (a-29) or (a-30), and more preferably a ring represented by Formula (a-1), (a-2), (a-11), (a-12), (a-13), (a-20), (a-22), (a-27) or (a-29).

In another aspect, the aromatic ring or aromatic heterocyclic ring represented by A is preferably a ring represented by Formula (a-1), (a-2), (a-3), (a-5), (a-6), (a-10), (a-11), (a-12), (a-18), (a-20), (a-22), (a-25), (a-26), (a-27), (a-28), (a-29) or (a-30), and more preferably a ring represented by Formula (a-1), (a-11), (a-12), (a-20), (a-22), (a-27) or (a-29).

R² represents a hydrogen atom or a fluorine atom. In one aspect, R² is a hydrogen atom, and in another aspect, R² is a fluorine atom.

R³ represents a C₁₋₄ alkyl group optionally substituted with one or more fluorine atoms, a hydrogen atom, or a fluorine atom.

The “alkyl group” in the C₁₋₄ alkyl group optionally substituted with one or more fluorine atoms may be linear or branched, and is preferably a linear or branched C₁₋₃ alkyl group, and more preferably a C₁₋₂ alkyl group, that is, a methyl group or an ethyl group.

In one aspect, the C₁₋₄ alkyl group optionally substituted with one or more fluorine atoms is a C₁₋₄ alkyl group not substituted with a fluorine atom. In another aspect, the C₁₋₄ alkyl group optionally substituted with one or more fluorine atoms is a C₁₋₄ fluoroalkyl group substituted with a fluorine atom, and more preferably a C₁₋₄ perfluoroalkyl group.

The C₁₋₄ perfluoroalkyl group may be linear or branched, and is preferably a linear or branched C₁₋₃ perfluoroalkyl group, and more preferably a C₁₋₂ perfluoroalkyl group, that is, a trifluoromethyl group or a pentafluoroethyl group.

In one aspect, R³ is preferably a C₁₋₄ alkyl group optionally substituted with one or more fluorine atoms, or a hydrogen atom, and in another aspect, R³ is preferably a fluorine atom.

R^{F1} represents —(Rf)ₚ—R^{F}—(O)_{q}.

Rf each independently represents a C₁₋₁₆ alkylene group optionally substituted with one or more fluorine atoms.

The “C₁₋₁₆ alkylene group” in the C₁₋₁₆ alkylene group optionally substituted with one or more fluorine atoms may be linear or branched, and is preferably a linear or branched C₁₋₆ alkylene group, and more preferably a linear C₁₋₃ alkylene group.

Rf is preferably a C₁₋₁₆ fluoroalkylene group substituted with one or more fluorine atoms, more preferably a C₁₋₁₆ perfluoroalkylene group, still more preferably a C₁₋₆ perfluoroalkylene group, and still even more preferably a C₁₋₃ perfluoroalkylene group.

The C₁₋₁₆ perfluoroalkylene group may be linear or branched, and is preferably a linear or branched C₁₋₆ perfluoroalkylene group, more preferably a linear or branched C₁₋₃ perfluoroalkylene group, and specifically —CF₂—, —CF₂CF₂—, CF₂CF₂CF₂—, and CF₂CF(CF₃)—.

R^{F} represents a divalent fluoro(poly)ether group. In the present disclosure, the fluoro(poly)ether group means a fluoroether group and/or a fluoropolyether group. When the fluorine-containing polymer of the present disclosure contains R^{F}, properties of the fluoro(poly)ether group can be imparted, and flexibility, heat resistance, friction characteristics, antifouling properties, and water and oil repellency can be improved.

R^{F} is preferably a group represented by the following formula:

—(OC₄F₈)_{c}—(OC₃R^{Fa}₆)_{d}—(OC₂F₄)ₑ—(OCF₂)_{f}—
wherein R^{Fa} is each independently a hydrogen atom, a fluorine atom, or a chlorine atom,
c, d, e, and f are each independently an integer of 0 to 200, and the sum of c, d, e, and f is 1 or more, the order of occurrence of each repeating unit enclosed by parentheses with c, d, e, or f is not limited in the formula, provided that, when all R^{Fa}s are hydrogen atoms or chlorine atoms, at least one of c, e, or f is 1 or more (hereinafter, also referred to as a group represented by “PFPE”).

R^{Fa} is preferably a hydrogen atom or a fluorine atom, and more preferably a fluorine atom. Provided that, when all R^{Fa}s are hydrogen atoms or chlorine atoms, at least one of c, e, or f is 1 or more.

c, d, e and f may preferably each independently be an integer of 0 to 100.

The sum of c, d, e, and f is preferably 5 or more, more preferably 10 or more, and may be, for example, 15 or more, or 20 or more. The sum of c, d, e, and f is preferably 200 or less, more preferably 100 or less, and still more preferably 60 or less, and may be, for example, 50 or less, or 30 or less.

These repeating units may be linear or branched. For example, —(OC₄F₈)— may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C₂F₅)CF₂)—, and —(OCF₂CF(C₂F₅))—. —(OC₃F₆)— (that is, in the above formula, R^{Fa} is a fluorine atom) may be any of —(OCF₂CF₂CF₂)—, —(OCF(CF₃)CF₂)—, and —(OCF₂CF(CF₃))—, and is preferably either —(OCF(CF₃)CF₂)— or —(OCF₂CF(CF₃))—. —(OC₂F₄)— may be either —(OCF₂CF₂)— or —(OCF(CF₃))—.

In one aspect, R^{F} is each independently a group represented by the following Formula (f1):

—(OC₃F₆)_{d}—(OCF₂)_{f}— (f1)
wherein d is an integer of 0 to 200 and f is an integer of 1 to 200.

OC₃F₆ in Formula (f1) is preferably (OCF₂CF₂CF₂), (OCF(CF₃)CF₂) or (OCF₂CF(CF₃)), and more preferably (OCF₂CF(CF₃)).

In Formula (f1), d is preferably an integer of 0 to 100, more preferably 0 to 50, and still more preferably 0 to 10. In one aspect, d is 0. In another aspect, d is preferably 1 to 100, more preferably 2 to 50, and still more preferably 3 to 10.

In Formula (f1), f is preferably 1 to 100, more preferably 1 to 10, still more preferably 1 to 5, and still even more preferably 1 to 3. In one aspect, f is 1.

p is 0 or 1. In one aspect, p is 0. In another aspect, p is 1.

q is 0 or 1. In one aspect, q is 0. In another aspect, q is 1.

r is 0 or 1. In one aspect, r is 0. In another aspect, r is 1.

X¹ represents a C₁₋₁₆ alkylene group optionally substituted with one or more halogen atoms, or a single bond.

The “C₁₋₁₆ alkylene group” in the C₁₋₁₆ alkylene group optionally substituted with one or more halogen atoms may be linear or branched, and is preferably a linear or branched C₁₋₁₀ alkylene group, and more preferably a linear or branched C₁₋₅ alkylene group. In one aspect, the C₁₋₁₆ alkylene group is preferably a branched C₂₋₄ alkylene group, and in another aspect, the C₁₋₁₆ alkylene group is preferably a linear C₂₋₅ alkylene group.

In one aspect, when R¹ is an iodine atom and r is 0, the C₁₋₁₆ alkylene group represented by X¹ preferably does not include a C₂₋₅ alkylene group optionally substituted with one or more fluorine atoms, and more preferably does not include a C₃ alkylene group optionally substituted with one or more fluorine atoms.

Examples of the halogen atom in the C₁₋₁₆ alkylene group optionally substituted with one or more halogen atoms include a fluorine atom, a chlorine atom, a bromine atom, and an iodine atom, and preferably include a fluorine atom and an iodine atom.

The C₁₋₁₆ alkylene group optionally substituted with one or more halogen atoms is preferably —CF₂—, —CF₂CF₂—, —CF(CF₃)—, —CF₂CF₂CF₂—, —CF₂CF(CF₃)—, —CF₂CF₂CF₂CF₂—, —CF₂CF₂CF₂CF₂CF₂—, or —CHI—CH₂—CF₂CF₂CF₂—, and more preferably —CF₂CF₂—, —CF(CF₃)—, —CF₂CF(CF₃)—, —CF₂CF₂CF₂CF₂CF₂—, or —CHI—CH₂—CF₂CF₂CF₂—.

X¹ is preferably a linear or branched C₁₋₁₀ alkylene group optionally substituted with one or more halogen atoms, or a single bond, and more preferably a linear or branched C₁₋₅ alkylene group optionally substituted with one or more selected from a fluorine atom and an iodine atom, or a single bond.

R¹ represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom. R¹ preferably represents a C₁₋₁₆ alkyl group optionally substituted with one or more halogen atoms, a C₆₋₂₀ aromatic hydrocarbon group optionally having one or more substituents, —COOR^{f2}, —OR^{f2}, —SO₂R^{f3}, —CR^{f4}═CR^{f4}₂, a fluorine atom, a bromine atom, or an iodine atom.

The “C₁₋₁₆ alkyl group” in the C₁₋₁₆ alkyl group optionally substituted with one or more halogen atoms represented by R¹ may be linear or branched, and is preferably a linear or branched C₁₋₁₀ alkyl group, and more preferably a linear or branched C₁₋₆ alkyl group. In one aspect, the C₁₋₁₆ alkyl group is a linear or branched C₁₋₄ alkyl group, and specifically may be —CH₃, —CH₂CH₃, —CH₂CH₂CH₃, —CH(CH₃)₂, —CH₂CH₂CH₂CH₃, —CH₂CH(CH₃)₂, or —CH(CH₃)₃.

Examples of the halogen atom in the C₁₋₁₆ alkyl group optionally substituted with one or more halogen atoms include a fluorine atom, a chlorine atom, a bromine atom, and an iodine atom, and preferably include a fluorine atom and an iodine atom.

In one aspect, the C₁₋₁₆ alkyl group optionally substituted with one or more halogen atoms is a C₁₋₁₆ alkyl group not substituted with a halogen atom. In another aspect, the C₁₋₁₆ alkyl group optionally substituted with one or more halogen atoms is preferably a C₁₋₁₆ fluoroalkyl group substituted with one or more fluorine atoms, more preferably a C₁₋₁₆ perfluoroalkyl group, and still more preferably a C₁₋₆ perfluoroalkyl group.

The C₁₋₁₆ perfluoroalkyl group may be linear or branched, and is preferably a linear or branched C₁₋₁₀ perfluoroalkyl group, more preferably a linear or branched C₁₋₆ perfluoroalkyl group, and specifically may be —CF₃, —CF₂CF₃, —CF₂CF₂CF₃, —CF(CF₃)₂, —CF₂CF₂CF₂CF₃, —CF₂CF(CF₃)₂, or —CF(CF₃)₃.

The “C₆₋₂₀ aromatic hydrocarbon group” in the C₆₋₂₀ aromatic hydrocarbon group optionally having one or more substituents represented by R¹ may be a monocyclic ring or a polycyclic ring, and in the case of a polycyclic ring, two or more rings may or may not form a fused ring. The “C₆₋₂₀ aromatic hydrocarbon group” in the C₆₋₂₀ aromatic hydrocarbon group optionally having one or more substituents is preferably a C₆₋₁₅ aromatic hydrocarbon group, more preferably a C₆₋₁₀ aromatic hydrocarbon group, and still more preferably a phenyl group.

Examples of the substituent in the C₆₋₂₀ aromatic hydrocarbon group optionally having one or more substituents include halogen atoms such as a fluorine atom, a chlorine atom, a bromine atom, and an iodine atom; C₁₋₄ alkyl groups; C₁₋₄ alkoxy groups; and R²⁰—O—CO— wherein R²⁰ represents a C₁₋₄ alkyl group. The substituent is preferably a halogen atom, and particularly preferably a fluorine atom. R²⁰ may be linear or branched, and is preferably a linear or branched C₁₋₃ alkyl group, and specifically, —CH₃, —CH₂CH₃ are preferable.

The C₆₋₂₀ aromatic hydrocarbon group represented by R¹ is preferably a C₆₋₁₀ aromatic hydrocarbon group optionally having one or more substituents, and more preferably a C₆₋₁₀ aromatic hydrocarbon group optionally having one or more substituents. In one aspect, the C₆₋₂₀ aromatic hydrocarbon group represented by R¹ preferably has a substituent, and in another aspect, the C₆₋₂₀ aromatic hydrocarbon group represented by R¹ preferably does not have a substituent.

The “silsesquioxane residue” in the silsesquioxane residue optionally having one or more substituents represented by R¹ is a monovalent group in which one substituent on Si in silsesquioxane has been eliminated. The silsesquioxane residue may has any of a basket structure, a double decker structure, a ladder structure, and a random structure, and has preferably a basket structure.

The substituent in the silsesquioxane residue optionally having one or more substituents is preferably a C₁₋₁₀ alkyl group optionally substituted with one or more halogen atoms; or a phenyl group, and more preferably a C₁₋₆ alkyl group optionally substituted with one or more halogen atoms; or a phenyl group.

The “C₁₋₁₀ alkyl group” in the C₁₋₁₀ alkyl group optionally substituted with one or more halogen atoms as a substituent of the silsesquioxane residue may be linear or branched, and is preferably a linear or branched C₁₋₆ alkyl group, and more preferably an isobutyl group.

Examples of the halogen atom in the C₁₋₁₀ alkyl group optionally substituted with one or more halogen atoms as a substituent of the silsesquioxane residue include a fluorine atom, a chlorine atom, a bromine atom, and an iodine atom, and preferably include a fluorine atom and an iodine atom.

The C₁₋₁₀ alkyl group optionally substituted with one or more halogen atoms as a substituent of the silsesquioxane residue is preferably —CHI—CH₂—CF₂CF₂—I, —CHI—CH₂—CF₂CF₂CF₂CF₂—I, —CHI—CH₂—CF₂CF₂CF₂CF₂CF₂CF₂—I, and more preferably —CHI—CH₂—CF₂CF₂CF₂CF₂—I.

The substituent in the silsesquioxane residue optionally having one or more substituents is preferably a phenyl group or an isobutyl group.

R^{f2} each independently represents a C₁₋₁₆ alkyl group optionally substituted with one or more fluorine atoms, or a hydrogen atom, and preferably a C₁₋₁₆ alkyl group optionally substituted with one or more fluorine atoms.

The “C₁₋₁₆ alkyl group” in the C₁₋₁₆ alkyl group optionally substituted with one or more fluorine atoms may be linear or branched, and is preferably a linear or branched C₁₋₁₀ alkyl group, more preferably a linear or branched C₁₋₅ alkyl group, and particularly preferably a C₁₋₂ alkyl group.

The C₁₋₁₆ alkyl group optionally substituted with one or more fluorine atoms is preferably a methyl group, an ethyl group, a trifluoromethyl group, or a pentafluoroethyl group.

R^{f3} represents a C₁₋₁₆ alkyl group optionally substituted with one or more halogen atoms, a fluorine atom, or a hydrogen atom.

The “C₁₋₁₆ alkyl group” in the C₁₋₁₆ alkyl group optionally substituted with one or more halogen atoms may be linear or branched, and is preferably a linear or branched C₁₋₁₀ alkyl group, more preferably a linear or branched C₁₋₅ alkyl group, and particularly preferably a C₁₋₂ alkyl group.

Examples of the halogen atom in the C₁₋₁₆ alkyl group optionally substituted with one or more halogen atoms include a fluorine atom, a chlorine atom, a bromine atom, and an iodine atom, and preferably include a fluorine atom.

R^{f3} is preferably a C₁₋₅ alkyl group optionally substituted with one or more halogen atoms, or a fluorine atom, and more preferably a fluorine atom.

R^{f4} each independently represents a hydrogen atom or a fluorine atom. In one aspect, R^{f4} is a hydrogen atom, and in another aspect, R^{f4} is a fluorine atom.

When R¹ is an iodine atom, in the unit represented by Formula (III), R¹ is optionally substituted with a bond, and X¹ bonded to R¹ is optionally bonded to another aromatic ring (an aromatic ring other than the aromatic ring to which R¹ is bonded via —X¹—(R^{F1})ᵣ—CF₂—, for example, an aromatic ring included in a unit represented by another Formula (I)). Although the present disclosure should not be construed as limited to a specific theory, the above structure is considered as follows. That is, in the method for producing a fluorine-containing polymer of the present disclosure, it is considered that the iodine atom of the compound represented by Formula (II) is extracted to form a reaction point, and the remaining structure of the compound from which the iodine atom has been extracted is bonded to the aromatic ring of the unit represented by Formula (I), whereby the structure represented by Formula (III) can be obtained. When R¹ is an iodine atom, it is considered that the iodine atom corresponding to R¹ may also be extracted, and the remaining structure may be bonded to another aromatic ring. The same applies to a case where the substituent of the group represented by R¹ contains an I atom, and the group bonded to the I atom may be bonded to another aromatic ring.

R¹ is preferably a C₁₋₁₆ alkyl group optionally substituted with one or more halogen atoms, a C₆₋₂₀ aromatic hydrocarbon group optionally having one or more substituents, —COOR^{f2}, —OR^{f2}, —SO₂R^{f3}, —CR^{f4}═CR^{f4}₂, a fluorine atom, a chlorine atom, a bromine atom or an iodine atom. R¹ is more preferably a C₁₋₁₆ alkyl group optionally substituted with one or more halogen atoms, a C₆₋₂₀ aromatic hydrocarbon group optionally having one or more substituents, —COOR^{f2}, —OR^{f2}, —SO₂R^{f3}, —CR^{f4}═CR^{f4}₂, a fluorine atom, a bromine atom, or an iodine atom.

R⁴⁰ represents a C₃₋₆ alkylene group optionally substituted with one or more fluorine atoms.

The “alkylene group” in the C₃₋₆ alkylene group optionally substituted with one or more fluorine atoms may be linear or branched. The alkylene group is preferably a linear or branched C₃₋₅ alkylene group, more preferably a linear C₃₋₅ alkylene group, that is, a propylene group, a butylene group, a pentanediyl group, and particularly preferably a linear butylene group.

In one aspect, the C₃₋₆ alkylene group optionally substituted with one or more fluorine atoms is a C₃₋₆ alkylene group not substituted with a fluorine atom. In another aspect, the C₃₋₆ alkylene group optionally substituted with one or more fluorine atoms is a C₃₋₆ fluoroalkylene group substituted with a fluorine atom, and more preferably a C₃₋₆ perfluoroalkylene group.

The C₃₋₆ perfluoroalkylene group may be linear or branched, and is preferably a linear or branched C₃₋₅ perfluoroalkylene group, more preferably a linear C₃₋₅ perfluoroalkylene group, that is, a hexafluoropropylene group, an octafluorobutylene group, a decafluoropentanediyl group, and particularly preferably a linear octafluorobutylene group.

In one aspect, R⁴⁰ is preferably a C₃₋₅ alkylene group optionally substituted with one or more fluorine atoms.

The symbol * represents a bond.

The polymer may contain a unit other than the unit represented by Formula (I). Examples of such a unit include units derived from a monomer containing an ethylenic double bond.

Specifically, the polymer preferably further contains one or more selected from a unit represented by the following Formula (IV-a):

[symbol]

CR⁵₂—CR⁶R⁷ [symbol] (IV-a)
wherein R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring containing a nitrogen atom, together with a nitrogen atom to which they are bonded, and —CH₂— on the ring is optionally substituted with —O—, or a unit represented by the following Formula (IV-b):

[symbol]

CR¹¹₂—CR¹²═CR¹²—CR¹¹₂ [symbol] (IV-b)
wherein R¹¹ each independently represents a C₁₋₄ alkyl group optionally substituted with one or more fluorine atoms, a hydrogen atom, or a fluorine atom, and
R¹² each independently represents a C₁₋₄ alkyl group optionally substituted with one or more fluorine atoms, a hydrogen atom, a fluorine atom, or a chlorine atom.

When the polymer contains the unit represented by Formula (IV-a), more excellent characteristics such as mechanical strength, heat resistance, oil resistance, and chemical resistance can be further imparted. When the polymer contains the unit represented by Formula (IV-b), more excellent characteristics such as stretchability, mechanical strength, processability, elasticity, and flexibility can be imparted.

The polymer may contain two or more of units represented by Formula (IV-a) or Formula (IV-b). When the polymer contains two or more units represented by Formula (IV-a) or the unit represented by Formula (IV-b), the two or more units represented by Formula (IV-a) may be the same or different from each other, and the two or more units represented by Formula (IV-b) may be the same or different from each other.

R⁵ each independently represents a hydrogen atom or a fluorine atom. In one aspect, R⁵ is a hydrogen atom, and in another aspect, R⁵ is a fluorine atom.

R⁶ each independently represents a C₁₋₄ alkyl group optionally substituted with one or more fluorine atoms, a hydrogen atom, a fluorine atom, or a chlorine atom.

The “alkyl group” in the C₁₋₄ alkyl group optionally substituted with one or more fluorine atoms may be linear or branched, and is preferably a linear or branched C₁₋₃ alkyl group, and more preferably a C₁₋₂ alkyl group, that is, a methyl group or an ethyl group.

In one aspect, the C₁₋₄ alkyl group optionally substituted with one or more fluorine atoms is a C₁₋₄ alkyl group not substituted with a fluorine atom. In another aspect, the C₁₋₄ alkyl group optionally substituted with one or more fluorine atoms is a C₁₋₄ fluoroalkyl group substituted with a fluorine atom, and more preferably a C₁₋₄ perfluoroalkyl group.

The C₁₋₄ perfluoroalkyl group may be linear or branched, and is preferably a linear or branched C₁₋₃ perfluoroalkyl group, and more preferably a C₁₋₂ perfluoroalkyl group, that is, a trifluoromethyl group or a pentafluoroethyl group.

In one aspect, R⁶ is preferably a C₁₋₄ alkyl group not substituted with a fluorine atom, or a hydrogen atom, in another aspect, R⁶ is preferably a C₁₋₄ fluoroalkyl group substituted with a fluorine atom, or a fluorine atom, and in still another aspect, R⁶ is preferably a chlorine atom.

R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom.

The “C₁₋₁₆ alkyl group” in the C₁₋₁₆ alkyl group optionally substituted with one or more fluorine atoms may be linear or branched, and is preferably a linear or branched C₁₋₁₀ alkyl group, and more preferably a linear or branched C₁₋₈ alkyl group. In one aspect, the C₁₋₁₆ alkyl group is a linear or branched C₁₋₄ alkyl group, and specifically may be —CH₃, —CH₂CH₃, —CH₂CH₂CH₃, —CH(CH₃)₂, —CH₂CH₂CH₂CH₃, —CH₂CH(CH₃)₂, or —CH(CH₃)₃.

In one aspect, the C₁₋₁₆ alkyl group optionally substituted with one or more fluorine atoms is a C₁₋₁₆ alkyl group not substituted with a fluorine atom. In another aspect, the C₁₋₁₆ alkyl group optionally substituted with one or more fluorine atoms is preferably a C₁₋₁₆ fluoroalkyl group substituted with one or more fluorine atoms, more preferably a C₁₋₁₆ perfluoroalkyl group, and still more preferably a C₁₋₆ perfluoroalkyl group.

The C₁₋₁₆ perfluoroalkyl group may be linear or branched, and is preferably a linear or branched C₁₋₁₀ perfluoroalkyl group, more preferably a linear or branched C₁₋₆ perfluoroalkyl group, and specifically may be —CF₃, —CF₂CF₃, —CF₂CF₂CF₃, —CF(CF₃)₂, —CF₂CF₂CF₂CF₃, —CF₂CF(CF₃)₂, or —CF(CF₃)₃.

In one aspect, the vinyl group optionally substituted with one or more fluorine atoms is preferably —CH═CH₂, and in another aspect, is preferably —CF═CF₂.

The C₁₋₁₆ hydroxyalkyl group may be linear or branched, and is preferably a linear or branched C₁₋₁₀ hydroxyalkyl group, and more preferably a linear or branched C₁₋₈ hydroxyalkyl group. In one aspect, the C₁₋₁₆ hydroxyalkyl group is a linear or branched C₁₋₄ hydroxyalkyl group, and specifically may be —CH₂—OH, —CH₂CH₂—OH, —CH₂CH₂CH₂—OH, —CH₂CH(OH)CH₂CH₃, or —CH₂CH₂CH₂CH₂—OH.

R⁸ each independently represents a C₁₋₁₆ alkyl group optionally substituted with one or more fluorine atoms, a sodium cation, a potassium cation, an ammonium cation, or a hydrogen atom.

The “C₁₋₁₆ alkyl group” in the C₁₋₁₆ alkyl group optionally substituted with one or more fluorine atoms may be linear or branched, and is preferably a linear or branched C₁₋₁₀ alkyl group, and more preferably a linear or branched C₁₋₈ alkyl group. In one aspect, the C₁₋₁₆ alkyl group is a linear or branched C₁₋₄ alkyl group, and specifically may be —CH₃, —CH₂CH₃, —CH₂CH₂CH₃, —CH(CH₃)₂, —CH₂CH₂CH₂CH₃, —CH₂CH(CH₃)₂, or —CH(CH₃)₃.

In one aspect, the C₁₋₁₆ alkyl group optionally substituted with one or more fluorine atoms is a C₁₋₁₆ alkyl group not substituted with a fluorine atom. In another aspect, the C₁₋₁₆ alkyl group optionally substituted with one or more fluorine atoms is preferably a C₁₋₁₆ fluoroalkyl group substituted with one or more fluorine atoms, more preferably a C₁₋₁₆ perfluoroalkyl group, and still more preferably a C₁₋₆ perfluoroalkyl group.

The C₁₋₁₆ perfluoroalkyl group may be linear or branched, and is preferably a linear or branched C₁₋₁₀ perfluoroalkyl group, more preferably a linear or branched C₁₋₆ perfluoroalkyl group, and specifically may be —CF₃, —CF₂CF₃, —CF₂CF₂CF₃, —CF(CF₃)₂, —CF₂CF₂CF₂CF₃, —CF₂CF(CF₃)₂, or —CF(CF₃)₃.

In one aspect, R⁸ is preferably a C₁₋₁₆ alkyl group optionally substituted with one or more fluorine atoms, and in another aspect, R⁸ is preferably a hydrogen atom.

R⁹ each independently represents a C₁₋₁₆ alkyl group optionally substituted with one or more fluorine atoms, or a hydrogen atom.

The “C₁₋₁₆ alkyl group” in the C₁₋₁₆ alkyl group optionally substituted with one or more fluorine atoms may be linear or branched, and is preferably a linear or branched C₁₋₁₀ alkyl group, and more preferably a linear or branched C₁₋₈ alkyl group. In one aspect, the C₁₋₁₆ alkyl group is a linear or branched C₁₋₄ alkyl group, and specifically may be —CH₃, —CH₂CH₃, —CH₂CH₂CH₃, —CH(CH₃)₂, —CH₂CH₂CH₂CH₃, —CH₂CH(CH₃)₂, or —CH(CH₃)₃.

In one aspect, the C₁₋₁₆ alkyl group optionally substituted with one or more fluorine atoms is a C₁₋₁₆ alkyl group not substituted with a halogen atom. In another aspect, the C₁₋₁₆ alkyl group optionally substituted with one or more fluorine atoms is preferably a C₁₋₁₆ fluoroalkyl group substituted with one or more fluorine atoms, more preferably a C₁₋₁₆ perfluoroalkyl group, and still more preferably a C₁₋₆ perfluoroalkyl group.

The C₁₋₁₆ perfluoroalkyl group may be linear or branched, and is preferably a linear or branched C₁₋₁₀ perfluoroalkyl group, more preferably a linear or branched C₁₋₆ perfluoroalkyl group, and specifically may be —CF₃, —CF₂CF₃, —CF₂CF₂CF₃, —CF(CF₃)₂, —CF₂CF₂CF₂CF₃, —CF₂CF(CF₃)₂, or —CF(CF₃)₃.

In one aspect, R⁹ is preferably a C₁₋₁₆ alkyl group optionally substituted with one or more fluorine atoms, and in another aspect, R⁹ is preferably a hydrogen atom.

R¹⁰ each independently represents a C₁₋₁₆ alkyl group optionally substituted with one or more fluorine atoms, or a hydrogen atom.

The “C₁₋₁₆ alkyl group” in the C₁₋₁₆ alkyl group optionally substituted with one or more fluorine atoms may be linear or branched, and is preferably a linear or branched C₁₋₁₀ alkyl group, and more preferably a linear or branched C₁₋₈ alkyl group. In one aspect, the C₁₋₁₆ alkyl group is a linear or branched C₁₋₄ alkyl group, and specifically may be —CH₃, —CH₂CH₃, —CH₂CH₂CH₃, —CH(CH₃)₂, —CH₂CH₂CH₂CH₃, —CH₂CH(CH₃)₂, or —CH(CH₃)₃.

In one aspect, the C₁₋₁₆ alkyl group optionally substituted with one or more fluorine atoms is a C₁₋₁₆ alkyl group not substituted with a halogen atom. In another aspect, the C₁₋₁₆ alkyl group optionally substituted with one or more fluorine atoms is preferably a C₁₋₁₆ fluoroalkyl group substituted with one or more fluorine atoms, more preferably a C₁₋₁₆ perfluoroalkyl group, and still more preferably a C₁₋₆ perfluoroalkyl group.

The C₁₋₁₆ perfluoroalkyl group may be linear or branched, and is preferably a linear or branched C₁₋₁₀ perfluoroalkyl group, more preferably a linear or branched C₁₋₆ perfluoroalkyl group, and specifically may be —CF₃, —CF₂CF₃, —CF₂CF₂CF₃, —CF(CF₃)₂, —CF₂CF₂CF₂CF₃, —CF₂CF(CF₃)₂, or —CF(CF₃)₃.

In one aspect, R¹⁰ is preferably a C₁₋₁₆ alkyl group optionally substituted with one or more fluorine atoms, and in another aspect, R¹⁰ is preferably a hydrogen atom.

R⁹ and R¹⁰ optionally form a ring containing a nitrogen atom, together with a nitrogen atom to which they are bonded, and —CH₂— on the ring is optionally substituted with one or more selected from —O—, —S—, and —NH—.

The ring containing a nitrogen atom, formed by R⁹ and R¹⁰ and a nitrogen atom to which they are bonded, may be a monocyclic ring or a polycyclic ring. The ring number of such a ring may be, for example, a 5 to 10 membered ring, preferably a 5 to 6 membered ring. The —CH₂— on the ring is preferably substituted with —O—.

Specific examples of such a ring include a pyrrolidine ring, a pyrroline ring, a piperidine ring, a piperazine ring, a morpholine ring, and a thiomorpholine ring, and a morpholine ring is preferable.

In one aspect, R⁷ is preferably a C₁₋₁₆ alkyl group optionally substituted with one or more fluorine atoms; in another aspect, R⁷ is preferably a vinyl group optionally substituted with one or more fluorine atoms; in still another aspect, R⁷ is preferably a C₁₋₁₆ hydroxyalkyl group; in still another aspect, R⁷ is preferably one selected from —CO—OR⁸, —CO—NR⁹R¹⁰, and a nitrile group; and in still another aspect, R⁷ is preferably one selected from a hydrogen atom, a fluorine atom, a chlorine atom, and an iodine atom.

R¹¹ each independently represents a C₁₋₄ alkyl group optionally substituted with one or more fluorine atoms, a hydrogen atom, or a fluorine atom.

The “alkyl group” in the C₁₋₄ alkyl group optionally substituted with one or more fluorine atoms may be linear or branched, and is preferably a linear or branched C₁₋₃ alkyl group, and more preferably a C₁₋₂ alkyl group, that is, a methyl group or an ethyl group.

In one aspect, the C₁₋₄ alkyl group optionally substituted with one or more fluorine atoms is a C₁₋₄ alkyl group not substituted with a fluorine atom. In another aspect, the C₁₋₄ alkyl group optionally substituted with one or more fluorine atoms is a C₁₋₄ fluoroalkyl group substituted with a fluorine atom, and more preferably a C₁₋₄ perfluoroalkyl group.

The C₁₋₄ perfluoroalkyl group may be linear or branched, and is preferably a linear or branched C₁₋₃ perfluoroalkyl group, and more preferably a C₁₋₂ perfluoroalkyl group, that is, a trifluoromethyl group or a pentafluoroethyl group.

In one aspect, R¹¹ is preferably a C₁₋₄ alkyl group not substituted with a fluorine atom, or a hydrogen atom, and in another aspect, R¹¹ is preferably a C₁₋₄ fluoroalkyl group substituted with a fluorine atom, or a fluorine atom.

R¹² each independently represents a C₁₋₄ alkyl group optionally substituted with one or more fluorine atoms, a hydrogen atom, a fluorine atom, or a chlorine atom.

The “alkyl group” in the C₁₋₄ alkyl group optionally substituted with one or more fluorine atoms may be linear or branched, and is preferably a linear or branched C₁₋₃ alkyl group, and more preferably a C₁₋₂ alkyl group, that is, a methyl group or an ethyl group.

In one aspect, the C₁₋₄ alkyl group optionally substituted with one or more fluorine atoms is a C₁₋₄ alkyl group not substituted with a fluorine atom. In another aspect, the C₁₋₄ alkyl group optionally substituted with one or more fluorine atoms is a C₁₋₄ fluoroalkyl group substituted with a fluorine atom, and more preferably a C₁₋₄ perfluoroalkyl group.

The C₁₋₄ perfluoroalkyl group may be linear or branched, and is preferably a linear or branched C₁₋₃ perfluoroalkyl group, and more preferably a C₁₋₂ perfluoroalkyl group, that is, a trifluoromethyl group or a pentafluoroethyl group.

In one aspect, R¹² is preferably a C₁₋₄ alkyl group not substituted with a fluorine atom, or a hydrogen atom, in another aspect, R¹² is preferably a C₁₋₄ fluoroalkyl group substituted with a fluorine atom, or a fluorine atom, and in still another aspect, R¹² is preferably a hydrogen atom or a chlorine atom.

Examples of R⁵, R⁶, and R⁷ in Formula (IV-a) include a combination in which R⁵ is a hydrogen atom, R⁶ is a hydrogen atom, and R⁷ is a hydrogen atom; a combination in which R⁵ is a hydrogen atom, R⁶ is a C₁₋₄ alkyl group optionally substituted with one or more fluorine atoms, and R⁷ is a hydrogen atom; a combination in which R⁵ is a hydrogen atom, R⁶ is a C₁₋₄ alkyl group, and R⁷ is a C₁₋₁₆ alkyl group optionally substituted with one or more fluorine atoms; a combination in which R⁵ is a hydrogen atom, R⁶ is a hydrogen atom, and R⁷ is a C₁₋₁₆ alkyl group optionally substituted with one or more fluorine atoms; a combination in which R⁵ is a hydrogen atom, R⁶ is a hydrogen atom, and R⁷ is a C₁₋₁₆ hydroxyalkyl group; a combination in which R⁵ is a hydrogen atom, R⁶ is a hydrogen atom, and R⁷ is a nitrile group; a combination in which R⁵ is a hydrogen atom, R⁶ is a hydrogen atom, and R⁷ is a chlorine atom; a combination in which R⁵ is a hydrogen atom, R⁶ is a hydrogen atom, and R⁷ is an iodine atom; and a combination in which R⁵ is a fluorine atom, R⁶ is a C₁₋₄ alkyl group optionally substituted with one or more fluorine atoms, or a fluorine atom, and R⁷ is a fluorine atom.

Examples of R¹¹ and R¹² in Formula (IV-b) include a combination in which R¹¹ is a hydrogen atom, and R¹² is a hydrogen atom; and a combination in which R¹¹ is a hydrogen atom, and R¹² is a C₁₋₄ alkyl group optionally substituted with one or more fluorine atoms, or a hydrogen atom.

When the polymer contains the unit represented by Formula (IV-b), the compound represented by Formula (II) may be added to the internal diene of the unit represented by Formula (IV-b) in the reaction between the polymer and the compound represented by Formula (II). Examples of an aspect of such addition include an aspect in which I— and R¹—X¹—(R^{F1})ᵣ—CF₂— of the compound represented by Formula (II) are added to two carbon atoms of —CR¹²═CCR¹²— of the unit represented by Formula (IV-b); an aspect in which when R¹ of the compound represented by Formula (II) is an iodine atom, the iodine atom represented by R¹ and —X¹—(R^{F1})ᵣ—CF₂—I are added to two carbon atoms of —CR¹²═CR¹²— of the unit represented by Formula (IV-b); and an aspect in which these aspects are combined. The aspect of such addition may be a combination of these aspects, that is, an aspect in which the compound represented by Formula (II) is added to —CR¹²═CR¹²— at both ends of the compound.

In the production method of the present disclosure, the compound represented by Formula (II) is considered to act mainly on the ring A, or —CR¹²═CCR¹²— which may be contained in the polymer, but may act on a carbon atom bonded to the ring A, and R¹—X¹—(R^{F1})ᵣ—CF₂— may be added to the carbon atom.

The number average molecular weight of the polymer may be preferably 1,000 or more and 1,000,000 or less, more preferably 2,000 or more and 500,000 or less, and still more preferably 7,000 or more and 200,000 or less.

In the present disclosure, the number average molecular weight can be measured by gel permeation chromatography, and a converted value using polystyrene as a standard sample can be taken as the number average molecular weight.

In one aspect, the polymer is represented by the following Formula (I-a):

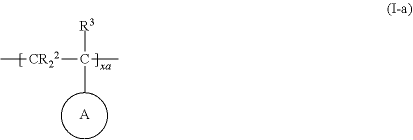

wherein A each independently represents an aromatic ring or an aromatic heterocyclic ring,
R² represents a hydrogen atom or a fluorine atom,
R³ represents a C₁₋₄ alkyl group optionally substituted with one or more fluorine atoms, a hydrogen atom, or a fluorine atom, and
xa represents an integer of 2 to 10,000.

When the polymer is represented by Formula (I-a), it is expected that it becomes possible to provide a fluorine-containing polymer having both characteristics such as processability derived from the styrene unit and characteristics such as high chemical and thermal robustness, high water and oil repellency, low refractive index, low dielectric properties, transparency, and fluorous characteristics derived from the fluorine-containing group.

The polymer may contain two or more units enclosed by parentheses with xa. When the polymer contains two or more such units, the two or more units enclosed by parentheses with xa may be the same or different from each other.

A, R², and R³ have the same meaning as described above.

xa represents an integer of 2 to 10,000, preferably an integer of 5 to 5,000, more preferably an integer of 10 to 5,000, and still more preferably an integer of 20 to 5,000.

In one aspect, A may be an aromatic ring or an aromatic heterocyclic ring, R² may be a hydrogen atom, and R³ may be a C₁₋₄ alkyl group optionally substituted with one or more fluorine atoms, or a hydrogen atom.

In another aspect, A may be an aromatic ring or an aromatic heterocyclic ring, R² may be a fluorine atom, and R³ may be a fluorine atom.

The number average molecular weight of the polymer represented by Formula (I-a) may be preferably 1,000 or more and 1,000,000 or less, more preferably 2,000 or more and 500,000 or less, and still more preferably 2,000 or more and 200,000 or less.

In another aspect, the polymer is preferably represented by the following Formula (I-b):

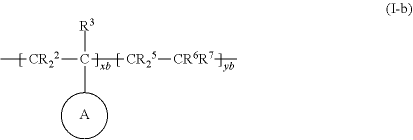

wherein A each independently represents an aromatic ring or an aromatic heterocyclic ring,
R² represents a hydrogen atom or a fluorine atom,
R³ represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring containing a nitrogen atom, together with a nitrogen atom to which they are bonded,
—CH₂— on the ring is optionally substituted with one or more selected from —O—, —S—, and —NH—,
xb represents an integer of 1 to 10,000, yb represents an integer of 1 to 10,000, and
the order of occurrence of units enclosed by parentheses with xb and yb is not limited in Formula (I-b).

When the polymer is represented by Formula (I-b), more excellent characteristics such as oil resistance, chemical resistance, heat resistance, and mechanical strength can be further imparted.

The polymer may contain two or more units enclosed by parentheses with xb or yb. When the polymer contains two or more of these units, the two or more units enclosed by parentheses with xb may be the same or different from each other, and the two or more units enclosed by parentheses with yb may be the same or different from each other.

A, R², R³, R⁵, R⁶, R⁷, R⁸, R⁹, and R¹⁰ have the same meaning as described above.

xb represents an integer of 1 to 10,000, preferably an integer of 5 to 5,000, more preferably an integer of 10 to 5,000, and still more preferably an integer of 20 to 5,000.

yb represents an integer of 1 to 10,000, preferably an integer of 5 to 5,000, more preferably an integer of 10 to 5,000, and still more preferably an integer of 20 to 5,000.

In one aspect, A may be an aromatic ring or an aromatic heterocyclic ring, R² may be a hydrogen atom, R³ may be a hydrogen atom, R⁵ may be a hydrogen atom, R⁶ may be a C₁₋₄ alkyl group optionally substituted with one or more fluorine atoms, a hydrogen atom or a chlorine atom, and R⁷ may be a nitrile group or a hydrogen atom.

In another aspect, A may be an aromatic ring or an aromatic heterocyclic ring, R² may be a hydrogen atom, R³ may be a hydrogen atom, R⁵ may be a hydrogen atom or a fluorine atom, R⁶ may be a hydrogen atom or a fluorine atom, and R⁷ may be one selected from a hydrogen atom, a fluorine atom, and an iodine atom.

The polymer may be a random copolymer in which a unit enclosed by parentheses with xb and a unit enclosed by parentheses with yb are randomly arranged, or may be a block copolymer including a block composed of units enclosed by parentheses with xb and a block composed of units enclosed by parentheses with yb.

The number average molecular weight of the polymer represented by Formula (I-b) may be preferably 1,000 or more and 1,000,000 or less, more preferably 2,000 or more and 500,000 or less, and still more preferably 7,000 or more and 200,000 or less.

In another aspect, the polymer is preferably represented by the following Formula (I-c):

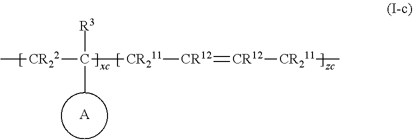

wherein A each independently represents an aromatic ring or an aromatic heterocyclic ring,
R² represents a hydrogen atom or a fluorine atom,
R³ represents a C₁₋₄ alkyl group optionally substituted with one or more fluorine atoms, a hydrogen atom, or a fluorine atom,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
xc represents an integer of 1 to 10,000, zc represents an integer of 1 to 10,000, and
the order of occurrence of units enclosed by parentheses with xc and zc is not limited in Formula (I-c).

When the polymer is represented by Formula (I-c), more excellent characteristics such as stretchability, elasticity, flexibility, mechanical strength, and processability can be imparted.

The polymer may contain two or more units enclosed by parentheses with xc or zc. When the polymer contains two or more of these units, the two or more units enclosed by parentheses with xc may be the same or different from each other, and the two or more units enclosed by parentheses with zc may be the same or different from each other.

A, R², R³, R¹¹, and R¹² have the same meaning as described above.

xc represents an integer of 1 to 10,000, preferably an integer of 5 to 5,000, more preferably an integer of 10 to 5,000, and still more preferably an integer of 20 to 5,000.

zc represents an integer of 1 to 10,000, preferably an integer of 5 to 5,000, more preferably an integer of 10 to 5,000, and still more preferably an integer of 20 to 5,000.

In one aspect, A may be an aromatic ring or an aromatic heterocyclic ring, R² may be a hydrogen atom, R³ may be a hydrogen atom, R¹¹ may be a hydrogen atom, and R¹² may be a C₁₋₄ alkyl group or a hydrogen atom.

The polymer represented by Formula (I-c) may be a random copolymer in which a unit enclosed by parentheses with xc and a unit enclosed by parentheses with zc are randomly arranged, or may be a block copolymer including a block composed of units enclosed by parentheses with xc and a block composed of units enclosed by parentheses with zc.

The number average molecular weight of the polymer represented by Formula (I-c) may be preferably 1,000 or more and 1,000,000 or less, more preferably 2,000 or more and 500,000 or less, and still more preferably 7,000 or more and 200,000 or less.

In still another aspect, the polymer is preferably represented by the following Formula (I-d):

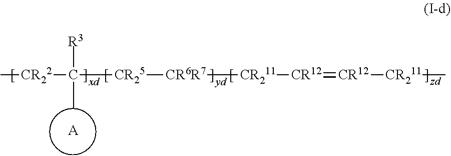

wherein A each independently represents an aromatic ring or an aromatic heterocyclic ring,
R² represents a hydrogen atom or a fluorine atom,
R³ represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring containing a nitrogen atom, together with a nitrogen atom to which they are bonded,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
—CH₂— on the ring is optionally substituted with one or more selected from —O—, —S—, and —NH—,
xd represents an integer of 1 to 10,000, yd represents an integer of 1 to 10,000, zd represents an integer of 1 to 10,000, and
the order of occurrence of units enclosed by parentheses with xd, yd, and zd is not limited in Formula (I-d).

When the polymer is represented by Formula (I-d), more excellent characteristics such as processability, flexibility, heat resistance, oil resistance, chemical resistance, stretchability, elasticity, and mechanical strength can be imparted.

The polymer may contain two or more units enclosed by parentheses with xd, yd, or zd. When the polymer contains two or more of these units, the two or more units enclosed by parentheses with xd may be the same or different from each other, the two or more units enclosed by parentheses with yd may be the same or different from each other, and the two or more units enclosed by parentheses with zd may be the same or different from each other.

A, R², R³, R⁵, R⁶, R⁷, R⁸, R⁹, R¹⁰, R¹¹, and R¹² have the same meaning as described above.

xd represents an integer of 1 to 10,000, preferably an integer of 5 to 5,000, more preferably an integer of 10 to 5,000, and still more preferably an integer of 20 to 5,000.

yd represents an integer of 1 to 10,000, preferably an integer of 5 to 5,000, more preferably an integer of 10 to 5,000, and still more preferably an integer of 20 to 5,000.

zd represents an integer of 1 to 10,000, preferably an integer of 5 to 5,000, more preferably an integer of 10 to 5,000, and still more preferably an integer of 20 to 5,000.

In one aspect, A may be an aromatic ring or an aromatic heterocyclic ring, R² may be a hydrogen atom, R³ may be a hydrogen atom, R⁵ may be a hydrogen atom, R⁶ may be a hydrogen atom, R⁷ may be a C₁₋₁₆ alkyl group optionally substituted with one or more fluorine atoms, or a nitrile group, R¹¹ may be a hydrogen atom, and R¹² may be a C₁₋₄ alkyl group or a hydrogen atom.

The polymer represented by Formula (I-d) may be a random copolymer in which a unit enclosed by parentheses with xd, a unit enclosed by parentheses with yd, and a unit enclosed by parentheses with zd are randomly arranged, or may be a block copolymer including a block composed of units enclosed by parentheses with xd, a block composed of units enclosed by parentheses with yd, and a block composed of units enclosed by parentheses with zd. In addition, when the polymer is a block copolymer, the arrangement of the block composed of units enclosed by parentheses with xd, the block composed of units enclosed by parentheses with yd, the block composed of units enclosed by parentheses with zd is not particularly limited. The block composed of units enclosed by parentheses with xd, the block composed of units enclosed by parentheses with yd, and the block composed of units enclosed by parentheses with zd may be arranged in this order. The block composed of units enclosed by parentheses with xd, the block composed of units enclosed by parentheses with zd, and the block composed of units enclosed by parentheses with yd may be arranged in this order. The block composed of units enclosed by parentheses with yd, the block composed of units enclosed by parentheses with xd, and the block composed of units enclosed by parentheses with zd may be arranged in this order.

The polymer represented by Formula (I-d) may also be a graft copolymer in which a unit enclosed by parentheses with xd and/or a unit enclosed by parentheses with yd are grafted to a carbon atom included in a unit enclosed by parentheses with zd; or may be a mixture of a copolymer of a unit enclosed by parentheses with xd and a unit enclosed by parentheses with yd and a polymer of a unit enclosed by parentheses with zd.

The number average molecular weight of the polymer represented by Formula (I-d) may be preferably 1,000 or more and 1,000,000 or less, more preferably 2,000 or more and 500,000 or less, and still more preferably 7,000 or more and 200,000 or less.

In still another aspect, the polymer is preferably represented by the following Formula (I-e):

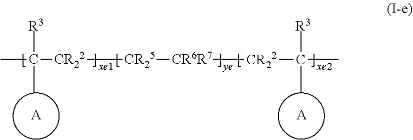

wherein A each independently represents an aromatic ring or an aromatic heterocyclic ring,
R² represents a hydrogen atom or a fluorine atom,
R³ represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring containing a nitrogen atom, together with a nitrogen atom to which they are bonded,
—CH₂— on the ring is optionally substituted with one or more selected from —O—, —S—, and —NH—,
xe1 represents an integer of 1 to 10,000, xe2 represents an integer of 1 to 10,000, ye represents an integer of 1 to 10,000, and
the order of occurrence of units enclosed by parentheses with xe1, xe2, and ye is not limited in Formula (I-e).

When the polymer is represented by Formula (I-e), more excellent characteristics such as processability, flexibility, elasticity, mechanical strength, oil resistance, chemical resistance, and heat resistance can be further imparted. Further, when a raw material skeleton in the form of a block polymer as described above is used, the resulting material may have properties as a thermoplastic elastomer, a dispersant, and a polymer emulsifier.

The polymer may contain two or more units enclosed by parentheses with xe1, xe2, or ye. When the polymer contains two or more of these units, the two or more units enclosed by parentheses with xe1 may be the same or different from each other, the two or more units enclosed by parentheses with xe2 may be the same or different from each other, and the two or more units enclosed by parentheses with ye may be the same or different from each other.

A, R², R³, R⁵, R⁶, R⁷, R⁸, R⁹, and R¹⁰ have the same meaning as described above.

xe1 represents an integer of 1 to 10,000, preferably an integer of 5 to 5,000, more preferably an integer of 10 to 5,000, and still more preferably an integer of 20 to 5,000.

ye represents an integer of 1 to 10,000, preferably an integer of 5 to 5,000, more preferably an integer of 10 to 5,000, and still more preferably an integer of 20 to 5,000.

xe2 represents an integer of 1 to 10,000, preferably an integer of 5 to 5,000, more preferably an integer of 10 to 5,000, and still more preferably an integer of 20 to 5,000.

In one aspect, A may be an aromatic ring or an aromatic heterocyclic ring, R² may be a hydrogen atom, R³ may be a hydrogen atom, R⁵ may be a hydrogen atom or a fluorine atom, R⁶ may be a C₁₋₄ alkyl group, a hydrogen atom, a fluorine atom or a chlorine atom, and R⁷ may be one selected from a hydrogen atom, a fluorine atom, and an iodine atom.

The polymer represented by Formula (I-e) may be a random copolymer in which a unit enclosed by parentheses with xe1, a unit enclosed by parentheses with ye, and a unit enclosed by parentheses with xe2 are randomly arranged, or may be a block copolymer including a block composed of units enclosed by parentheses with xe1, a block composed of units enclosed by parentheses with xe2, and a block composed of units enclosed by parentheses with ye.

The polymer represented by Formula (I-e) is preferably a block copolymer represented by the following formula.

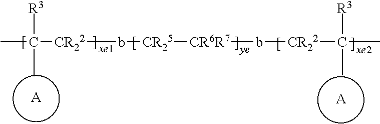

In addition, when the polymer is a block copolymer, the arrangement of the block composed of units enclosed by parentheses with xe1, the block composed of units enclosed by parentheses with ye, and the block composed of units enclosed by parentheses with xe2 is not particularly limited. For example, the block composed of units enclosed by parentheses with xe1, the block composed of units enclosed by parentheses with ye, and the block composed of units enclosed by parentheses with xe2 may be arranged in this order.

The number average molecular weight of the polymer represented by Formula (I-e) may be preferably 1,000 or more and 1,000,000 or less, more preferably 2,000 or more and 500,000 or less, and still more preferably 7,000 or more and 200,000 or less.

In still another aspect, the polymer is preferably represented by the following Formula (I-f):

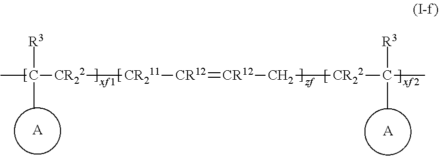

wherein A each independently represents an aromatic ring or an aromatic heterocyclic ring,
R² each independently represents a hydrogen atom or a fluorine atom, and
R³ each independently represents a C₁₋₄ alkyl group optionally substituted with one or more fluorine atoms, a hydrogen atom, or a fluorine atom,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
xf1 represents an integer of 1 to 10,000, xf2 represents an integer of 1 to 10,000, zf represents an integer of 1 to 10,000, and
the order of occurrence of units enclosed by parentheses with xf1, xf2, and zf is not limited in Formula (I-f).

When the polymer is represented by Formula (I-f), more excellent characteristics such as stretchability, elasticity, flexibility, processability, and mechanical strength can be further imparted. Further, when a raw material skeleton in the form of a block polymer as described above is used, the resulting material may have properties as a thermoplastic elastomer, a dispersant, and a polymer emulsifier.

The polymer may contain two or more units enclosed by parentheses with xf1, xf2, or zf. When the polymer contains two or more of these units, the two or more units enclosed by parentheses with xf1 may be the same or different from each other, the two or more units enclosed by parentheses with xf2 may be the same or different from each other, and the two or more units enclosed by parentheses with zf may be the same or different from each other.

A, R², R³, R¹¹, and R¹² have the same meaning as described above.

xf1 represents an integer of 1 to 10,000, preferably an integer of 5 to 5,000, more preferably an integer of 10 to 5,000, and still more preferably an integer of 20 to 5,000.

xf2 represents an integer of 1 to 10,000, preferably an integer of 5 to 5,000, more preferably an integer of 10 to 5,000, and still more preferably an integer of 20 to 5,000.

zf represents an integer of 1 to 10,000, preferably an integer of 5 to 5,000, more preferably an integer of 10 to 5,000, and still more preferably an integer of 20 to 5,000.

In one aspect, A may be an aromatic ring or an aromatic heterocyclic ring, R² may be a hydrogen atom, R³ may be a hydrogen atom, R¹¹ may be a hydrogen atom, and R² may be a C₁₋₄ alkyl group or a hydrogen atom.

The polymer represented by Formula (I-f) may be a random copolymer in which a unit enclosed by parentheses with xf1, a unit enclosed by parentheses with zf, and a unit enclosed by parentheses with xf2 are randomly arranged, or may be a block copolymer including a block composed of units enclosed by parentheses with xf1, a block composed of units enclosed by parentheses with xf2, and a block composed of units enclosed by parentheses with zf.

The polymer represented by Formula (I-f) is preferably a block copolymer represented by the following formula.

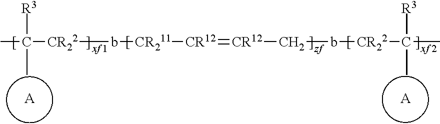

In addition, when the polymer is a block copolymer, the arrangement of the block composed of units enclosed by parentheses with xf1, the block composed of units enclosed by parentheses with zf, and the block composed of units enclosed by parentheses with xf2 is not particularly limited. For example, the block composed of units enclosed by parentheses with xf1, the block composed of units enclosed by parentheses with zf, and the block composed of units enclosed by parentheses with xf2 may be arranged in this order.

The number average molecular weight of the polymer represented by Formula (I-f) may be preferably 1,000 or more and 1,000,000 or less, more preferably 2,000 or more and 500,000 or less, and still more preferably 7,000 or more and 200,000 or less.

The amount of the compound represented by Formula (II) may be preferably 1 mol % or more and 600 mol % or less, and more preferably 10 mol % or more and 200 mol % or less, with respect to 100 mol % of the unit represented by Formula (I).

The reaction between the compound represented by Formula (I) and the compound represented by Formula (II), and the reaction between the compound represented by Formula (I) and the compound represented by Formula (VI) may be performed under light irradiation. Such light irradiation is preferably ultraviolet irradiation, and is performed by irradiation with light having a wavelength of 300 to 400 nm, for example, a wavelength of 350 to 380 nm.

The light source used for such light irradiation is not particularly limited, and examples thereof include an LED, a mercury lamp, a xenon lamp, a UV lamp, a halogen lamp, a fluorescent lamp, sunlight, and indoor light, and an LED is preferably used.

The reaction between the compound represented by Formula (I) and the compound represented by Formula (II), and the reaction between the compound represented by Formula (I) and the compound represented by Formula (VI) can be preferably performed using a basic compound, a catalyst, a one-electron reducing agent, or a radical generator.

Examples of the basic compound include inorganic bases such as Cs₂CO₃, K₂CO₃, Na₂CO₃, Li₂CO₃, CsF, CsHCO₃, KHCO₃, NaHCO₃, and LiHCO₃, amine compounds such as triethylamine, tributylamine, diisopropylethylamine, N,N,N′,N′-tetramethylenediamine, N,N,N′,N′-tetraethylenediamine, pyrrolidine, pyridine, collidine, ammonia, dimethylamine, and DBU, tributylphosphine, triphenylphosphine, triarylphosphines, and disubstituted phosphines, and Cs₂CO₃ is preferably used.

Examples of the catalyst include a transition metal complex, an organic dye compound, and an enamine compound.

Examples of the central metal species of the transition metal complex include cobalt, ruthenium, rhodium, rhenium, iridium, zinc, nickel, palladium, osmium, and platinum.

Examples of the organic dye compound include rose bengal, erythrosin, eosin (for example, Eosin B, and Eosin Y), acriflavine, riboflavin, thionine, phenoxazine, and phenothiazine.

The enamine compound is a structure represented by the following formula.

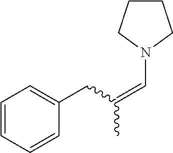

The enamine compound is a chemical species generated by the reaction between the following aldehyde:

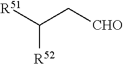

wherein R⁵¹ is a phenyl group or a benzyl group, and R¹² is a hydrogen atom, a methyl group, or a phenyl group, and
the following pyrrolidine:

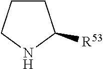

wherein R⁵³ is a hydrogen atom or a bis(3,4-dimethoxyphenyl)methoxymethyl group.

An enamine compound synthesized in advance may be added, or an aldehyde and a pyrrole may be directly added to generate a catalyst in the reaction system.

Examples of the aldehydes include 3-phenyl-2-methylpropanal, 2-phenylpropanal, diphenylacetaldehyde, and phenylacetaldehyde.

Examples of the pyrrolidines include pyrrolidine and (S)-2-[3,4-bis(dimethoxyphenyl)methoxymethyl]pyrrolidine.

Examples of the one-electron reducing agent include sodium thiosulfate, lithium dithionite, sodium dithionite, potassium dithionite, cesium dithionite, copper(I) iodide, copper(I) bromide, copper(I) chloride, triethylamine, tributylamine, tetrabutylammonium iodide, tetrabutylphosphonium iodide, ascorbic acid, ascorbate, zinc powder, indium powder, and magnesium powder. The one-electron reducing agent is preferably sodium thiosulfate, sodium dithionite, copper(I) iodide, or copper(I) bromide, and particularly preferably sodium thiosulfate or sodium dithionite.

Examples of the radical generator include an organic peroxide, an inorganic peroxide, and an organic azo compound, and an organic peroxide is preferably used. Although not limited to the following, examples of the organic peroxide include benzoyl peroxide, examples of the inorganic peroxide include potassium persulfite, and examples of the organic azo compound include azobisisobutyronitrile (AIBN).

The reaction between the compound represented by Formula (I) and the compound represented by Formula (II) and the reaction between the compound represented by Formula (I) and the compound represented by Formula (VI) are preferably performed in a solvent. The solvent is not particularly limited, and examples thereof include dichloromethane, chloroform, carbon tetrachloride, dichloroethane, dichloropentafluoropropane (HCFC-225), perfluoroaliphatic hydrocarbons having 5 to 12 carbon atoms (for example, perfluorohexane, perfluoromethylcyclohexane, and perfluoro-1,3-dimethylcyclohexane); polyfluoroaromatic hydrocarbons (for example, bis(trifluoromethyl)benzene); polyfluoroaliphatic hydrocarbons (for example, C₆F₁₃CH₂CH₃ (for example, ASAHIKLIN (registered trademark) AC-6000, manufactured by Asahi Glass Co., Ltd.), and 1,1,2,2,3,3,4-heptafluorocyclopentane (for example, ZEORORA (registered trademark) H, manufactured by Zeon Corporation)); hydrofluoroethers (HFE) (alkyl perfluoroalkyl ethers (perfluoroalkyl groups and alkyl groups may be linear or branched) such as, for example, perfluoropropyl methyl ether (C₃F₇OCH₃) (for example, Novec (trademark) 7000, manufactured by Sumitomo 3M Ltd.), perfluorobutyl methyl ether (C₄F₉OCH₃) (for example, Novec (trademark) 7100, manufactured by Sumitomo 3M Ltd.), perfluorobutyl ethyl ether (C₄F₉OC₂H₅) (for example, Novec (trademark) 7200, manufactured by Sumitomo 3M Ltd.), perfluorohexyl methyl ether (C₂F₅CF(OCH₃)C₃F₇) (for example, Novec (trademark) 7300, manufactured by Sumitomo 3M Ltd.), or CF₃CH₂OCF₂CHF₂ (for example, ASAHIKLIN (registered trademark) AE-3000, manufactured by Asahi Glass Co., Ltd.)); sulfone-based solvents (for example, dimethylsulfone and sulfolane); ether-based solvents (for example, tetrahydrofuran, 1,4-dioxane, 2-methyltetrahydrofuran, 4-methyltetrahydropyran, monoglyme, diglyme, triglyme, and tetraglyme); acetonitrile; nitromethane; amide-based solvents (N,N-dimethylformamide, N,N-dimethylacetamide, N-methylpyrrolidone, N,N′-dimethylpropyleneurea, 1,3-dimethyl-2-imidazolidinone); ester-based solvents (for example, ethyl acetate and butyl acetate); and ketone-based solvents (for example, acetone, methyl ethyl ketone, and methyl isobutyl ketone).

The reaction temperature in the reaction between the compound represented by Formula (I) and the compound represented by Formula (II) and the reaction between the compound represented by Formula (I) and the compound represented by Formula (VI) may be preferably 0 to 60° C., more preferably 10 to 40° C., for example, room temperature.

The reaction time in the reaction between the compound represented by Formula (I) and the compound represented by Formula (II) and the reaction between the compound represented by Formula (I) and the compound represented by Formula (VI) may be, for example, 10 minutes to 48 hours, and preferably 1 to 24 hours.

(Fluorine-Containing Polymer)

The present disclosure also includes
a fluorine-containing polymer containing a unit represented by the following Formula (III-a):

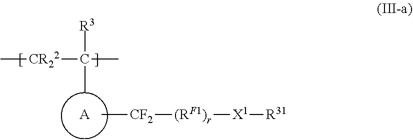

wherein A represents an aromatic ring or an aromatic heterocyclic ring,
R^{F1} represents —(Rf)ₚ—R^{F}—(O)_{q},
Rf represents each independently a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R² each independently represents a hydrogen atom or a fluorine atom, and
R³ each independently represents a C₁₋₄ alkyl group optionally substituted with one or more fluorine atoms, a hydrogen atom, or a fluorine atom,
R³¹ represents a C₇₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a bromine atom, or an iodine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is 0 or 1, q is 0 or 1, and r is 0 or 1.

The present disclosure also includes a fluorine-containing polymer containing a unit represented by the following Formula (VII):

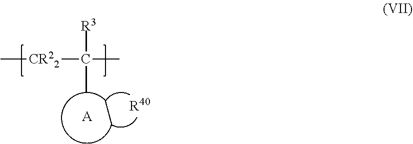

wherein A represents an aromatic ring or an aromatic heterocyclic ring,
R² each independently represents a hydrogen atom or a fluorine atom, and
R³ each independently represents a C₁₋₄ alkyl group optionally substituted with one or more fluorine atoms, a hydrogen atom, or a fluorine atom, and
R⁴⁰ represents a C₃₋₆ alkylene group optionally substituted with one or more halogen atoms.

The fluorine-containing polymer has a structure in which a fluorine-containing group is introduced into a styrene unit, and may have characteristics such as processability derived from the styrene unit and characteristics such as high chemical and thermal robustness, high water and oil repellency, and low refractive index derived from the fluorine-containing group.

The fluorine-containing polymer of the present disclosure is only required to contain a unit represented by one or more selected from Formula (III-a) and Formula (VII). When the fluorine-containing polymer contains two or more units represented by one or more selected from Formula (III-a) and Formula (VII), the two or more units represented by one or more selected from Formula (III-a) and Formula (VII) may be the same or different from each other.

A, R², R³, R⁴⁰, R^{F1}, X¹, and r have the same meaning as described above.

R³¹ represents a C₇₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a bromine atom, or an iodine atom.

The C₆₋₂₀ aromatic hydrocarbon group optionally having one or more substituents, and the silsesquioxane residue optionally having one or more substituents have the same meaning as the C₆₋₂₀ aromatic hydrocarbon group optionally having one or more substituents, and the silsesquioxane residue optionally having one or more substituents in R¹, and R^{f2}, R^{f3}, and R^{f4} have the same meaning as described above.

The “C₇₋₁₆ alkyl group” in the C₇₋₁₆ alkyl group optionally substituted with one or more halogen atoms may be linear or branched, and is preferably a linear or branched C₇₋₁₀ alkyl group, and more preferably a linear or branched C₇₋₈ alkyl group.

Examples of the halogen atom in the C₇₋₁₆ alkyl group optionally substituted with one or more halogen atoms include a fluorine atom, a chlorine atom, a bromine atom, and an iodine atom, and preferably include a fluorine atom.

In one aspect, the C₇₋₁₆ alkyl group optionally substituted with one or more fluorine atoms is a C₇₋₁₆ alkyl group not substituted with a fluorine atom. In another aspect, the C₇₋₁₆ alkyl group optionally substituted with one or more fluorine atoms is preferably a C₁₋₁₆ fluoroalkyl group substituted with one or more fluorine atoms, more preferably a C₇₋₁₆ perfluoroalkyl group, and still more preferably a C₇₋₁₀ perfluoroalkyl group.

The C₇₋₁₆ perfluoroalkyl group may be linear or branched, and may be preferably a linear or branched C₇₋₁₀ perfluoroalkyl group, and more preferably a linear or branched C₇₋₈ perfluoroalkyl group.

R³¹ is preferably a C₇₋₁₆ alkyl group optionally substituted with one or more halogen atoms, a C₆₋₂₀ aromatic hydrocarbon group optionally having one or more substituents, —COOR^{f2}, —OR^{f2}, —SO₂R^{f3}, —CR^{f4}═CR^{f4}₂, a fluorine atom, a bromine atom, or an iodine atom.

The polymer preferably contains: one or more selected from a unit represented by the following Formula (III):

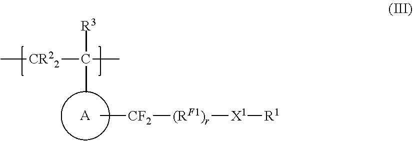

wherein A represents an aromatic ring or an aromatic heterocyclic ring,
R^{F1} represents —(Rf)ₚ—R^{F}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R¹ represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom, and
R³ each independently represents a C₁₋₄ alkyl group optionally substituted with one or more fluorine atoms, a hydrogen atom, or a fluorine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is 0 or 1, q is 0 or 1, and r is 0 or 1, and
a unit represented by the following Formula (VII):

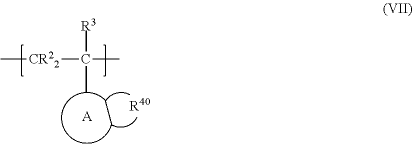

wherein A represents an aromatic ring or an aromatic heterocyclic ring,
R² each independently represents a hydrogen atom or a fluorine atom, and
R³ represents a C₁₋₄ alkyl group optionally substituted with one or more fluorine atoms, a hydrogen atom, or a fluorine atom, and
R⁴⁰ represents a C₃₋₆ alkylene group optionally substituted with one or more halogen atoms; and one or more selected from a unit represented by the following Formula (IV-a):

[symbol]

CR⁵₂—CR⁶R⁷ [symbol] (IV-a)
wherein R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring containing a nitrogen atom, together with a nitrogen atom to which they are bonded, and —CH₂— on the ring is optionally substituted with —O—, a unit represented by the following Formula (IV-b):

[symbol]

CR¹¹₂—CR¹²═CR¹²—CR¹¹₂ [symbol] (IV-b)
wherein R¹¹ each independently represents a C₁₋₄ alkyl group optionally substituted with one or more fluorine atoms, a hydrogen atom, or a fluorine atom, and
R¹² each independently represents a C₁₋₄ alkyl group optionally substituted with one or more fluorine atoms, a hydrogen atom, a fluorine atom, or a chlorine atom, and a unit represented by the following Formula (IV-c):

[symbol]

CR¹¹₂—CR¹³₂—CR¹³₂—CR¹¹₂ [symbol] (IV-c)
wherein R¹¹ each independently represents a C₁₋₄ alkyl group optionally substituted with one or more fluorine atoms, a hydrogen atom, or a fluorine atom,
R¹³ each independently represents one selected from a C₁₋₄ alkyl group optionally substituted with one or more fluorine atoms, a hydrogen atom, a fluorine atom, a chlorine atom, an iodine atom, and —CF₂—(R^{F1})ᵣ—X¹—R¹,
R^{F1} represents —(Rf)ₚ—R^{F}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is 0 or 1, q is 0 or 1, and r is 0 or 1.

When the fluorine-containing polymer contains the unit represented by Formula (IV-a), more excellent characteristics such as processability, flexibility and heat resistance can be further imparted. When the fluorine-containing polymer contains the unit represented by Formula (IV-b), more excellent characteristics such as stretchability can be imparted.

The polymer may contain two or more of units represented by Formula (IV-a), Formula (IV-b), or Formula (IV-c). When the polymer contains two or more units represented by Formula (IV-a), Formula (IV-b), or Formula (IV-c), the two or more units represented by Formula (IV-a) may be the same or different from each other, the two or more units represented by Formula (IV-b) may be the same or different from each other, and the two or more units represented by Formula (IV-c) may be the same or different from each other.

R^{F1}, Rf, R^{F}, X¹, R¹, R⁵, R⁶, R⁷, R⁸, R⁹, R¹⁰, R¹¹, R¹², R⁴⁰, R^{f2}, R^{f3}, R^{f4}, p, q, and r have the same meaning as described above.

R¹³ each independently represents one selected from a C₁₋₄ alkyl group optionally substituted with one or more fluorine atoms, a hydrogen atom, a fluorine atom, a chlorine atom, an iodine atom, and —CF₂—(R^{F1})ᵣ—X¹—R¹.

The C₁₋₄ alkyl group optionally substituted with one or more fluorine atoms represented by R¹³ has the same meaning as the C₁₋₄ alkyl group optionally substituted with one or more fluorine atoms represented by R¹². In one aspect, the C₁₋₄ alkyl group may be preferably a linear or branched C₁₋₃ alkyl group, and more preferably a C₁₋₂ alkyl group. In another aspect, the C₁₋₄ alkyl group may be preferably a C₁₋₄ fluoroalkyl group substituted with a fluorine atom, more preferably a C₁₋₄ perfluoroalkyl group, and still more preferably a C₁₋₂ perfluoroalkyl group, that is, a trifluoromethyl group or a pentafluoroethyl group.

In one aspect, R¹³ is preferably a C₁₋₄ alkyl group not substituted with a fluorine atom, —CF₂—(R^{F1})ᵣ—X¹—R¹, a hydrogen atom, or an iodine atom. In another aspect, R¹³ is preferably a C₁₋₄ fluoroalkyl group substituted with a fluorine atom, —CF₂—(R^{F1})ᵣ—X¹—R¹, a fluorine atom, or an iodine atom. In still another aspect, R¹³ is preferably —CF₂—(R^{F1})ᵣ—X¹—R¹, a hydrogen atom, a chlorine atom, or an iodine atom.

The proportion of the unit represented by Formula (III-a) in the total amount of 100 mol % of the fluorine-containing polymer is preferably 1 mol % or more and 70 mol % or less, more preferably 20 mol % or more and 70 mol % or less, and still more preferably 30 mol % or more and 65 mol % or less.

In the present disclosure, the content of each unit can be calculated on the basis of the charged composition.

In addition, the content of the fluorine atom in the fluorine-containing polymer may be preferably 1 mass % or more and 50 mass % or less, and more preferably 10 mass % or more and 40 mass % or less in 100 mass % of the fluorine-containing polymer.

In the present disclosure, the content of the fluorine atom can be measured by mass spectrometry.

The number average molecular weight of the fluorine-containing polymer having a unit represented by Formula (III-a) may be preferably 1,000 or more and 1,000,000 or less, more preferably 2,000 or more and 500,000 or less, and still more preferably 7,000 or more and 200,000 or less.

In one aspect, the fluorine-containing polymer is preferably represented by the following Formula (V-a):

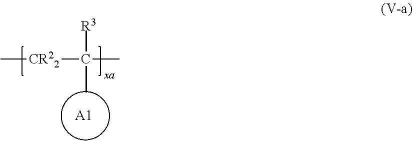

wherein A1 each independently represents one or more selected from a ring represented by the following formula:

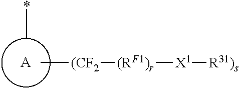

and a ring represented by the following formula:

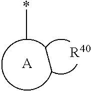

wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R² each independently represents a hydrogen atom or a fluorine atom, and
R³ each independently represents a C₁₋₄ alkyl group optionally substituted with one or more fluorine atoms, a hydrogen atom, or a fluorine atom,
R³¹ each independently represents a C₇₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a bromine atom, or an iodine atom,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1, q is each independently 0 or 1, r is each independently 0 or 1, s each independently represents an integer of 0 to 5,
xa represents an integer of 2 to 10,000, and
the number of —CF₂—(R^{F1})ᵣ—X¹—R³¹ included in Formula (V-a) is one or more.

When the fluorine-containing polymer is represented by Formula (V-a), it is expected that the fluorine-containing polymer can exhibit characteristics such as processability derived from the styrene unit and characteristics such as high chemical and thermal robustness, high water and oil repellency, and low refractive index derived from the fluorine-containing group.

The fluorine-containing polymer may contain two or more units enclosed by parentheses with xa. When the polymer contains two or more such units, the two or more units enclosed by parentheses with xa may be the same or different from each other.

A, R^{F1}, Rf, R^{F}, X¹, R², R³¹, R⁴⁰, R^{f2}, R^{f3}, R^{f4}, p, q, r, and xa have the same meaning as described above.

s represents an integer of 0 to 5, and is preferably 0 or 1.

In one aspect, A may be an aromatic ring or an aromatic heterocyclic ring, R² may be a hydrogen atom, and R³ may be a C₁₋₄ alkyl group optionally substituted with one or more fluorine atoms, or a hydrogen atom.

In another aspect, A may be an aromatic ring or an aromatic heterocyclic ring, R² may be a fluorine atom, and R³ may be a fluorine atom.

In the fluorine-containing polymer represented by Formula (V-a), not all the repeating units may be units represented by Formula (III-a), and the number of —CF₂—(R^{F1})ᵣ—X¹—R³¹ in the fluorine-containing polymer may be one or more. In other words, the fluorine-containing polymer is only required to contain at least the unit represented by Formula (III-a). The proportion of the unit represented by Formula (III-a) is preferably 1 mol % or more and 70 mol % or less, more preferably 20 mol % or more and 70 mol % or less, and still more preferably 30 mol % or more and 65 mol % or less, with respect to 100 mol % of the total amount of the fluorine-containing polymer represented by Formula (V-a).

In one aspect, Formula (V-a) may be represented by the following Formula (V-a1).

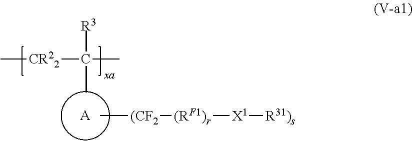

In another aspect, Formula (V-a) may be represented by the following Formula (V-a2).

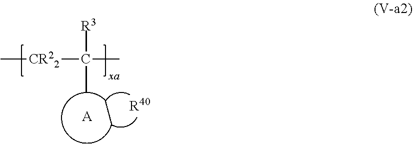

In addition, the content of the fluorine atom in the fluorine-containing polymer represented by Formula (V-a) may be preferably 1 mass % or more and 50 mass % or less, and more preferably 10 mass % or more and 40 mass % or less in 100 mass % of the fluorine-containing polymer.

The number average molecular weight of the polymer represented by Formula (V-a) may be preferably 1,000 or more and 1,000,000 or less, more preferably 2,000 or more and 500,000 or less, and still more preferably 7,000 or more and 200,000 or less.

In another aspect, the fluorine-containing polymer is preferably represented by the following Formula (V-b):

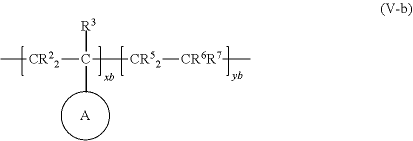

wherein A2 each independently represents one or more selected from a ring represented by the following formula:

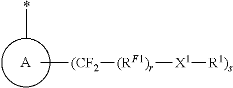

and a ring represented by the following formula:

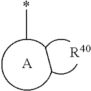

wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring containing a nitrogen atom, together with a nitrogen atom to which they are bonded, and —CH₂— on the ring is optionally substituted with one or more selected from —O—, —S—, and —NH—,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1, q is each independently 0 or 1, r is each independently 0 or 1, s each independently represents an integer of 0 to 5,
xb represents an integer of 1 to 10,000, yb represents an integer of 1 to 10,000,
the order of occurrence of units enclosed by parentheses with xb and yb is not limited in Formula (V-b), and
the number of —CF₂—(R^{F1})ᵣ—X¹—R¹ included in Formula (V-b) is one or more.

When the fluorine-containing polymer is represented by Formula (V-b), more excellent characteristics such as processability, flexibility, heat resistance, oil resistance, chemical resistance, and mechanical strength can be further imparted.

The fluorine-containing polymer may contain two or more units enclosed by parentheses with xb or yb. When the polymer contains two or more of these units, the two or more units enclosed by parentheses with xb may be the same or different from each other, and the two or more units enclosed by parentheses with yb may be the same or different from each other.

A, R^{F1}, Rf, R^{F}, X¹, R¹, R², R³, R⁵, R⁶, R⁷, R⁸, R⁹, R¹⁰, R⁴⁰, R^{f2}, R^{f3}, R^{f4}, p, q, r, s, xb, and yb have the same meaning as described above.

In one aspect, A may be an aromatic ring or an aromatic heterocyclic ring, R² may be a hydrogen atom, R³ may be a hydrogen atom, R⁵ may be a hydrogen atom, R⁶ may be a C₁₋₄ alkyl group optionally substituted with one or more fluorine atoms, a hydrogen atom or a chlorine atom, and R⁷ may be a nitrile group or a hydrogen atom.

In another aspect, A may be an aromatic ring or an aromatic heterocyclic ring, R² may be a hydrogen atom, R³ may be a hydrogen atom, R⁵ may be a hydrogen atom or a fluorine atom, R⁶ may be a hydrogen atom or a fluorine atom, and R⁷ may be one selected from a hydrogen atom, a fluorine atom, and an iodine atom.

The proportion of the unit represented by Formula (III-a) in the total amount of 100 mol % of the fluorine-containing polymer represented by Formula (V-b) is preferably 1 mol % or more and 35 mol % or less, more preferably 3 mol % or more and 30 mol % or less, and still more preferably 5 mol % or more and 25 mol % or less.

In addition, the content of the fluorine atom in the fluorine-containing polymer represented by Formula (V-b) may be preferably 1 mass % or more and 25 mass % or less, and more preferably 5 mass % or more and 20 mass % or less in 100 mass % of the fluorine-containing polymer.

In one aspect, Formula (V-b) may be represented by the following Formula (V-b1).

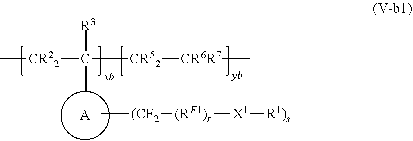

In another aspect, Formula (V-b) may be represented by the following Formula (V-b2).

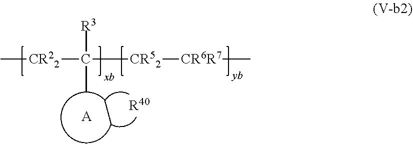

The fluorine-containing polymer may be a random copolymer in which a unit enclosed by parentheses with xb and a unit enclosed by parentheses with yb are randomly arranged, or may be a block copolymer including a block composed of units enclosed by parentheses with xb and a block composed of units enclosed by parentheses with yb.

The number average molecular weight of the polymer represented by Formula (V-b) may be preferably 1,000 or more and 1,000,000 or less, more preferably 2,000 or more and 500,000 or less, and still more preferably 7,000 or more and 200,000 or less.

In another aspect, the fluorine-containing polymer of the present disclosure is preferably represented by the following Formula (V-c):

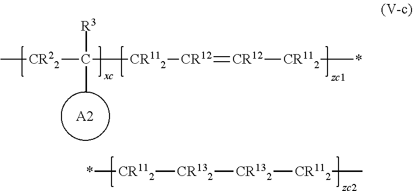

wherein A2 each independently represents one or more selected from a ring represented by the following formula:

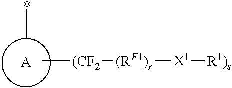

and a ring represented by the following formula:

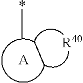

wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom, and
R³ each independently represents a C₁₋₄ alkyl group optionally substituted with one or more fluorine atoms, a hydrogen atom, or a fluorine atom,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
R¹³ each independently represents one selected from a C₁₋₄ alkyl group optionally substituted with one or more fluorine atoms, a hydrogen atom, a fluorine atom, a chlorine atom, an iodine atom, and —CF₂—(R^{F1})ᵣ—X¹—R¹,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1, q is each independently 0 or 1, r is each independently 0 or 1, s each independently represents an integer of 0 to 5,
xc represents an integer of 1 to 10,000, zc1 represents an integer of 1 to 10,000, zc2 represents an integer of 0 to 10,000,
the order of occurrence of units enclosed by parentheses with xc, zc1, and zc2 is not limited in Formula (V-c),
the number of —CF₂—(R^{F1})ᵣ—X¹—R¹ included in Formula (V-c) is one or more, and
asterisks * in the formulas are bonded to each other.

When the polymer is represented by Formula (V-c), more excellent characteristics such as stretchability can be imparted.

The fluorine-containing polymer may contain two or more units enclosed by parentheses with xc, zc1, or zc2. When the polymer contains two or more of these units, the two or more units enclosed by parentheses with xc may be the same or different from each other, the two or more units enclosed by parentheses with zc1 may be the same or different from each other, and the two or more units enclosed by parentheses with zc2 may be the same or different from each other.

A, R^{F1}, Rf, R^{F}, X¹, R¹, R², R³, R¹¹, R¹², R¹³, R⁴⁰, R^{f2}, R^{f3}, R^{f4}, p, q, r, s, and xc have the same meaning as described above.

zc1 represents an integer of 1 to 10,000, preferably an integer of 5 to 5,000, more preferably an integer of 10 to 5,000, and still more preferably an integer of 20 to 5,000.

zc2 represents an integer of 0 to 10,000, preferably an integer of 5 to 5,000, more preferably an integer of 10 to 5,000, and still more preferably an integer of 20 to 5,000.

The sum of zc1 and zc2 is preferably an integer of 1 to 10,000, more preferably an integer of 5 to 5,000, still more preferably an integer of 10 to 5,000, and still even more preferably an integer of 20 to 5,000.

In one aspect, A may be an aromatic ring or an aromatic heterocyclic ring, R² may be a hydrogen atom, R³ may be a hydrogen atom, R¹¹ may be a hydrogen atom, R¹² may be a C₁₋₄ alkyl group or a hydrogen atom, and R¹³ may be a C₁₋₄ alkyl group, —CF₂—(R^{F1})ᵣ—X¹—R¹, a hydrogen atom, or an iodine atom.

The proportion of the unit represented by Formula (III-a) in the total amount of 100 mol % of the fluorine-containing polymer represented by Formula (V-c) is preferably 1 mol % or more and 70 mol % or less, more preferably 5 mol % or more and 60 mol % or less, and still more preferably 10 mol % or more and 50 mol % or less.

In addition, the content of the fluorine atom in the fluorine-containing polymer represented by Formula (V-c) may be preferably 1 mass % or more and 50 mass % or less, and more preferably 5 mass % or more and 40 mass % or less in 100 mass % of the fluorine-containing polymer.

In one aspect, Formula (V-c) may be represented by the following Formula (V-c1).

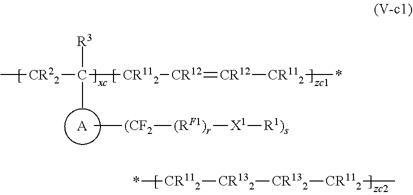

In another aspect, Formula (V-c) may be represented by the following Formula (V-c2).

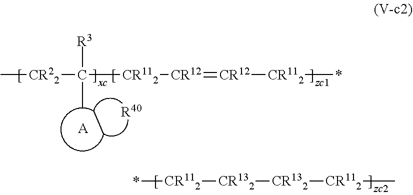

The fluorine-containing polymer represented by Formula (V-c) may be a random copolymer in which a unit enclosed by parentheses with xc and a unit enclosed by parentheses with zc1 and/or zc2 are randomly arranged, or may be a block copolymer including a block composed of units enclosed by parentheses with xc and a block composed of units enclosed by parentheses with zc1 and/or zc2.

The number average molecular weight of the polymer represented by Formula (V-c) may be preferably 1,000 or more and 1,000,000 or less, more preferably 2,000 or more and 500,000 or less, and still more preferably 7,000 or more and 200,000 or less.

Further, in still another aspect, the fluorine-containing polymer of the present disclosure is preferably represented by the following Formula (V-d):

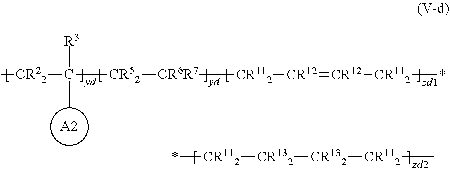

wherein A2 each independently represents one or more selected from a ring represented by the following formula:

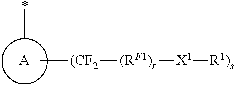

and a ring represented by the following formula:

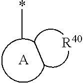

wherein A each independently represents an aromatic ring or an aromatic heterocyclic ring,
R^{F1} each independently represents —(Rf)ₚ—R^{F}—(O)_{q},
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom, and
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring containing a nitrogen atom, together with a nitrogen atom to which they are bonded,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
R¹³ each independently represents one selected from a C₁₋₄ alkyl group optionally substituted with one or more fluorine atoms, a hydrogen atom, a fluorine atom, a chlorine atom, an iodine atom, and —CF²—(R^{F1})ᵣ—X¹—R¹,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom, and —CH₂-on the ring is optionally substituted with one or more selected from —O—, —S— and —NH—,
p is each independently 0 or 1, q is each independently 0 or 1, r is each independently 0 or 1, s each independently represents an integer of 0 to 5,
xd represents an integer of 1 to 10,000, yd represents an integer of 1 to 10,000, zd1 represents an integer of 1 to 10,000, zd2 represents an integer of 0 to 10,000,
the order of occurrence of units enclosed by parentheses with xd, yd, zd1, and zd2 is not limited in Formula (V-d),
the number of —CF₂—(R^{F1})ᵣ—X¹—R¹ included in Formula (V-d) is one or more, and
asterisks * in the formulas are bonded to each other.

When the polymer is represented by Formula (V-d), more excellent characteristics such as processability, flexibility, heat resistance, oil resistance, chemical resistance, stretchability, elasticity, and mechanical strength can be imparted.

The fluorine-containing polymer may contain two or more units enclosed by parentheses with xd, yd, zd1, or zd2. When the polymer contains two or more of these units, the two or more units enclosed by parentheses with xd may be the same or different from each other, the two or more units enclosed by parentheses with yd may be the same or different from each other, the two or more units enclosed by parentheses with zd1 may be the same or different from each other, and the two or more units enclosed by parentheses with zd2 may be the same or different from each other.

A, R^{F1}, Rf, R^{F}, X¹, R¹, R², R³, R⁵, R⁶, R⁷, R⁸, R⁹, R¹⁰, R¹¹, R¹², R¹³, R⁴⁰, R^{f2}, R^{f3}, R^{f4}, p, q, r, s, x, and yd have the same meaning as described above.

zd1 represents an integer of 1 to 10,000, preferably an integer of 5 to 5,000, more preferably an integer of 10 to 5,000, and still more preferably an integer of 20 to 5,000.

zd2 represents an integer of 0 to 10,000, preferably an integer of 5 to 5,000, more preferably an integer of 10 to 5,000, and still more preferably an integer of 20 to 5,000.

The sum of zd1 and zd2 is preferably an integer of 1 to 10,000, more preferably an integer of 5 to 5,000, still more preferably an integer of 10 to 5,000, and still even more preferably an integer of 20 to 5,000.

In one aspect, A may be an aromatic ring or an aromatic heterocyclic ring, R² may be a hydrogen atom, R³ may be a hydrogen atom, R⁵ may be a hydrogen atom, R⁶ may be a hydrogen atom, R⁷ may be a C₁₋₁₆ alkyl group optionally substituted with one or more fluorine atoms, or a nitrile group, R¹¹ may be a hydrogen atom, R¹² may be a C₁₋₄ alkyl group or a hydrogen atom, and R¹³ may be a C₁₋₄ alkyl group, —CF₂—(R^{F1})ᵣ—X¹—R¹, a hydrogen atom, or an iodine atom.

The proportion of the unit represented by Formula (III-a) in the total amount of 100 mol % of the fluorine-containing polymer represented by Formula (V-d) is preferably 1 mol % or more and 50 mol % or less, more preferably 3 mol % or more and 40 mol % or less, and still more preferably 5 mol % or more and 30 mol % or less.

In addition, the content of the fluorine atom in the fluorine-containing polymer represented by Formula (V-d) may be preferably 1 mass % or more and 50 mass % or less, and more preferably 5 mass % or more and 40 mass % or less in 100 mass % of the fluorine-containing polymer.

In one aspect, Formula (V-d) may be represented by the following Formula (V-d1).

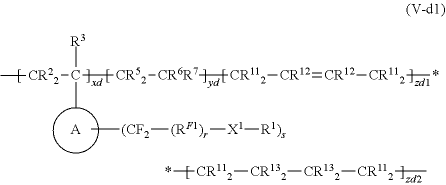

In another aspect, Formula (V-d) may be represented by the following Formula (V-d2).

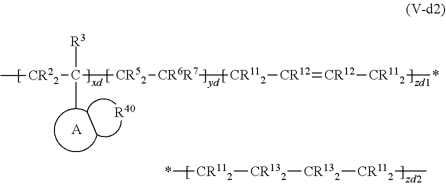

The polymer represented by Formula (V-d) may be a random copolymer in which a unit enclosed by parentheses with xd, a unit enclosed by parentheses with yd, and a unit enclosed by parentheses with zd1 and/or zd2 are randomly arranged, or may be a block copolymer including a block composed of units enclosed by parentheses with xd, a block composed of units enclosed by parentheses with yd, and a block composed of units enclosed by parentheses with zd1 and/or zd2. In addition, when the polymer is a block copolymer, the arrangement of the block composed of units enclosed by parentheses with xd, the block composed of units enclosed by parentheses with yd, the block composed of units enclosed by parentheses with zd1 and/or zd2 is not particularly limited. The block composed of units enclosed by parentheses with xd, the block composed of units enclosed by parentheses with yd, and the block composed of units enclosed by parentheses with zd1 and/or zd2 may be arranged in this order. The block composed of units enclosed by parentheses with xd, the block composed of units enclosed by parentheses with zd1 and/or zd2, and the block composed of units enclosed by parentheses with yd may be arranged in this order. The block composed of units enclosed by parentheses with yd, the block composed of units enclosed by parentheses with xd, and the block composed of units enclosed by parentheses with zd1 and/or zd2 may be arranged in this order.

The polymer represented by Formula (V-d) may also be a graft copolymer in which a unit enclosed by parentheses with xd and/or a unit enclosed by parentheses with yd are grafted to a carbon atom included in a unit enclosed by parentheses with zd1; or may be a mixture of a copolymer of a unit enclosed by parentheses with xd and a unit enclosed by parentheses with yd and a polymer of a unit enclosed by parentheses with zd1 and/or zd2.

The number average molecular weight of the polymer represented by Formula (V-d) may be preferably 1,000 or more and 1,000,000 or less, more preferably 2,000 or more and 500,000 or less, and still more preferably 7,000 or more and 200,000 or less.

Further, in still another aspect, the fluorine-containing polymer of the present disclosure is preferably represented by the following Formula (V-e):

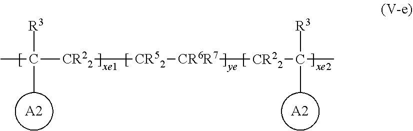

wherein A2 each independently represents one or more selected from a ring represented by the following formula:

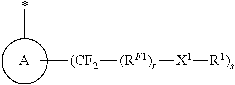

and a ring represented by the following formula:

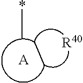

wherein A each independently represents an aromatic ring or an aromatic heterocyclic ring,
R^{F1} each independently represents —(Rf)ₚ—R^{F}—(O)_{q},
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom, and
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring containing a nitrogen atom, together with a nitrogen atom to which they are bonded, and —CH₂— on the ring is optionally substituted with one or more selected from —O—, —S—, and —NH—,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1, q is each independently 0 or 1, r is each independently 0 or 1, s each independently represents an integer of 0 to 5,
xe1 represents an integer of 1 to 10,000, xe2 represents an integer of 1 to 10,000, ye represents an integer of 1 to 10,000, and
the order of occurrence of units enclosed by parentheses with xe1, xe2, and ye is not limited in Formula (V-e), and
the number of —CF₂—(R^{F1})ᵣ—X¹—R¹ included in Formula (V-e) is one or more.

When the polymer is represented by Formula (V-e), more excellent characteristics such as processability, flexibility, elasticity, mechanical strength, oil resistance, chemical resistance, and heat resistance can be further imparted. Further, when a raw material skeleton in the form of a block polymer as described above is used, the resulting material may have properties as a thermoplastic elastomer, a dispersant, and a polymer emulsifier.

The fluorine-containing polymer may contain two or more units enclosed by parentheses with xe1, xe2, or ye. When the polymer contains two or more of these units, the two or more units enclosed by parentheses with xe1 may be the same or different from each other, the two or more units enclosed by parentheses with xe2 may be the same or different from each other, and the two or more units enclosed by parentheses with ye may be the same or different from each other.

A, R^{F1}, Rf, R^{F}, X¹, R¹, R², R³, R⁵, R⁶, R⁷, R⁸, R⁹, R¹⁰, R⁴⁰, R^{f2}, R^{f3}, R^{f4}, p, q, r, s, xe1, xe2, and ye have the same meaning as described above.

In one aspect, A may be an aromatic ring or an aromatic heterocyclic ring, R² may be a hydrogen atom, R³ may be a hydrogen atom, R⁵ may be a hydrogen atom or a fluorine atom, R⁶ may be a C₁₋₄ alkyl group, a hydrogen atom, a fluorine atom or a chlorine atom, and R⁷ may be one selected from a hydrogen atom, a fluorine atom, and an iodine atom.

The proportion of the unit represented by Formula (III-a) in the total amount of 100 mol % of the fluorine-containing polymer represented by Formula (V-e) is preferably 1 mol % or more and 35 mol % or less, more preferably 3 mol % or more and 30 mol % or less, and still more preferably 5 mol % or more and 25 mol % or less. In Formula (V-e), the unit represented by Formula (III-a) includes both —[CR²₂—CR³(A-(CF₂—(R^{F1})ᵣ—X¹—R³¹)ₛ)]— and —[CR³(A-(CF₂—(R^{F1})ᵣ—X¹—R³¹)ₛ)—CR²₂]—.

In addition, the content of the fluorine atom in the fluorine-containing polymer represented by Formula (V-e) may be preferably 1 mass % or more and 30 mass % or less, and more preferably 5 mass % or more and 20 mass % or less in 100 mass % of the fluorine-containing polymer.

In one aspect, Formula (V-e) may be represented by the following Formula (V-e1).

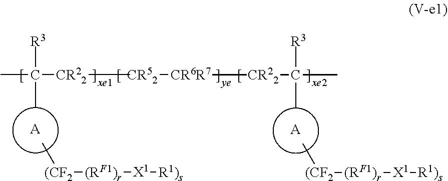

In another aspect, Formula (V-e) may be represented by the following Formula (V-e2).

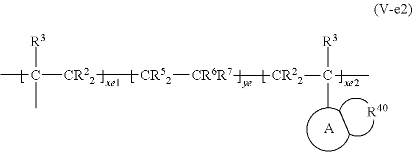

The polymer represented by Formula (V-e) may be a random copolymer in which a unit enclosed by parentheses with xe1, a unit enclosed by parentheses with ye, and a unit enclosed by parentheses with xe2 are randomly arranged, or may be a block copolymer including a block composed of units enclosed by parentheses with xe1, a block composed of units enclosed by parentheses with xe2, and a block composed of units enclosed by parentheses with ye.

The polymer represented by Formula (V-e) is preferably a block copolymer represented by the following formula:

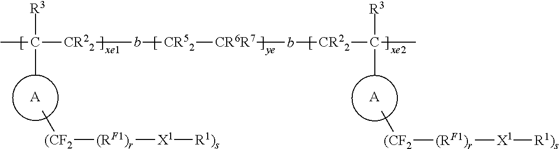

or the following formula.

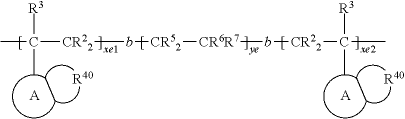

In addition, when the polymer is a block copolymer, the arrangement of the block composed of units enclosed by parentheses with xe1, the block composed of units enclosed by parentheses with ye, and the block composed of units enclosed by parentheses with xe2 is not particularly limited. For example, the block composed of units enclosed by parentheses with xe1, the block composed of units enclosed by parentheses with ye, and the block composed of units enclosed by parentheses with xe2 may be arranged in this order.

The number average molecular weight of the polymer represented by Formula (V-e) may be preferably 1,000 or more and 1,000,000 or less, more preferably 2,000 or more and 500,000 or less, and still more preferably 7,000 or more and 200,000 or less.

In still another aspect, the fluorine-containing polymer is preferably represented by the following Formula (V-f):

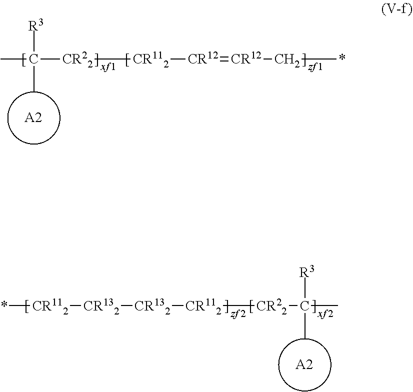

wherein A2 each independently represents one or more selected from a ring represented by the following formula:

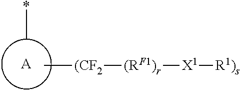

and a ring represented by the following formula:

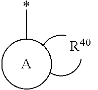

wherein A each independently represents an aromatic ring or an aromatic heterocyclic ring,
R^{F1} each independently represents —(Rf)ₚ—R^{F}—(O)_{q}—, Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom, and
R³ each independently represents a C₁₋₄ alkyl group optionally substituted with one or more fluorine atoms, a hydrogen atom, or a fluorine atom,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
R¹³ each independently represents one selected from a C₁₋₄ alkyl group optionally substituted with one or more fluorine atoms, a hydrogen atom, a fluorine atom, a chlorine atom, an iodine atom, and —CF²—(R^{F1})ᵣ—X¹—R¹,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1, q is each independently 0 or 1, r is each independently 0 or 1, s each independently represents an integer of 0 to 5,
xf1 represents an integer of 1 to 10,000, xf2 represents an integer of 1 to 10,000, zf1 represents an integer of 1 to 10,000, zf2 represents an integer of 0 to 10,000,
the order of occurrence of units enclosed by parentheses with xf1, xf2, zf1, and zf2 is not limited in Formula (V-f),
the number of —CF₂—(R^{F1})ᵣ—X¹—R¹ included in Formula (V-f) is one or more, and
asterisks * in the formulas are bonded to each other.

When the polymer is represented by Formula (V-f), more excellent characteristics such as stretchability, elasticity, flexibility, processability, and mechanical strength can be further imparted. Further, when a raw material skeleton in the form of a block polymer as described above is used, the resulting material may have properties as a thermoplastic elastomer, a dispersant, and a polymer emulsifier.

The polymer may contain two or more units enclosed by parentheses with xf1, xf2, zf1, or zf2. When the polymer contains two or more of these units, the two or more units enclosed by parentheses with xf1 may be the same or different from each other, the two or more units enclosed by parentheses with xf2 may be the same or different from each other, the two or more units enclosed by parentheses with zf1 may be the same or different from each other, and the two or more units enclosed by parentheses with zf2 may be the same or different from each other.

A, R^{F1}, Rf, R^{F}, X¹, R¹, R², R³, R¹¹, R¹², R¹³, R⁴⁰, R^{f2}, R^{f3}, R^{f4}, p, q, r, s, xf1, and xf2 have the same meaning as described above.

zf1 represents an integer of 1 to 10,000, preferably an integer of 5 to 5,000, more preferably an integer of 10 to 5,000, and still more preferably an integer of 20 to 5,000.

zf2 represents an integer of 0 to 10,000, preferably an integer of 5 to 5,000, more preferably an integer of 10 to 5,000, and still more preferably an integer of 20 to 5,000.

The sum of zf1 and zf2 is preferably an integer of 1 to 10,000, more preferably an integer of 5 to 5,000, still more preferably an integer of 10 to 5,000, and still even more preferably an integer of 20 to 5,000.

In one aspect, A may be an aromatic ring or an aromatic heterocyclic ring, R² may be a hydrogen atom, R³ may be a hydrogen atom, R¹¹ may be a hydrogen atom, R¹² may be a C₁₋₄ alkyl group or a hydrogen atom, and R¹³ may be a C₁₋₄ alkyl group, —CF₂—(R^{F1})ᵣ—X¹—R¹, a hydrogen atom, or an iodine atom.

The proportion of the unit represented by Formula (III-a) in the total amount of 100 mol % of the fluorine-containing polymer represented by Formula (V-f) is preferably 1 mol % or more and 70 mol % or less, more preferably 5 mol % or more and 70 mol % or less, and still more preferably 10 mol % or more and 65 mol % or less. In Formula (V-f), the unit represented by Formula (III-a) includes both —[CR²₂—CR³(A-(CF₂—(R^{F1})ᵣ—X¹—R³¹)ₛ)]— and —[CR³(A-(CF₂—(R^{F1})ᵣ—X¹—R³¹)ₛ)—CR²₂]—.

In one aspect, Formula (V-f) may be represented by the following Formula (V-f1).

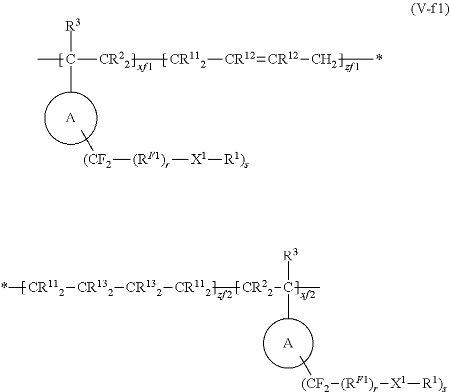

In another aspect, Formula (V-f) may be represented by the following Formula (V-f2).

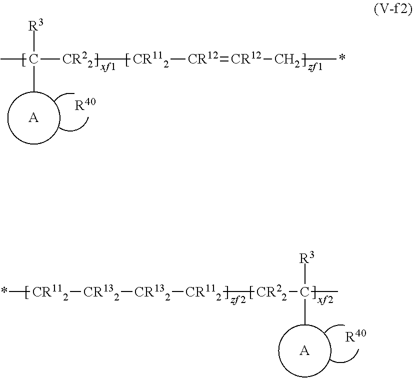

In addition, the content of the fluorine atom in the fluorine-containing polymer represented by Formula (V-f) may be preferably 1 mass % or more and 50 mass % or less, and more preferably 5 mass % or more and 40 mass % or less in 100 mass % of the fluorine-containing polymer.

The fluorine-containing polymer represented by Formula (V-f) may be a random copolymer in which a unit enclosed by parentheses with xf1, a unit enclosed by parentheses with zf1 and/or zf2, and a unit enclosed by parentheses with xf2 are randomly arranged, or may be a block copolymer including a block composed of units enclosed by parentheses with xf1, a block composed of units enclosed by parentheses with xf2, and a block composed of units enclosed by parentheses with zf1 and/or zf2.

The polymer represented by Formula (V-f) is preferably a block copolymer represented by the following formula:

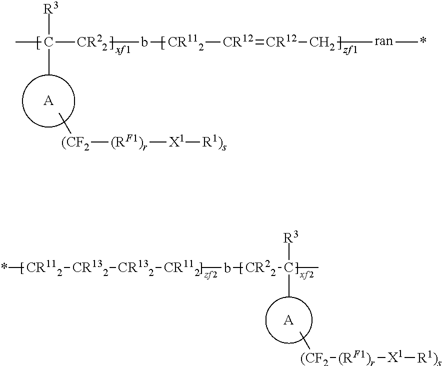

or the following formula.

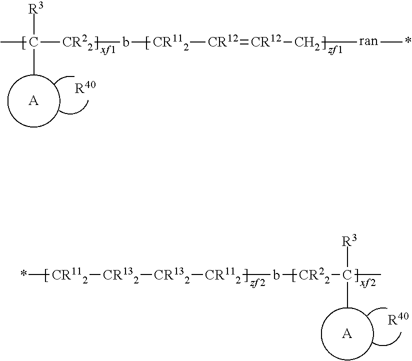

In addition, when the fluorine-containing polymer is a block copolymer, the arrangement of the block composed of units enclosed by parentheses with xf1, the block composed of units enclosed by parentheses with zf1 and/or zf2, and the block composed of units enclosed by parentheses with xf2 is not particularly limited. For example, the block composed of units enclosed by parentheses with xf1, the block composed of units enclosed by parentheses with zf1 and/or zf2, and the block composed of units enclosed by parentheses with xf2 may be arranged in this order.

The number average molecular weight of the fluorine-containing polymer represented by Formula (V-f) may be preferably 1,000 or more and 1,000,000 or less, more preferably 2,000 or more and 500,000 or less, and still more preferably 7,000 or more and 200,000 or less.

The fluorine-containing polymer may include a structure due to a side reaction, and for example, in the unit represented by Formula (I), a structure in which R¹—X¹—(R^{F1})ᵣ—CF₂— is introduced at the position of R³, that is, —[CR²₂—C(—CF₂—(R^{F1})ᵣ—X¹—R¹)(-A)]- may be included.

(Article)

The technical scope of the present disclosure also includes an article including: a base material; and a layer that is formed on a surface of the base material and formed with a surface treatment agent, wherein
the base material contains a polymer containing a unit represented by the following Formula (I):

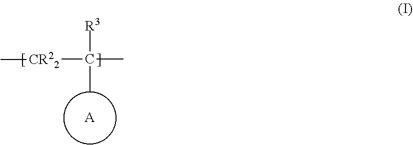

wherein A represents an aromatic ring or an aromatic heterocyclic ring,
R² represents a hydrogen atom or a fluorine atom, and
R³ represents a C₁₋₄ alkyl group optionally substituted with one or more fluorine atoms, a hydrogen atom, or a fluorine atom, and
the surface treatment agent contains a fluorine-containing compound represented by Formula (II):

R¹—X¹—(R^{F1})ᵣ—CF₂—I (I)
wherein R^{F1} represents —(Rf)ₚ—R^{F}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R¹ represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is 0 or 1, q is 0 or 1, and r is 0 or 1.

In the article of the present disclosure, a fluorine-containing organic group is imparted onto a base material containing a polymer containing a unit represented by Formula (I). It is therefore expected that the article further has characteristics such as processability derived from the polymer and characteristics such as high chemical and thermal robustness, high water and oil repellency, and low refractive index derived from the fluorine-containing group.

In one aspect, the article may include:
a base material; and a layer that is formed on a surface of the base material and formed with a surface treatment agent, wherein
the base material may contain a polymer containing a unit represented by the following Formula (I):

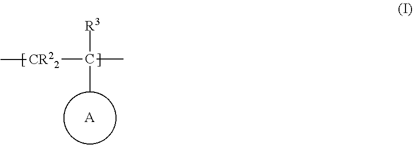

wherein A represents an aromatic ring or an aromatic heterocyclic ring,
R² represents a hydrogen atom or a fluorine atom, and
R³ represents a C₁₋₄ alkyl group optionally substituted with one or more fluorine atoms, a hydrogen atom, or a fluorine atom, and
the surface treatment agent may contain a fluorine-containing compound represented by Formula (VI):

I—R⁴⁰—I (VI)

wherein R⁴⁰ represents a C₃₋₆ alkylene group optionally substituted with one or more fluorine atoms.

The base material is only required to contain a polymer containing a unit represented by Formula (I), and may be preferably a polymer represented by Formula (I-a), (I-b), (I-c), (I-d), (I-e) or (I-f).

The base material may be composed of only a polymer containing a unit represented by Formula (I), or may be a combination of the polymer containing a unit represented by Formula (I) and other materials. Such other materials may include any suitable materials such as glass, other resins, metals (a simple metal such as aluminum, copper, or iron, or an alloy containing such simple metals), ceramics, semiconductors (silicon, germanium, and the like), fur, leather, wood, paper, ceramic, stone, and fabric.

The base material may be in the form of a powder, a film, a plate, a film, a pellet, a molded article (various parts and the like), an irregular shape, or the like. The base material may be, for example, a pressure-sensitive adhesive or an adhesive (bond) before and after curing. By reacting the fluorine-containing compound represented by Formula (II) or Formula (VI) with the pressure-sensitive adhesive or the adhesive before curing, a fluorine-containing organic group can be uniformly introduced into the pressure-sensitive adhesive or the adhesive. By reacting the fluorine-containing compound represented by Formula (II) or Formula (VI) with the pressure-sensitive adhesive or the adhesive after curing, the fluorine-containing organic group can be introduced onto the surface of the cured product.

The surface region of the base material on which the layer is to be formed with the surface treatment agent may be at least a part of the surface of the base material, and can be appropriately determined according to the use of the article to be produced, specific specifications, and the like. For example, it is possible to introduce a fluorine-containing organic group into only a part of the surface of the molded article.

The surface treatment agent contains a compound represented by Formula (II) or Formula (VI). In one aspect, the surface treatment agent may further contain a basic compound, a catalyst, a one-electron reducing agent, a radical generator, a solvent, and the like in addition to the compound represented by Formula (II) or Formula (VI). As the basic compound, the catalyst, the one-electron reducing agent, the radical generator, and the solvent, the same compounds as the compounds described in the above production method can be used.

(Method for Producing Article)

A method for producing an article of the present disclosure includes reacting the base material with the surface treatment agent to form a layer on a surface of the base material, wherein the base material contains a polymer containing a unit represented by Formula (I), and the surface treatment agent contains a compound represented by Formula (II) or Formula (VI).

According to the method for producing an article of the present disclosure, a fluorine-containing organic group is imparted onto a base material containing a polymer containing a unit represented by Formula (I). It is therefore expected that characteristics such as processability derived from the polymer and characteristics such as high chemical and thermal robustness, high water and oil repellency, and low refractive index derived from the fluorine-containing group can be further imparted.

The above reaction may be performed under light irradiation. Such light irradiation is preferably ultraviolet irradiation, and may be performed by irradiation with light having a wavelength of 300 to 400 nm, for example, a wavelength of 350 to 380 nm. As the light source used for such light irradiation, the light source described in the production method can be used.

The reaction temperature in the reaction may be preferably 0 to 60° C., more preferably 10 to 40° C., for example, room temperature. The reaction time in the reaction may be, for example, 10 minutes to 48 hours, and preferably 1 to 24 hours.

The method for producing an article may further include removing an unreacted surface treatment agent and/or by-products after forming a layer on a surface of the base material. The removal of the unreacted surface treatment agent and/or by-products may be performed by one or more selected from washing or drying. The technical scope of the article of the present disclosure also include articles from which the unreacted surface treatment agent and/or by-products have been removed.

### EXAMPLES

The present invention will be described more specifically with reference to the following Examples, but the present invention is not limited thereto.

### Example 1

Perfluorooctyl iodide (10 mol %), 5 equivalents (1 mL) of an aqueous sodium thiosulfate solution, and 3 equivalents (1 mL) of an aqueous cesium carbonate solution were added to a dichloromethane solution (5 mL) of polystyrene (15) (Mₙ=1.1×10⁴, M_{w}/Mₙ=1.02), and light irradiation with a 365 nm LED and stirring were performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 16 (Mₙ=1.2×10⁴, M_{w}/Mₙ=1.16) in which a C₈F₁₇ group was introduced into 7 mol % of all benzene rings was obtained at an isolation yield of 92%.

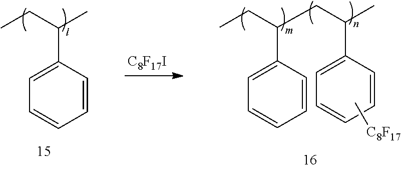

¹H NMR (400 MHz, CDCl₃)

δ=7.07 (br), 6.57 (br), 1.84 (br), 1.43 (br), 0.71 (br)

¹⁹F NMR (376 MHz, CDCl₃)

δ=−81.23 (3F, br), −111.03 (2F, br), −122.37 (8F, br), −123.20 (2F, br), −126.61 (2F, br).

### Example 2

Iodide (17) (50 mol %), 5 equivalents (1 mL) of an aqueous sodium thiosulfate solution, and 3 equivalents (1 mL) of an aqueous cesium carbonate solution were added to a dichloromethane solution (5 mL) of polystyrene (15) (the total amount of the aromatic ring was 0.5 mmol) (Mₙ=1.4×10⁴, M_{w}/Mₙ=1.03), and light irradiation with a 365 nm LED and stirring were performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 18 (Mₙ=2.8×10⁴, M_{w}/Mₙ=2.2) in which a C₂F₄OCF₃ group was introduced into 37 mol % of all benzene rings was obtained at an isolation yield of 89%.

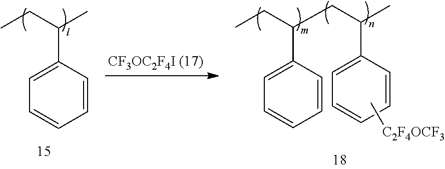

¹H NMR (400 MHz, CDCl₃)

δ=7.04 (br), 6.54 (br), 1.78 (br), 1.41 (br), 0.69 (br)

¹⁹F NMR (376 MHz, CDCl₃)

δ=−55.69 (3F, br), −86.91 (2F, br), −89.68 (2F, br), −114.85 (2F, br).

### Example 3

Iodide (19) (50 mol %), 5 equivalents (1 mL) of an aqueous sodium thiosulfate solution, and 3 equivalents (1 mL) of an aqueous cesium carbonate solution were added to a dichloromethane solution (5 mL) of polystyrene (15) (the total amount of the aromatic ring was 0.5 mmol) (Mₙ=1.1×10⁴, M_{w}/Mₙ=1.02, Tg=84° C.), and light irradiation with a 365 nm LED and stirring were performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 20 (Mₙ=1.3×10⁴, M_{w}/Mₙ=1.5) in which a perfluoropolyether skeleton derived from the raw material iodide was introduced into 29 mol % of all benzene rings was obtained at an isolation yield of 35%. The glass transition point (Tg) of the obtained polymer was measured by DSC and found to be 45° C., which was lower than that of the raw material polystyrene, and this result shows that a more flexible material was obtained.

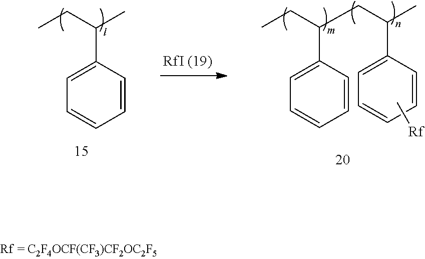

¹H NMR (400 MHz, CDCl₃)

δ=7.04 (br), 6.55 (br), 1.80 (br), 1.41 (br), 0.69 (br)

¹⁹F NMR (376 MHz, CDCl₃)

δ=−80.55 (3F, br), −83.84 (2F, br), −85.13 (2F, br), −87.43 (3F, br), −89.22 (2F, br), −114.88 (2F, br), −146.25 (1F, br).

### Example 4

Perfluoroisopropyl iodide (1 equivalent), 5 equivalents (1 mL) of an aqueous sodium thiosulfate solution, and 3 equivalents (1 mL) of an aqueous cesium carbonate solution were added to a dichloromethane solution (5 mL) of polystyrene (15) (the total amount of the aromatic ring was 0.5 mmol) (Mₙ=1.1×10⁴, M_{w}/Mₙ=1.02), and light irradiation with a 365 nm LED and stirring were performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 21 (Mₙ=1.4×10⁴, M_{w}/Mₙ=1.11) in which a perfluoroisopropyl group was introduced into 31 mol % of all benzene rings was obtained.

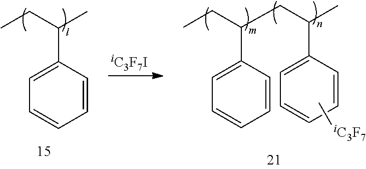

¹H NMR (400 MHz, CDCl₃)

δ=7.03 (br), 6.52 (br), 1.41 (br), 0.69 (br)

¹⁹F NMR (376 MHz, CDCl₃)

δ=−72.65 (6F, br), −74.62 (6F, br), −76.31 (6F, br), −179.22 (1F, br), −180.18 (1F, br), −183.03 (1F, br).

### Example 5

Ethyl iododifluoroacetate (1 equivalent), 5 equivalents (1 mL) of an aqueous sodium thiosulfate solution, and 3 equivalents (1 mL) of an aqueous cesium carbonate solution were added to a dichloromethane solution (5 mL) of polystyrene (15) (the total amount of the aromatic ring was 0.5 mmol) (Mₙ=1.1×10⁴, M_{w}/Mₙ=1.02), and light irradiation with a 365 nm LED and stirring were performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 22 (Mₙ=1.2×10⁴, M_{w}/Mₙ=1.04) into which an ethyl difluoroacetate skeleton in an amount corresponding to 11 mol % of all benzene rings was introduced was obtained at an isolation yield of 82%.

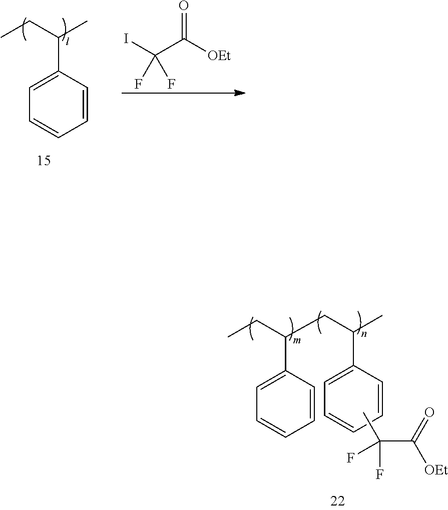

¹H NMR (400 MHz, CDCl₃)

δ=7.08 (br), 6.57 (br), 1.83 (br), 1.41 (br), 0.71 (br)

¹⁹F NMR (376 MHz, CDCl₃)

δ=−103.60 (2F, br).

### Example 6

1-Bromo-2-iodotetrafluoroethane (50 mol %), 5 equivalents (1 mL) of an aqueous sodium thiosulfate solution, and 3 equivalents (1 mL) of an aqueous cesium carbonate solution were added to a dichloromethane solution (5 mL) of polystyrene (15) (the total amount of the aromatic ring was 0.5 mmol) (Mₙ=1.1×10⁴, M_{w}/Mₙ=1.02), and light irradiation with a 365 nm LED and stirring were performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 23 (Mₙ=1.2×10⁴, M_{w}/Mₙ=1.04) in which a C₂F₄Br group was introduced into 30 mol % of all benzene rings was quantitatively obtained.

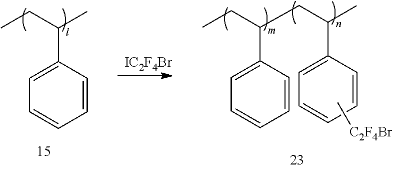

¹H NMR (500 MHz, CDCl₃)

δ=7.04 (br), 6.51 (br), 1.83 (br), 1.41 (br), 0.69 (br)

¹⁹F NMR (376 MHz, CDCl₃)

δ=−65.16 (2F, br), −108.24 (2F, br)

### Example 7

Iodide (24) (50 mol %), 5 equivalents (1 mL) of an aqueous sodium thiosulfate solution, and 3 equivalents (1 mL) of an aqueous cesium carbonate solution were added to a dichloromethane solution (5 mL) of polystyrene (15) (the total amount of the aromatic ring was 0.5 mmol) (Mₙ=1.1×10⁴, M_{w}/Mₙ=1.02), and light irradiation with a 365 nm LED and stirring were performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 25 (Mₙ=1.3×10⁴, M_{w}/Mₙ=1.51) in which a C₂F₄OC₂F₄Br group was introduced into 15 mol % of all benzene rings was quantitatively obtained.

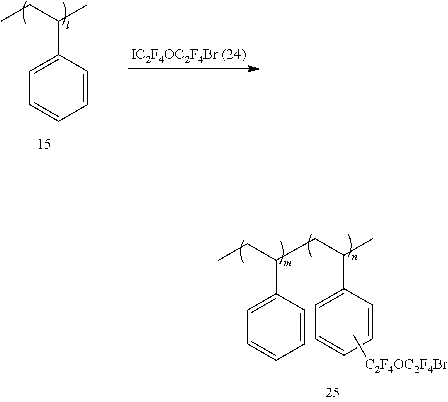

¹H NMR (400 MHz, CDCl₃)

δ=7.05 (br), 6.55 (br), 1.79 (br), 1.41 (br), 0.70 (br)

¹⁹F NMR (376 MHz, CDCl₃)

δ=−69.89 (2F, br), −87.00 (2F, br), −87.99 (2F, br), −114.97 (2F, br).

### Example 8

1,6-Diiodoperfluorohexane (50 mol %), 5 equivalents (1 mL) of an aqueous sodium thiosulfate solution, and 3 equivalents (1 mL) of an aqueous cesium carbonate solution were added to a dichloromethane solution (5 mL) of polystyrene (15) (the total amount of the aromatic ring was 0.5 mmol) (Mₙ=1.1×10⁴, M_{w}/Mₙ=1.02), and light irradiation with a 365 nm LED and stirring were performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 27 (Mₙ=1.3×10⁴, M_{w}/Mₙ=2.3) in which a C₆F₁₂I group was introduced into 11 mol % of all benzene rings was obtained at an isolation yield of 75%. It was confirmed that 1 mol % of all benzene rings was a crosslinked structure, but the obtained polymer was soluble in chloroform and THF.

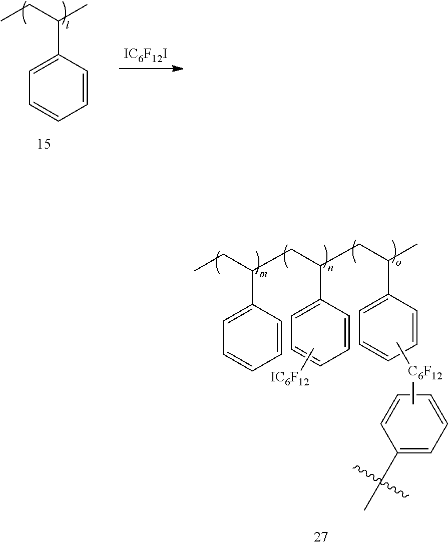

¹H NMR (400 MHz, CDCl₃)

δ=7.06 (br), 6.56 (br), 1.58 (br), 0.70 (br)

¹⁹F NMR (376 MHz, CDCl₃)

δ=−59.35 (2F, br), −111.10 (2F, br), −113.52 (2F, br), −121.54 (6F, br), −121.88 (6F, br)

### Example 9

Perfluoropropyl iodide (1 equivalent), 5 equivalents (1 mL) of an aqueous sodium thiosulfate solution, and 3 equivalents (1 mL) of an aqueous cesium carbonate solution were added to a dichloromethane solution (5 mL) of poly(α,β,β-trifluorostyrene) (28) (the total amount of the aromatic ring was 0.5 mmol) (Mₙ=5.5×10⁴, M_{w}/Mₙ=8.31), and light irradiation with a 365 nm LED and stirring were performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 29 (Mₙ=2.4×10⁵, M_{w}/Mₙ=3.43) in which a C₃F₇ group was introduced into 43 mol % of all benzene rings was obtained at an isolation yield of 69%.

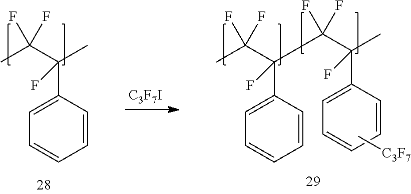

¹H NMR (400 MHz, CDCl₃): δ=7.14 (br), 6.93 (br), 6.54 (br), 5.74 (br)

¹⁹F NMR (471 MHz, CDCl₃): δ=−80.5 (3F, br), −81.1 (3F, br), −108.2 (3F, br), −109.4 (2F, br), −113.05 (2F, br), −127.31 (2F, br), −175.2 (2F, br)

### Example 10

Perfluoropropyl iodide (1 equivalent), 5 equivalents (1 mL) of an aqueous sodium thiosulfate solution, and 3 equivalents (1 mL) of an aqueous cesium carbonate solution were added to a dichloromethane solution (5 mL) of a copolymer (commonly called AS resin) (30) (the total amount of the benzene ring was 0.5 mmol) (Mₙ=6.1×10⁴, M_{w}/Mₙ=4.92) having a molar composition ratio of acrylonitrile to styrene of 2:3, and light irradiation with a 365 nm LED and stirring were performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 31 (Mₙ=2.7×10⁴, M_{w}/Mₙ=1.42) in which a C₃F₇ group was introduced into 13 mol % of all benzene rings was obtained at an isolation yield of 12%.

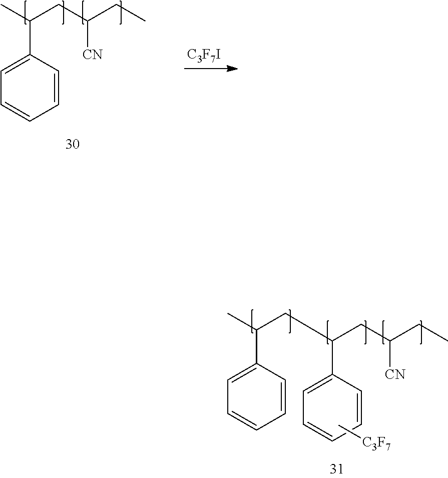

Spectrum of Compound 31

¹H NMR (400 MHz, CDCl₃): δ=7.13 (br), 6.75 (br), 2.55 (br), 1.61 (br), 1.42 (br)

¹⁹F NMR (471 MHz, CDCl₃): δ=−80.5 (3F, br), −112.4 (2F, br), −127.0 (2F, br)

### Example 11

A resin sample plate (ABS, natural color, “product number 3-3262-01” manufactured by AS ONE Corporation) (32) containing an acrylonitrile component, a 1,3-butadiene component, and a styrene component (the total amount of the benzene ring was 0.5 mmol) (Mₙ=5.8×10⁴, M_{w}/Mₙ=3.15) was dissolved in dichloromethane (5 mL). Then, 1 equivalent of perfluoropropyl iodide, 5 equivalents of an aqueous sodium thiosulfate solution (1 mL), and 3 equivalents of an aqueous cesium carbonate solution (1 mL) were added to the solution, and light irradiation with a 365 nm LED was performed at room temperature for 2 hours. The obtained reaction mixture was reprecipitated with methanol as a poor solvent, and further purified by reprecipitation with a methanol/water (3/2) mixed solvent as a poor solvent. As a result, it was found that a desired polymer 33 (Mₙ=5.7×10⁴, M_{w}/Mₙ=3.58) having a fluorine content of 13 wt % in which a C₃F₇ group in an amount of 0.0754 mmol in total was introduced was obtained.

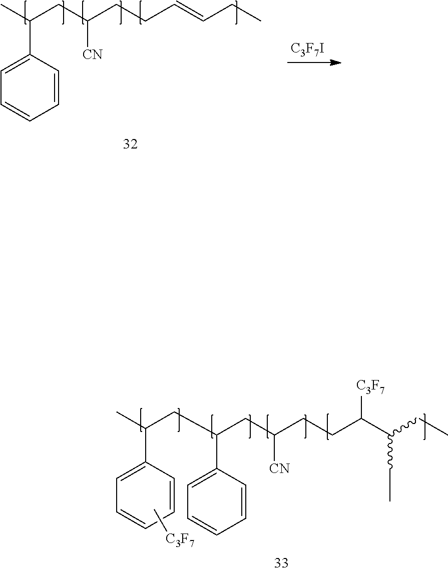

Spectrum of Compound 33

¹H NMR (400 MHz, CDCl₃): δ=7.13 (br), 6.75 (br), 2.56 (br), 2.03 (br), 1.61 (br)

¹⁹F NMR (471 MHz, CDCl₃): δ=−80.4 (3F, br), −81.0 (3F, br), −112.2 (2F, br), −126.9 (2F, br)

### Example 12

Perfluoropropyl iodide (1 equivalent), 5 equivalents (1 mL) of an aqueous sodium thiosulfate solution, and 3 equivalents (1 mL) of an aqueous cesium carbonate solution were added to a dichloromethane solution (5 mL) of a block copolymer (commonly called hydrogenated styrene-based thermoplastic elastomer (SEBS)) (34) (the total amount of the aromatic ring was 0.5 mmol) (Mₙ=1.2×10⁵, M_{w}/Mₙ=1.23) containing 29 wt % of a polystyrene unit, and light irradiation with a 365 nm LED was performed at room temperature for 3 hours. The obtained reaction mixture was reprecipitated with methanol as a poor solvent, and further purified by reprecipitation with a methanol/water (3/2) mixed solvent as a poor solvent. As a result, a desired polymer 35 (Mₙ=9.6×10⁴, M_{w}/Mₙ=1.51) in which a C₃F₇ group was introduced into 21 mol % of all benzene rings was obtained at an isolation yield of 88%.

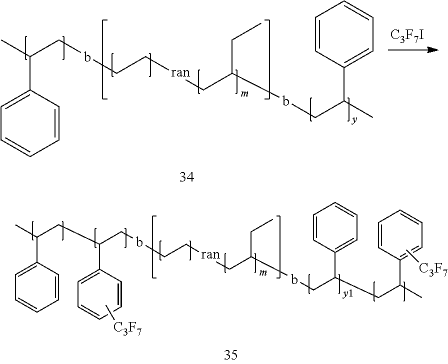

Spectrum of Compound 35

¹H NMR (400 MHz, CDCl₃): δ=7.05 (br), 6.56 (br), 1.84 (br), 1.68 (br), 1.43 (br), 1.26 (br), 1.08 (br), 0.83 (br)

¹⁹F NMR (471 MHz, CDCl₃): δ=−80.5 (3F, br), −81.2 (3F, br), −112.0 (2F, br), −114.8 (2F, br), −125.1 (2F, br), −127.0 (2F, br)

### Example 13

Perfluoropropyl iodide (1 equivalent with respect to the total amount of the benzene ring), 5 equivalents (1 mL) of an aqueous sodium thiosulfate solution, and 1.5 equivalents (1 mL) of an aqueous cesium carbonate solution were added to a dichloromethane solution (5 mL) of a block copolymer (commonly called styrene-based thermoplastic elastomer (SBS)) (36) (192 mg) (Mₙ=1.5×10⁵, M_{w}/Mₙ=1.17) containing 30 wt % of a polystyrene unit, and light irradiation with a 365 nm LED was performed for 2 hours at room temperature. The obtained reaction mixture was reprecipitated with methanol as a poor solvent, and further purified by reprecipitation with a methanol/water (3/2) mixed solvent as a poor solvent. As a result, a desired polymer 37 (Mₙ=2.5×10⁴, M_{w}/Mₙ=3.53) having a fluorine content of 12 wt % was obtained at an isolation yield of 211 mg.

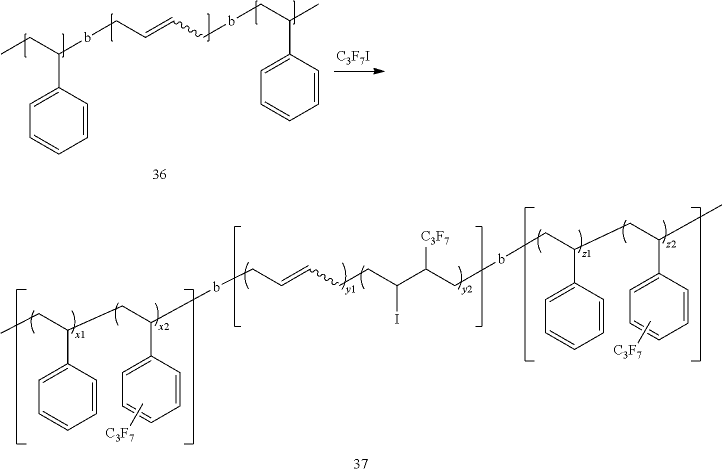

Spectrum of Compound 37

¹H NMR (400 MHz, CDCl₃): δ=7.08 (br), 6.58 (br), 5.42 (br), 4.96 (br), 4.08 (br), 2.08 (br), 2.03 (br), 1.43 (br)

¹⁹F NMR (471 MHz, CDCl₃): δ=−80.8 (3F, br), −81.2 (br), −110.4 (2F, br), −111.14 (2F, br), −114.8 (2F, br), −121.6 (2F, br), 122.3 (2F, br), −125.6 (2F, br), 128.2 (2F, br)

### Example 14

Perfluoropropyl iodide (1 equivalent with respect to the total amount of the benzene ring), 5 equivalents (1 mL) of an aqueous sodium thiosulfate solution, and 1.5 equivalents (1 mL) of an aqueous cesium carbonate solution were added to a dichloromethane solution (5 mL) of a block copolymer (commonly called styrene-based thermoplastic elastomer (SIS)) (38) (240 mg) (Mₙ=2.3×10⁵, M_{w}/Mₙ=1.22) containing 22 wt % of a polystyrene unit, and light irradiation with a 365 nm LED was performed for 2 hours at room temperature. The obtained reaction mixture was reprecipitated with methanol as a poor solvent, and further purified by reprecipitation with a methanol/water (3/2) mixed solvent as a poor solvent. As a result, a desired polymer 39 (Mₙ=9.8×10⁴, M_{w}/Mₙ=3.54) having a fluorine content of 23 wt % was obtained at an isolation yield of 323 mg.

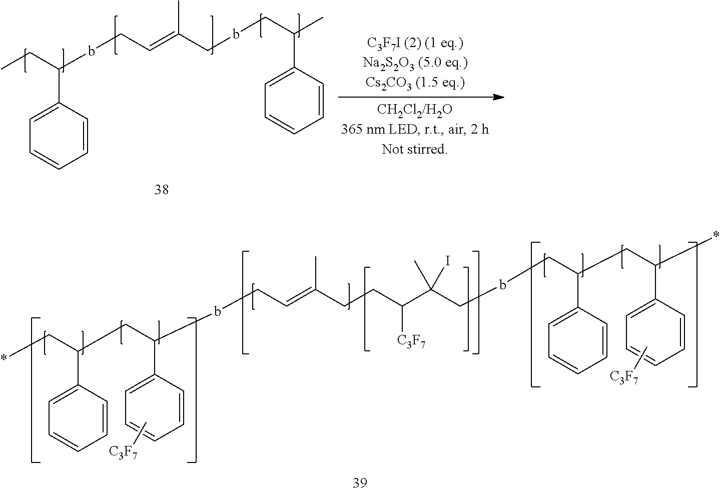

Spectrum of Compound 39

¹H NMR (400 MHz, CDCl₃): δ=7.07 (br), 6.57 (br), 5.12 (br), 4.75 (br), 4.67 (br), 4.48 (br), 2.03 (br), 1.67 (br), 1.59 (br), 1.43 (br)

¹⁹F NMR (471 MHz, CDCl₃): δ=−80.5 (3F, br), −80.9 (3F, br), −81.1 (3F, br), −111.4 (2F, br), −125.6 (2F, br), −128.2 (2F, br)

### Example 15

Diiodoperfluorobutyl (0.5 equivalents), 5 equivalents of an aqueous sodium thiosulfate solution, and 1.5 equivalents of an aqueous cesium carbonate solution were added to a dichloromethane solution (5 mL) of polystyrene (15) (Mₙ=5.8×10³, M_{w}/Mₙ=1.03), and light irradiation with 365 nm LED and stirring were performed at room temperature for 24 hours. The obtained reaction mixture was reprecipitated with methanol as a poor solvent, and further purified by reprecipitation with a dichloromethane/water (5/2) mixed solvent as a poor solvent. As a result, a desired polymer 40 (Mₙ=8.9×10³, M_{w}/Mₙ=1.12) in which a C₄F₈ group was introduced into 30 mol % of all benzene rings was obtained at an isolation yield of 63%. The fluorine content was 10 mass %.

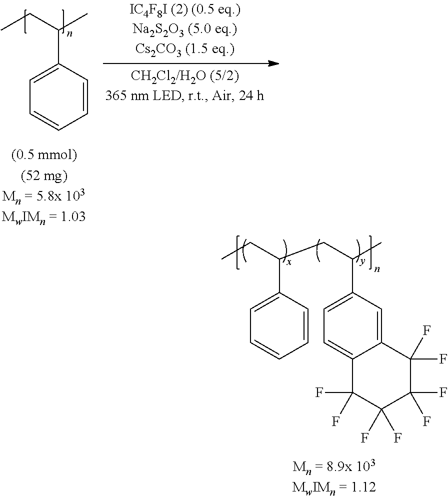

¹H NMR (400 MHz, CDCl₃)

δ=6.99 (br), 6.43 (br), 1.46 (br)

¹⁹F NMR (376 MHz, CDCl₃)

δ=−103.34 (br), −134.83 (br)

### Example 16

Perfluoropropyl iodide (0.2 to 1 equivalents), 3 equivalents of an aqueous sodium thiosulfate solution, and 1.5 equivalents of an aqueous cesium carbonate solution were added to a dichloromethane solution (5 mL) of polystyrene 41 (Mₙ=8.9×10³, M_{w}/Mₙ=1.03), and light irradiation with a 365 nm LED was performed at room temperature for 24 hours. The obtained reaction mixture was reprecipitated with methanol as a poor solvent, and further purified by reprecipitation with a dichloromethane/water mixed solvent as a poor solvent. As a result, desired polymers 41a to 41d in which a C₃F₇ group was introduced into 23 to 102 mol % of all benzene rings were obtained. The introduction ratio was measured by ¹⁹F NMR using α,α,α-trifluorotoluene as a reference substance.

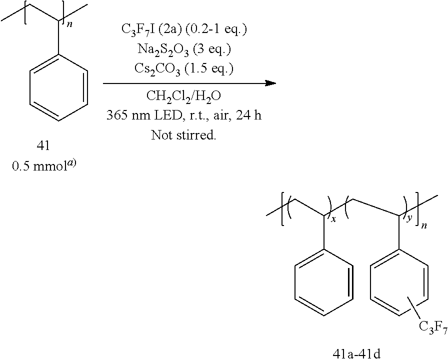

The results of measuring the contact angle with water and the contact angle with n-dodecane for polystyrene 41 and polymers 41a to 41d are shown in Table 1.

TABLE 1

| | Introduction | Contact angle | Contact angle |
|---|---|---|---|
| Compound | ratio | with water | with n-dodecane |
| 41 | 0% | 97.4° | 4.4° |
| 41a | 23% | 101.5° | 9.4° |
| 41b | 52% | 103.0° | 10.4° |
| 41c | 70% | 101.5° | 10.8° |
| 41d | 102% | 104.5° | 33.3° |

The contact angle was measured by the following method.

A polymer was dissolved in toluene (30 mass %) so as to have a concentration of 30 mass %, to prepare a polymer solution. This polymer solution was spin-coated on a silicon wafer, and heated and dried at 110° C. to prepare a film of the polymer on the silicon wafer.

The contact angle was measured in an environment of 25° C. using a wettability evaluation apparatus (contact angle meter) LSE-ME5 (manufactured by NiCK Corporation). Specifically, a base material having a polymer film to be measured was allowed to stand horizontally, and a liquid (water or n-dodecane) to be measured was dropped from a microsyringe onto the surface of the base material. Then, a still image 1 second after the dropping was photographed with a video microscope to measure the static contact angle. As the static contact angle, a value obtained by measuring at three different points of the surface-treated layer of the base material, and calculating an average of the measured values was used.

### Example 17

A compound (0.5 to 1 equivalents) represented by RfI wherein Rf represents a group shown in Table 2, 3.0 equivalents of an aqueous sodium thiosulfate solution, and 1.5 equivalents of an aqueous cesium carbonate solution were added to a dichloromethane solution (5 mL) of polystyrene 42 (Mₙ=8.9×10³, M_{w}/Mₙ=1.03), and light irradiation with a 365 nm LED was performed at room temperature for 24 hours. The obtained reaction mixture was reprecipitated with methanol as a poor solvent, and further purified by reprecipitation with a dichloromethane/water mixed solvent as a poor solvent. As a result, desired polymers 42a to 42f in which an Rf group was introduced into 17 to 79 mol % of all benzene rings were obtained. The introduction ratio was measured by ¹⁹F NMR using α,α,α-trifluorotoluene as a reference substance.

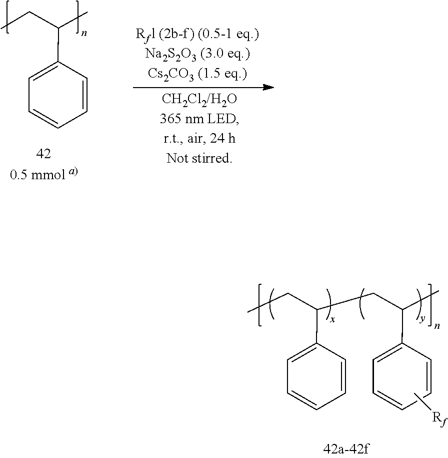

The results of measuring the contact angle with water and the contact angle with n-dodecane for polystyrene 42 and polymers 42a to 42f are shown in the following table.

TABLE 2

| | 42 | 42a | 42b | 42c |
|---|---|---|---|---|
| entry | 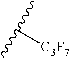 | 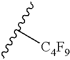 | 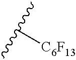 | 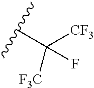 [SMILES: *C(F)(C(F)(F)F)C(F)(F)F] |
| Introduction ratio^{b)} | 3a:70% | 3b:72% | 3c^{c)}:69% | 3e:59% |
| Contact angle with water | 101.5° | 106.8° | 111.0° | 106.6° |
| Contact angle with n-dodecane | 10.8° | 38.9° | 43.3° | 37.8° |

| | 42d | 42e | 42f |
|---|---|---|---|
| | 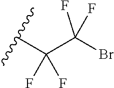 [SMILES: *C(F)(F)C(F)(F)Br] | 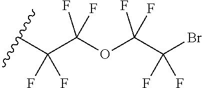 [SMILES: *C(F)(F)C(F)(F)OC(F)(F)C(F)(F)Br] | 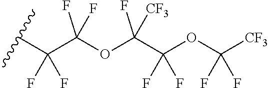 [SMILES: *C(F)(F)C(F)(F)OC(F)(C(F)(F)F)C(F)(F)OC(F)(F)C(F)(F)F] |
| Introduction ratio^{b)} | 3i:17% | 3j:79% | 3f:75% |
| Contact angle with water | 110.0° | 107.9° | 110.9° |
| Contact angle with n-dodecane | 46.7° | 40.2° | 46.4° |

^{a)}Amount of styrene unit.
^{b)}Determined by ¹⁹F NMR using BTF.
^{c)}R_{f}I = 0.5 eq.

### Example 18

A compound represented by the following formula (0.5 equivalents):

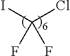

wherein Rf represents-CF₂CF₂CF₂CF₂CF₂CF₂—, 3.0 equivalents of an aqueous sodium thiosulfate solution, and 1.5 equivalents of an aqueous cesium carbonate solution were added to a dichloromethane solution (5 mL) of polystyrene 43 (Mₙ=8.9×10³, M_{w}/Mₙ=1.03), and light irradiation with a 365 nm LED was performed at room temperature for 24 hours. The obtained reaction mixture was reprecipitated with methanol as a poor solvent, and further purified by reprecipitation with a dichloromethane/water mixed solvent as a poor solvent. As a result, a desired polymer 43a (Mₙ=1.4×10⁴, M_{w}/Mₙ=1.06) in which an Rf group was introduced into 44 mol % of all benzene rings was obtained at an isolation yield of 69%. The fluorine content in the polymer 43a was 40 mass %. The introduction ratio was measured by ¹⁹F NMR using α,α,α-trifluorotoluene as a reference substance.

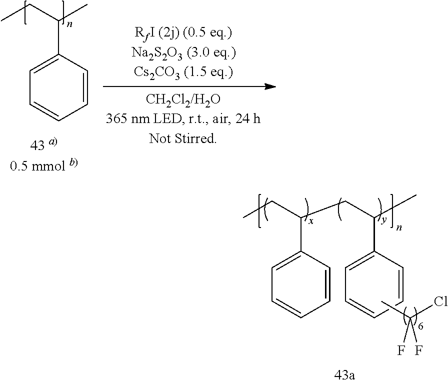

¹H NMR (400 MHz, CDCl₃)

δ=7.03 (br), 6.50 (br), 1.77 (br), 1.40 (br)

¹⁹F NMR (376 MHz, CDCl₃)

δ=−68.55 (br), −111.19 (br), −120.68 (br), −121.94 (br)

### Example 19

A compound (RfI) represented by the following formula (0.5 equivalents):

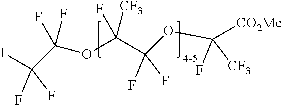

3.0 equivalents of an aqueous sodium thiosulfate solution, and 1.5 equivalents of an aqueous cesium carbonate solution were added to a dichloromethane solution (5 mL) of polystyrene 44 (Mₙ=8.9×10³, M_{w}/Mₙ=1.03), and light irradiation with a 365 nm LED was performed at room temperature for 24 hours. The obtained reaction mixture was reprecipitated with methanol as a poor solvent, and further purified by reprecipitation with a dichloromethane/water mixed solvent as a poor solvent. As a result, a desired polymer 44a (Mₙ=1.6×10⁴, M_{w}/Mₙ=1.08) in which an Rf group was introduced into 19 mol % of all benzene rings was obtained at an isolation yield of 118%. The fluorine content in the polymer 44a was 41 mass %. The introduction ratio was measured by ¹⁹F NMR using α,α,α-trifluorotoluene as a reference substance.

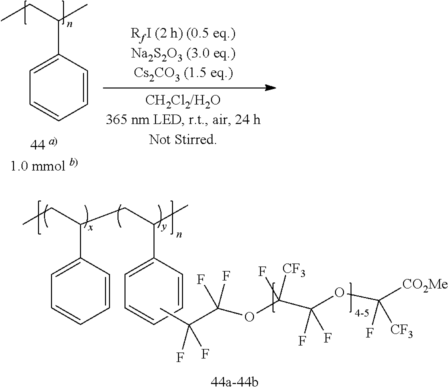

¹H NMR (400 MHz, CDCl₃)

δ=7.04 (br), 6.56 (br), 3.92 (br), 1.80 (br), 1.42 (br)

¹⁹F NMR (376 MHz, CDCl₃)

δ=−80.87 (br), −83.12 (br), −84.92 (br), −85.89 (br), −114.93 (br), −132.30 (br), −145.96 (br)

The contact angle, the advancing contact angle, the receding contact angle, and the sliding angle with water were measured for the polystyrene 44 and the polymer 44a, and the results were as shown in the following table.

TABLE 3

| | | Contact | Advancing | Receding | |
|---|---|---|---|---|---|
| | Introduction | angle | contact | contact | Sliding |
| Compound | ratio | with water | angle θa | angle θr | angle |
| 44 | 0% | 82.5° | 93.9° | 65.6° | 64.2° |
| 44a | 19% | 103.5° | 106.1° | 79.8° | 48.7° |

The advancing contact angle, the receding contact angle, and the sliding angle were measured by the following methods.

A polymer was dissolved in toluene (30 mass %) so as to have a concentration of 30 mass %, to prepare a polymer solution. This polymer solution was spin-coated on a silicon wafer, and heated and dried at 110° C. to prepare a film of the polymer on the silicon wafer.

The advancing contact angle, the receding contact angle, and the sliding angle were measured under an environment of 25° C. using a wettability evaluation apparatus (contact angle meter) LSE-ME5 (manufactured by NiCK Corporation). Specifically, a base material having a polymer film to be measured was allowed to stand horizontally, a liquid (water or n-dodecane) to be measured was dropped from a microsyringe onto the surface of the base material, and the sample was gradually inclined from the horizontal state. The inclination angle when the droplet slid down was defined as a sliding angle, the contact angle at the front of the droplet was defined as an advancing contact angle (0a), and the contact angle at the rear of the droplet was defined as a receding contact angle (Or).

### Example 20

A compound (0.5 equivalents) represented by RfI wherein Rf represents a group shown in Table 4, 3.0 equivalents of an aqueous sodium thiosulfate solution, and 1.5 equivalents of an aqueous cesium carbonate solution were added to a dichloromethane solution (5 mL) of polystyrene 45 (Mₙ=8.9×10³, M_{w}/Mₙ=1.03), and light irradiation with a 365 nm LED was performed at room temperature for 24 hours. The obtained reaction mixture was reprecipitated with methanol as a poor solvent, and further purified by reprecipitation with a dichloromethane/water mixed solvent as a poor solvent. As a result, desired polymers 45a to 45b in which an Rf group was introduced into 19 to 69 mol % of all benzene rings were obtained. The introduction ratio was measured by ¹⁹F NMR using α,α,α-trifluorotoluene as a reference substance.

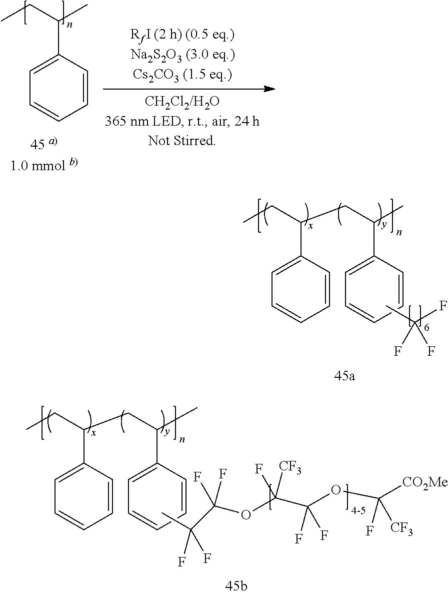

The contact angle, the advancing contact angle, the receding contact angle, and the sliding angle with n-dodecane were measured for the polystyrene 45 and the polymers 45a to 45b, and the results were shown in the following table.

TABLE 4

| | | Contact | | | |
|---|---|---|---|---|---|
| | Intro- | angle | Advancing | Receding | |
| | duction | with | contact | contact | Sliding |
| Compound | ratio | n-dodecane | angle θa | angle θr | angle |
| 45 | 0% | 4.4° | — | — | — |
| 45a | 69% | 43.3° | 45.9° | 19.0° | 27.5° |
| 45b | 19% | 42.3° | 71.3° | 10.6° | 36.8° |

### Example 21

Perfluoropropyl iodide (0.5 to 1 equivalents), 3.0 equivalents of an aqueous sodium thiosulfate solution, and 1.5 equivalents of an aqueous cesium carbonate solution were added to a dichloromethane solution (5 mL) of polyvinyl naphthalene 46 (Mₙ=4.4×10³, M_{w}/Mₙ=2.28), and light irradiation with a 365 nm LED was performed at room temperature for 24 hours. The obtained reaction mixture was reprecipitated with methanol as a poor solvent, and further purified by reprecipitation with a dichloromethane/water mixed solvent as a poor solvent. As a result, desired polymers 46a to 46b in which a perfluoropropyl group was introduced into 37 to 53 mol % of all benzene rings were obtained. The introduction ratio was measured by ¹⁹F NMR using α,α,α-trifluorotoluene as a reference substance.

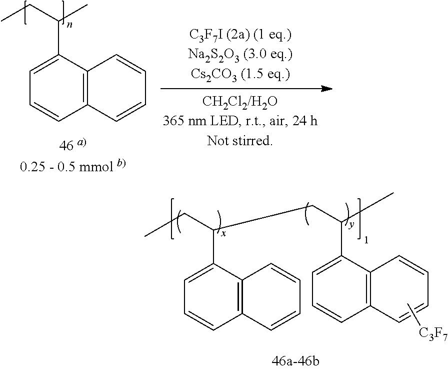

¹H NMR (400 MHz, CDCl₃)

δ=6.98 (br), 1.43 (br)

¹⁹F NMR (376 MHz, CDCl₃)

δ=−80.58 (br), −105.47 (br), −112.08 (br), −125.08 (br), −126.61 (br)

### Example 22

Perfluoropropyl iodide (1.0 equivalents), 3.0 equivalents of an aqueous sodium thiosulfate solution, and 1.5 equivalents of an aqueous cesium carbonate solution were added to a dichloromethane solution (5 mL) of poly(4-chloro)styrene 47 (M_{w}=3.9×10⁴, M_{w}/Mₙ=3.17), and light irradiation with a 365 nm LED was performed at room temperature for 24 hours. The obtained reaction mixture was reprecipitated with methanol as a poor solvent, and further purified by reprecipitation with a dichloromethane/water mixed solvent as a poor solvent. As a result, a desired polymer 47a (M_{w}=3.9×10⁴, M_{w}/Mₙ=3.17) in which a perfluoropropyl group was introduced into 8 mol % of all benzene rings was obtained at an isolation yield of 69%. The fluorine content of the polymer 47a was 7 mass %.

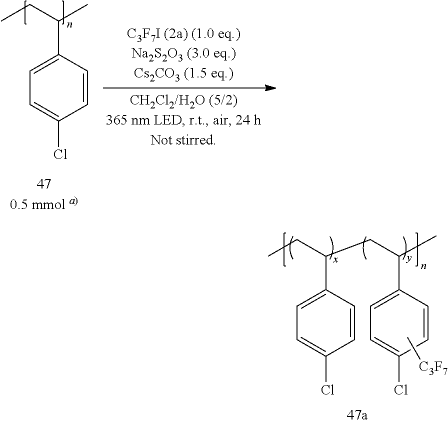

¹H NMR (400 MHz, CDCl₃)

δ=7.04 (br), 6.40 (br), 2.02 (br), 1.91 (br), 1.83 (br), 1.59 (br), 1.32 (br)

¹⁹F NMR (376 MHz, CDCl₃)

δ=−80.58 (br), −81.27 (br), −108.49 (br), −113.04 (br), −122.86 (br), −123.40 (br), −124.16 (br), −125.27 (br), −126.66 (br)

### Example 23

Perfluoropropyl iodide (1.0 equivalents), 3.0 equivalents of an aqueous sodium thiosulfate solution, and 1.5 equivalents of an aqueous cesium carbonate solution were added to a dichloromethane solution (5 mL) of a polystyrene-poly(α-methyl)styrene copolymer 48 (styrene [x]:α-methylstyrene [y]=2:1), and light irradiation with a 365 nm LED was performed at room temperature for 24 hours. The obtained reaction mixture was reprecipitated with methanol as a poor solvent, and further purified by reprecipitation with a dichloromethane/water mixed solvent as a poor solvent. As a result, a desired polymer 48a (M_{w}=4.9×10³, M_{w}/Mₙ=1.41) having a fluorine content of 38 wt % was obtained at an isolation yield of 30.1 mg.

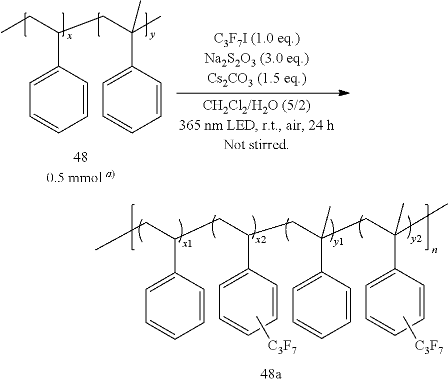

¹H NMR (400 MHz, CDCl₃)

δ=7.10 (br), 6.89 (br), 6.67 (br), 1.56 (br), 1.05 (br), 0.72 (br), 0.40 (br), 0.05 (br)

¹⁹F NMR (376 MHz, CDCl₃)

δ=−80.60 (br), −112.24 (br), −126.75 (br), −127.00 (br), −127.17 (br), −127.61 (br)

### Example 24

Perfluorocyclohexyl iodide (50 mol %), 3 equivalents (1 mL) of an aqueous sodium thiosulfate solution, and 1.5 equivalents (1 mL) of an aqueous cesium carbonate solution were added to a dichloromethane solution (5 mL) of polystyrene (49) (Mₙ=8.9×10³, M_{w}/Mₙ=1.03), and light irradiation with a 365 nm LED was performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 49a (Mₙ=1.3×10⁴, M_{w}/Mₙ=1.04) in which a C₆F₁₁ group was introduced into 28 mol % of all benzene rings was obtained at an isolation yield of 94%.

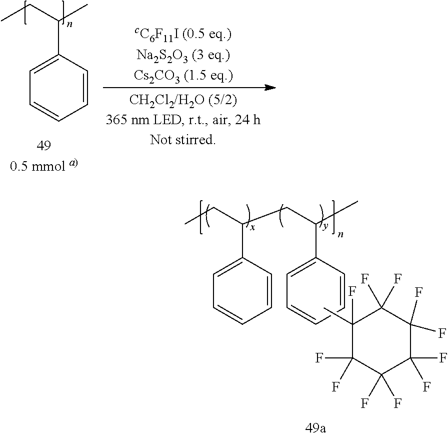

¹H NMR (400 MHz, CDCl₃)

δ=7.03 (br), 6.49 (br), 1.77 (br), 1.41 (br)

¹⁹F NMR (376 MHz, CDCl₃)

δ=−118.73 (br), −119.52 (br), −122.13 (br), −122.87 (br), −123.19 (br), −123.96 (br), −133.22 (br), −134.01 (br), −138.81 (br), −139.56 (br), −141.84 (br), −142.60 (br)

### Example 25

Perfluorodecyl iodide (30 mol %), 3 equivalents (1 mL) of an aqueous sodium thiosulfate solution, and 1.5 equivalents (1 mL) of an aqueous cesium carbonate solution were added to a dichloromethane solution (5 mL) of polystyrene (50) (Mₙ=8.9×10³, M_{w}/Mₙ=1.03), and light irradiation with a 365 nm LED was performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 50a (Mₙ=1.3×10⁴, M_{w}/Mₙ=1.11) in which the fluorine content was 39 mass % and a C₁₀F₂₁ group was introduced into 20 mol % of all benzene rings was obtained at an isolation yield of 91%.

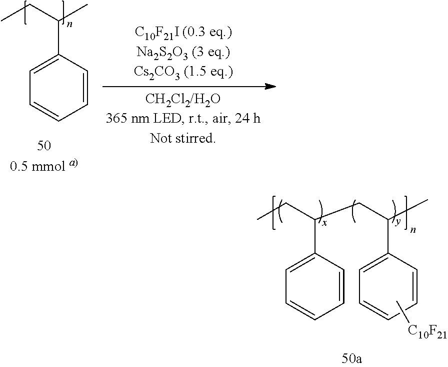

¹H NMR (400 MHz, CDCl₃)

δ=7.04 (br), 6.56 (br), 1.82 (br), 1.43 (br)

¹⁹F NMR (376 MHz, CDCl₃)

δ=−81.42 (br), −111.15 (br), −122.39 (br), −123.32 (br), −126.76 (br)

### Example 26

Under atmospheric condition, 2.0 equivalents (8.416 mg) of 1-decene and 5.0 equivalents of an aqueous thiosulfate solution (23.7 mg, 1.5 mL) were added to a dichloromethane solution (7.5 mL) of polystyrene 51, which contain 0.03 mmol of iodoperfluorohexyl group, and light irradiation with a 365 nm LED was carried out for 3 hours. The obtained reaction mixture was reprecipitated with methanol as a poor solvent, and further purified by reprecipitation with a methanol/water (5/1) solvent as a poor solvent. As a result, a desired polymer 51a (Mₙ=9.4×10³, M_{w}/Mₙ=1.18) containing structure (a), in which a 1-decene was added to 80 mol % of all [—CF₂I] group of the raw material, was obtained at an isolation yield of 64%.

From this result, Polymer 51 of the present invention, which contains iodine on its side chain, is capable of further hosting a post-modification reaction. This post-modification reaction would be applicable to surface modification reaction or surface-curing reaction.

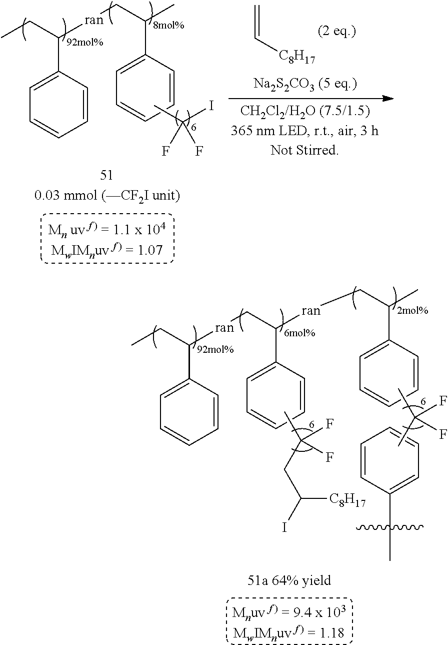

¹H NMR (400 MHz, CDCl₃)

δ=7.04 (br), 6.57 (br), 4.34 (br), 2.94 (br), 2.87 (br), 1.81 (br), 1.42 (br), 1.29 (br), 0.89 (br), 0.71 (br)

¹⁹F NMR (376 MHz, CDCl₃)

δ=−111.0˜−115.4 (4F, br), −122.1 (6F, br), −124.2 (2F, br)

### Example 27

A compound (RfI) represented by the following formula (0.5 equivalents):

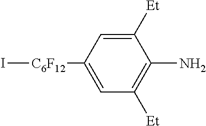

3 equivalents (1 mL) of an aqueous sodium thiosulfate solution, and 1.5 equivalents (1 mL) of an aqueous cesium carbonate solution were added to a dichloromethane solution (5 mL) of polystyrene (52) (Mₙ=8.9×10³, M_{w}/Mₙ=1.03), and light irradiation with a 365 nm LED was performed at room temperature for 24 hours. The obtained reaction mixture was reprecipitated with methanol as a poor solvent, and further purified by reprecipitation with a methanol/water (3/2) mixed solvent as a poor solvent. As a result, a desired polymer 52a (Mₙ=1.3×10⁴, M_{w}/Mₙ=1.22) in which the fluorine content was 11 mass % and a Rf group was introduced into 6 mol % of all benzene rings was obtained at an isolation yield of 90%.

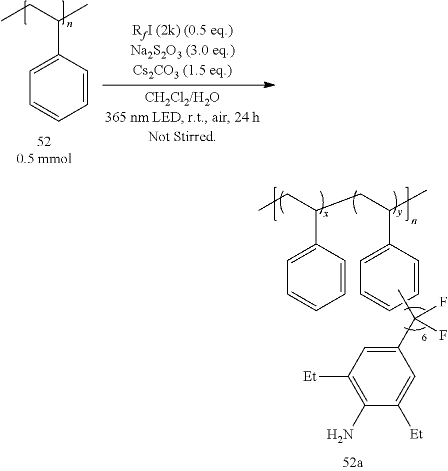

¹H NMR (400 MHz, CDCl₃)

δ=7.04 (br), 6.53 (br), 3.90 (s), 2.52 (d, 7.5 Hz), 1.82 (br), 1.43 (br)

¹⁹F NMR (376 MHz, CDCl₃)

δ=−109.6 (2F, br), −110.9 (2F, br), −121.8 (4F, br), −122.2 (4F, br)

### Example 28

Under atmospheric condition, 1 mL of iodoperfluorohexyl, 0.5 mL of 0.75M aqueous sodium thiosulfate solution, 0.5 mL of 0.23M aqueous cesium carbonate and AK-225 were added to polystyrene (15 mm square plate, 249.6 mg, 2.39 mmol, water contact angle 83 degree) in an weighing bottle and the bottle was covered with a petri dish. Light irradiation with a 365 nm LEF was performed from the upper side of the bottle at room temperature for 2 hours. The polystyrene plate after the reaction was washed with methanol, water and methanol in this sequence, dried and placed in a draft for 5 minutes. A measurement of water contact angle on the surface of the obtained plate was performed to give the value of 101 degree. Further, the obtained plate was dissolved in deuterated chloroform, on which a NMR measurement was performed. As a result, the obtained plate was confirmed to have perfluorohexyl group.

NMR Spectrum of the Obtained Plate

¹H NMR (400 MHz, CDCl₃)

δ=7.13-6.89 (br), 3.76-0.61 (br)

¹⁹F NMR (376 MHz, CDCl₃)

δ=−80.9-−81.18 (3F, br), −112.56 (2F, br), −122.06 (2F, br), −126.44 (2F, br), −127.3 (2F, br).

1. A method for producing a fluorine-containing polymer, the method comprising
reacting a polymer comprising a unit represented by the following Formula (I): 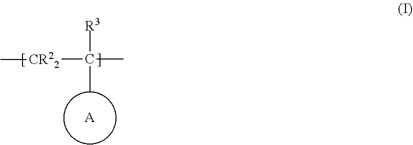
wherein A represents an aromatic ring or an aromatic heterocyclic ring,
R² each independently represents a hydrogen atom or a fluorine atom, and
R³ represents a C₁₋₄ alkyl group optionally substituted with one or more fluorine atoms, a hydrogen atom, or a fluorine atom,
with a fluorine-containing compound represented by the following Formula (II),
R¹—X¹—(R^{F1})ᵣ—CF₂—I (II)
wherein R^{F1} represents —(Rf)ₚ—R^{F1}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R¹ represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1,
q is each independently 0 or 1, and
r is each independently 0 or 1,
to obtain a fluorine-containing polymer comprising a unit represented by the following Formula (III): 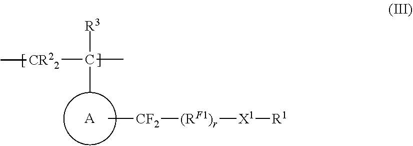
wherein A, R^{F1}, X¹, R¹, R², R³ and r have the same meaning as described above.

2. A method for producing a fluorine-containing polymer, the method comprising
reacting a polymer comprising a unit represented by the following Formula (I): 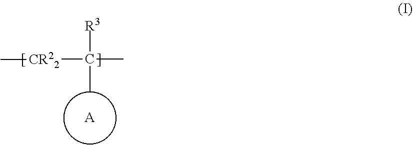
wherein A represents an aromatic ring or an aromatic heterocyclic ring,
R² each independently represents a hydrogen atom or a fluorine atom, and
R³ represents a C₁₋₄ alkyl group optionally substituted with one or more fluorine atoms, a hydrogen atom, or a fluorine atom,
with a fluorine-containing compound represented by the following Formula (VI):
I—R⁴⁰—I (VI)
wherein
R⁴⁰ represents a C₃₋₆ alkylene group optionally substituted with one or more halogen atoms, to obtain a fluorine-containing polymer comprising a unit represented by the following Formula (VII): 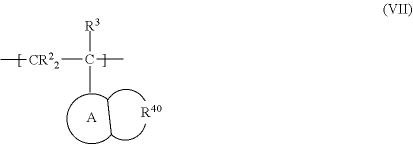
wherein A, R², R³ and R⁴⁰ have the same meaning as described above.

3. The method according to claim 1, wherein the polymer further comprises one or more selected from a unit represented by the following Formula (IV-a): [symbol]
CR⁵₂—CR⁶R⁷ [symbol] (IV-a)
wherein R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
or a unit represented by the following Formula (IV-b): [symbol]
CR¹¹₂—CR¹²═CR¹²—CR¹¹₂ [symbol] (IV-b)
wherein R¹¹ each independently represents a C₁₋₄ alkyl group optionally substituted with one or more fluorine atoms, a hydrogen atom, or a fluorine atom, and
R¹² each independently represents a C₁₋₄ alkyl group optionally substituted with one or more fluorine atoms, a hydrogen atom, a fluorine atom, or a chlorine atom.

4. The method according to claim 1, wherein the polymer is represented by the following Formula (I-a): 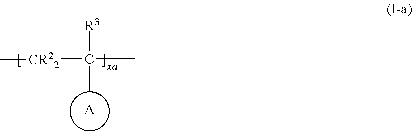
wherein A each independently represents an aromatic ring or an aromatic heterocyclic ring,
R² each independently represents a hydrogen atom or a fluorine atom,
R³ each independently represents a C₁₋₄ alkyl group optionally substituted with one or more fluorine atoms, a hydrogen atom, or a fluorine atom, and
xa represents an integer of 1 to 10,000.

5. The method according to claim 1, wherein the polymer is represented by the following Formula (I-b): 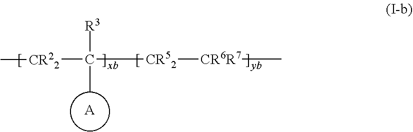
wherein A each independently represents an aromatic ring or an aromatic heterocyclic ring,
R² each independently represents a hydrogen atom or a fluorine atom,
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
xb represents an integer of 1 to 10,000,
yb represents an integer of 1 to 10,000, and
the order of occurrence of units enclosed by parentheses with xb and yb is not limited in Formula (I-b).

6. The method according to claim 1, wherein the polymer is represented by the following Formula (I-c): 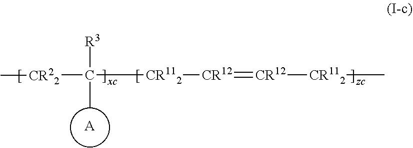
wherein A each independently represents an aromatic ring or an aromatic heterocyclic ring,
R² each independently represents a hydrogen atom or a fluorine atom,
R³ each independently represents a C₁₋₄ alkyl group optionally substituted with one or more fluorine atoms, a hydrogen atom, or a fluorine atom,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
xc represents an integer of 1 to 10,000,
zc represents an integer of 1 to 10,000, and
the order of occurrence of units enclosed by parentheses with xc and zc is not limited in Formula (I-c).

7. The method according to claim 1, wherein the polymer is represented by the following Formula (I-d): 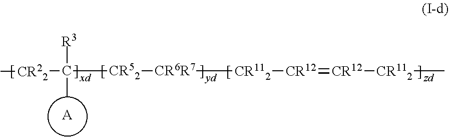
wherein each independently A represents an aromatic ring or an aromatic heterocyclic ring,
R² each independently represents a hydrogen atom or a fluorine atom,
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
xd represents an integer of 1 to 10,000,
yd represents an integer of 1 to 10,000,
zd represents an integer of 1 to 10,000, and
the order of occurrence of units enclosed by parentheses with xd, yd, and zd is not limited in Formula (I-d).

8. The method according to claim 1, wherein the polymer is represented by the following Formula (I-e): 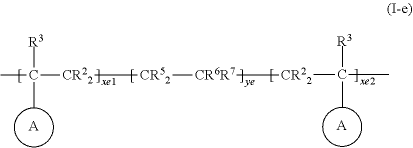
wherein each independently A represents an aromatic ring or an aromatic heterocyclic ring,
R² each independently represents a hydrogen atom or a fluorine atom,
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
xe1 represents an integer of 1 to 10,000,
xe2 represents an integer of 1 to 10,000,
ye represents an integer of 1 to 10,000, and
the order of occurrence of units enclosed by parentheses with xe1, xe2, and ye is not limited in Formula (I-e).

9. The method according to claim 1, wherein the polymer is represented by the following Formula (I-f): 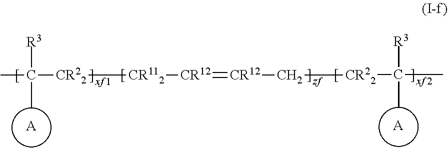
wherein A each independently represents an aromatic ring or an aromatic heterocyclic ring,
R² each independently represents a hydrogen atom or a fluorine atom,
R³ each independently represents a C₁₋₄ alkyl group optionally substituted with one or more fluorine atoms, a hydrogen atom, or a fluorine atom,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
xf1 represents an integer of 1 to 10,000,
xf2 represents an integer of 1 to 10,000,
zf represents an integer of 1 to 10,000, and
the order of occurrence of units enclosed by parentheses with xf1, xf2, and zf is not limited in Formula (I-f).

10. A fluorine-containing polymer comprising a unit represented by the following Formula (III-a): 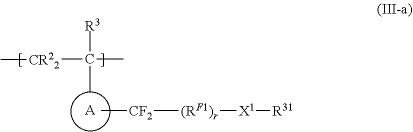
wherein A represents an aromatic ring or an aromatic heterocyclic ring,
R^{F1} represents —(Rf)ₚR^{F1}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R² each independently represents a hydrogen atom or a fluorine atom,
R³ each independently represents a C₁₋₄ alkyl group optionally substituted with one or more fluorine atoms, a hydrogen atom, or a fluorine atom,
R³¹ represents a C₇₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a bromine atom, or an iodine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is 0 or 1,
q is 0 or 1, and
r is 0 or 1.

11. A fluorine-containing polymer comprising a unit represented by the following Formula (VII): 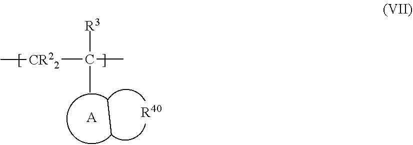
wherein A represents an aromatic ring or an aromatic heterocyclic ring,
R² each independently represents a hydrogen atom or a fluorine atom,
R³ represents a C₁₋₄ alkyl group optionally substituted with one or more fluorine atoms, a hydrogen atom, or a fluorine atom, and
R⁴⁰ represents a C₃₋₆ alkylene group optionally substituted with one or more halogen atoms.

12. A fluorine-containing polymer comprising
one or more selected from a unit represented by the following Formula (III): 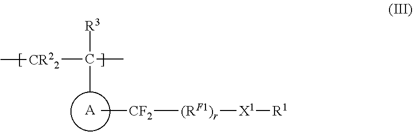
wherein A represents an aromatic ring or an aromatic heterocyclic ring,
R^{F1} represents —(Rf)ₚ—R^{F}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R¹ represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom,
R³ each independently represents a C₁₋₄ alkyl group optionally substituted with one or more fluorine atoms, a hydrogen atom, or a fluorine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is 0 or 1,
q is 0 or 1, and
r is 0 or 1, or
a unit represented by the following Formula (VII): 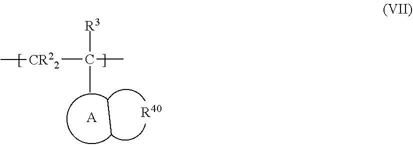
wherein A represents an aromatic ring or an aromatic heterocyclic ring,
R² each independently represents a hydrogen atom or a fluorine atom,
R³ represents a C₁₋₄ alkyl group optionally substituted with one or more fluorine atoms, a hydrogen atom, or a fluorine atom, and
R⁴⁰ represents a C₃₋₆ alkylene group optionally substituted with one or more halogen atoms; and
one or more selected from a unit represented by the following Formula (IV-a): [symbol]
CR⁵₂—CR⁶R⁷ [symbol] (IV-a)
wherein R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
a unit represented by the following Formula (IV-b): [symbol]
CR¹¹₂—CR¹²═CR¹²—CR¹¹₂ [symbol] (IV-b)
wherein R¹¹ each independently represents a C₁₋₄ alkyl group optionally substituted with one or more fluorine atoms, a hydrogen atom, or a fluorine atom, and
R¹² each independently represents a C₁₋₄ alkyl group optionally substituted with one or more fluorine atoms, a hydrogen atom, a fluorine atom, or a chlorine atom, or
a unit represented by the following Formula (IV-c): [symbol]
CR¹¹₂—CR¹³₂—CR¹³₂—CR¹¹₂ [symbol] (IV-C)
wherein R¹¹ has the same meaning as described above,
R¹³ each independently represents one selected from a C₁₋₄ alkyl group optionally substituted with one or more fluorine atoms, a hydrogen atom, a fluorine atom, a chlorine atom, an iodine atom, and —CF₂—(R^{F1})ᵣ—X¹—R¹,
R^{F1} represents —(Rf)ₚ—R^{F}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents hydrogen atom or a fluorine atom,
p is each independently 0 or 1,
q is each independently 0 or 1, and
r is each independently 0 or 1.

13. The fluorine-containing polymer according to claim 10, wherein the fluorine-containing polymer is represented by the following Formula (V-a): 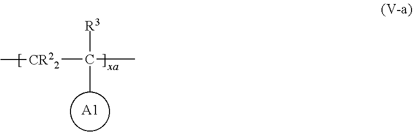
wherein A1 each independently represents one or more selected from a ring represented by the following formula: 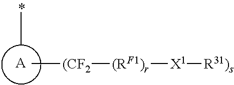
and a ring represented by the following formula: 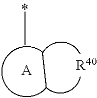
wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R² each independently represents a hydrogen atom or a fluorine atom,
R³ each independently represents a C₁₋₄ alkyl group optionally substituted with one or more fluorine atoms, a hydrogen atom, or a fluorine atom,
R³¹ each independently represents a C₇₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a bromine atom, or an iodine atom,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1,
q is each independently 0 or 1,
r is each independently 0 or 1,
s each independently represents an integer of 0 to 5,
xa represents an integer of 2 to 10,000, and
the number of —CF₂—(R^{F1})ᵣ—X¹—R³¹ included in Formula (V-a) is one or more.

14. The fluorine-containing polymer according to claim 12, wherein the fluorine-containing polymer is represented by the following Formula (V-b): 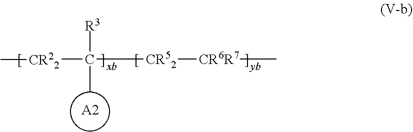
wherein A2 each independently represents one or more selected from a ring represented by the following formula: 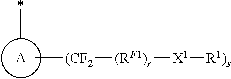
and a ring represented by the following formula: 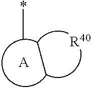
wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom,
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1,
q is each independently 0 or 1,
r is each independently 0 or 1,
s each independently represents an integer of 0 to 5,
xb represents an integer of 1 to 10,000,
yb represents an integer of 1 to 10,000,
the order of occurrence of units enclosed by parentheses with xb and yb is not limited in Formula (V-b), and
the number of —CF₂—(R^{F1})ᵣ—X¹—R¹ included in Formula (V-b) is one or more.

15. The fluorine-containing polymer according to claim 12, wherein the fluorine-containing polymer is represented by the following Formula (V-c): 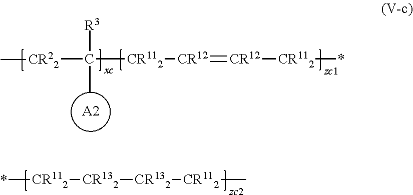
wherein A2 each independently represents one or more selected from a ring represented by the following formula: 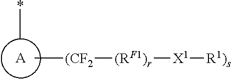
and a ring represented by the following formula: 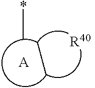
wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom,
R³ each independently represents a C₁₋₄ alkyl group optionally substituted with one or more fluorine atoms, a hydrogen atom, or a fluorine atom,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R¹³ each independently represents one selected from a C₁₋₄ alkyl group optionally substituted with one or more fluorine atoms, a hydrogen atom, a fluorine atom, a chlorine atom, an iodine atom, and —CF₂—(R^{F1})ᵣ—X¹—R¹,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1,
q is each independently 0 or 1,
r is each independently 0 or 1,
s each independently represents an integer of 0 to 5,
xc represents an integer of 1 to 10,000,
zc1 represents an integer of 1 to 10,000,
zc2 represents an integer of 1 to 10,000,
the order of occurrence of units enclosed by parentheses with xc, zc1, and zc2 is not limited in Formula (V-c),
the number of —CF₂—(R^{F1})ᵣ—X¹—R¹ included in Formula (V-c) is one or more, and
asterisks * in the formulas are bonded to each other.

16. The fluorine-containing polymer according to claim 12, wherein the fluorine-containing polymer is represented by the following Formula (V-d): 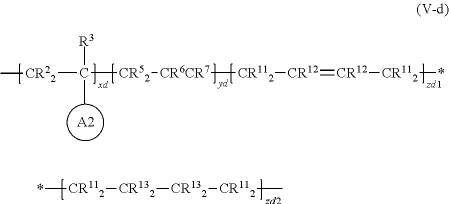
wherein A2 each independently represents one or more selected from a ring represented by the following formula: 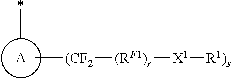
and a ring represented by the following formula: 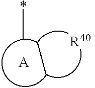
wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom,
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
R¹³ each independently represents one selected from a C₁₋₄ alkyl group optionally substituted with one or more fluorine atoms, a hydrogen atom, a fluorine atom, a chlorine atom, an iodine atom, and —CF²—(R^{F1})ᵣ—X¹—R¹,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom, and —CH₂— on the ring is optionally substituted with one or more selected from —O—, —S— and —NH—,
p is each independently 0 or 1,
q is each independently 0 or 1,
r is each independently 0 or 1,
s each independently represents an integer of 0 to 5,
xd represents an integer of 1 to 10,000,
yd represents an integer of 1 to 10,000,
zd1 represents an integer of 1 to 10,000,
zd2 represents an integer of 1 to 10,000,
the order of occurrence of units enclosed by parentheses with xd, yd, zd1, and zd2 is not limited in Formula (V-d),
the number of —CF₂—(R^{F1})ᵣ—X¹—R¹ included in Formula (V-d) is one or more, and
asterisks * in the formulas are bonded to each other.

17. The fluorine-containing polymer according to claim 12, wherein the fluorine-containing polymer is represented by the following Formula (V-e): 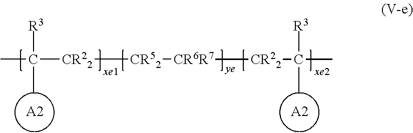
wherein A2 each independently represents one or more selected from a ring represented by the following formula: 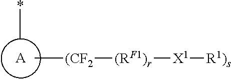
and a ring represented by the following formula: 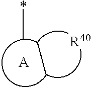
wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom,
R³ each independently represents a C₁₋₄ alkyl group optionally substituted with one or more fluorine atoms, a hydrogen atom, or a fluorine atom,
R⁵ each independently represents a hydrogen atom or a fluorine atom,
R⁶ each independently represents a C₁₋₄ alkyl group optionally substituted with one or more fluorine atoms, a hydrogen atom, a fluorine atom, or a chlorine atom,
R⁷ each independently represents one selected from a C₁₋₁₆ alkyl group optionally substituted with one or more fluorine atoms, a vinyl group optionally substituted with one or more fluorine atoms, a C₁₋₁₆ hydroxyalkyl group, —CO—OR⁸, —CO—NR⁹R¹⁰, a nitrile group, a hydrogen atom, a fluorine atom, a chlorine atom, and an iodine atom,
R⁸ each independently represents a C₁₋₁₆ alkyl group optionally substituted with one or more fluorine atoms, a sodium cation, a potassium cation, an ammonium cation, or a hydrogen atom,
R⁹ each independently represents a C₁₋₁₆ alkyl group optionally substituted with one or more fluorine atoms, or a hydrogen atom,
R¹⁰ each independently represents a C₁₋₁₆ alkyl group optionally substituted with one or more fluorine atoms, or a hydrogen atom, or
R⁹ and R¹⁰ optionally form a ring comprising a nitrogen atom, together with a nitrogen atom to which they are bonded, and —CH₂— on the ring is optionally substituted with one or more selected from —O—, —S—, and —NH—,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1,
q is each independently 0 or 1,
r is each independently 0 or 1,
s each independently represents an integer of 0 to 5,
xe1 represents an integer of 1 to 10,000,
xe2 represents an integer of 1 to 10,000,
ye represents an integer of 1 to 10,000,
the order of occurrence of units enclosed by parentheses with xe1, xe2, and ye is not limited in Formula (V-e), and
the number of —CF₂—(R^{F1})ᵣ—X¹—R¹ included in Formula (V-e) is one or more.

18. The fluorine-containing polymer according to claim 12, wherein the fluorine-containing polymer is represented by the following the Formula (V-f): 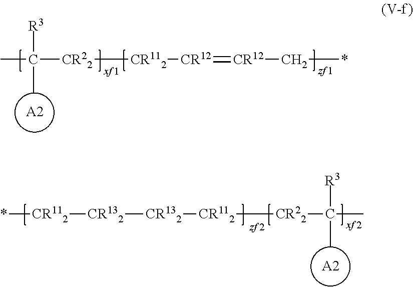
wherein A2 each independently represents one or more selected from a ring represented by the following formula: 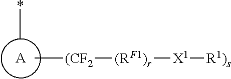
and a ring represented by the following formula: 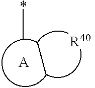
wherein A each independently represents an aromatic ring or an aromatic heterocyclic ring,
R^{F1} each independently represents —(Rf)ₚ—R^{F}—(O)_{q}—,
Rf each independently represents a C₁₋₁₆ alkylene group optionally substituted with one or more fluorine atoms,
R^{F} each independently represents a divalent fluoro(poly)ether group,
X¹ each independently represents a C₁₋₁₆ alkylene group optionally substituted with one or more halogen atoms, or a single bond,
R¹ each independently represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R² each independently represents a hydrogen atom or a fluorine atom,
R³ each independently represents a C₁₋₄ alkyl group optionally substituted with one or more fluorine atoms, a hydrogen atom, or a fluorine atom,
R¹¹ each independently represents a C₁₋₄ alkyl group optionally substituted with one or more fluorine atoms, a hydrogen atom, or a fluorine atom,
R¹² each independently represents a C₁₋₄ alkyl group optionally substituted with one or more fluorine atoms, a hydrogen atom, a fluorine atom, or a chlorine atom,
R¹³ each independently represents one selected from a C₁₋₄ alkyl group optionally substituted with one or more fluorine atoms, a hydrogen atom, a fluorine atom, a chlorine atom, an iodine atom, and —CF₂—(R^{F1})ᵣ—X¹—R¹,
R⁴⁰ each independently represents a C₃₋₆ alkylene group optionally substituted with one or more halogen atoms,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is each independently 0 or 1,
q is each independently 0 or 1,
r is each independently 0 or 1,
s each independently represents an integer of 0 to 5,
xf1 represents an integer of 1 to 10,000,
xf2 represents an integer of 1 to 10,000,
zf1 represents an integer of 1 to 10,000,
zf2 represents an integer of 1 to 10,000,
the order of occurrence of units enclosed by parentheses with xf1, xf2, zf1, and zf2 is not limited in Formula (V-f),
the number of —CF₂—(R^{F1})ᵣ—X¹—R¹ included in Formula (V-f) is one or more, and
asterisks * in the formulas are bonded to each other.

19. An article comprising:
a base material; and
a layer that is formed on a surface of the base material and formed with a surface treatment agent, wherein
the base material comprises a polymer comprising a unit represented by the following Formula (I): 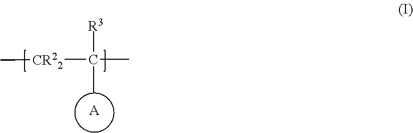
wherein A represents an aromatic ring or an aromatic heterocyclic ring,
R² represents a hydrogen atom or a fluorine atom, and
R³ represents a C₁₋₄ alkyl group optionally substituted with one or more fluorine atoms, a hydrogen atom, or a fluorine atom, and
the surface treatment agent comprises a fluorine-containing compound represented by Formula (II):
R¹—X¹—(R^{F1})ᵣ—CF₂—I (II)
wherein R^{F1} represents —(Rf)ₚ—R^{F}—(O)_{q}—,
Rf each independently represents a C₁₋₁₆ alkylene group optionally substituted with one or more fluorine atoms,
R^{F} represents a divalent fluoro(poly)ether group,
X¹ represents a C₁₋₁₆ alkylene group optionally substituted with one or more halogen atoms, or a single bond,
R¹ represents a C₁₋₁₆ alkyl group optionally substituted with one or more halogen atoms, a C₆₋₂₀ aromatic hydrocarbon group optionally having one or more substituents, a silsesquioxane residue optionally having one or more substituents, —COOR^{f2}, —OR^{f2}, —SO₂R^{f3}, —CR^{f4}═CR^{f4}₂, a fluorine atom, a chlorine atom, a bromine atom, or an iodine atom,
R^{f2} each independently represents a C₁₋₁₆ alkyl group optionally substituted with one or more fluorine atoms, or a hydrogen atom,
R^{f3} represents a C₁₋₁₆ alkyl group optionally substituted with one or more halogen atoms, a fluorine atom, or a hydrogen atom,
R^{f4} each independently represents a hydrogen atom or a fluorine atom,
p is 0 or 1,
q is 0 or 1, and
r is 0 or 1.

20. (canceled)
